(19) United States
(12) Patent Application Publication
(10) Pub. No.: US 2026/0261195 A1
(43) Pub. Date: Sep. 3, 2026

(54) POWER CONVERTER

(71) Applicant: Panasonic Intellectual Property Management Co., Ltd., Osaka (JP)

(72) Inventors: Yutaka KAMON, Osaka (JP); Koji HIGASHIYAMA, Osaka (JP); Yasuhiro ARAI, Shiga (JP); Ryosuke MAEDA, Osaka (JP)

(21) Appl. No.: 18/881,616

(22) PCT Filed: Aug. 10, 2023
(86) PCT No.: PCT/JP2023/029342

§ 371 Date: Jan. 6, 2025

(30) Foreign Application Priority Data
Aug. 26, 2022 (JP) 2022-135429

(51) Int. Cl. H02M 1/088; H02M 1/00; H02M 1/08; H02M 7/48; H02M 7/537

(52) U.S. Cl. CPC H02M 1/088; H02M 1/0058; H02M 1/083; H02M 7/4818; H02M 7/537

(57) ABSTRACT

The controller may perform a first control operation and a second control operation when determining that resonant currents, each passing through a corresponding one of two or more switches, flow simultaneously through a resonant inductor. The first control operation includes allowing a high-level period of a control signal for each of the two or more switches to overlap, for a predetermined period, with a dead time period associated with each of two or more switching circuits connected to the two or more switches, respectively. The second control operation includes determining a beginning of a high-level period of a control signal for at least one switch by a load current.

### TECHNICAL FIELD

The present disclosure generally relates to a power converter. More particularly, the present disclosure relates to a power converter having the ability to convert DC power into AC power.

### BACKGROUND ART

Patent Literature 1 discloses a power converter for converting DC power into multiphase AC power.

The power converter of Patent Literature 1 includes a main switching means (power converter circuit), two capacitors, one coil (resonant inductor), a plurality of auxiliary switch elements, and a control means. The main switching means includes a plurality of main switching circuits provided for respective phases of the multiphase AC power. Each of the plurality of main switching circuits is implemented as a pair of main switch elements which are connected in series between both terminals of a DC power supply and uses, as the output node of its associated phase, the interconnection node of the pair of main switch elements. The two capacitors divide the voltage of the DC power supply. One terminal of the coil is connected to a voltage division node of the two capacitors. The plurality of auxiliary switch elements connect the other terminal of the coil and the output nodes of the respective phases. When determining that a plurality of phase currents flow through the coil, the control means controls the plurality of auxiliary switch elements to make the amount of current flowing through at least one phase smaller than a preset amount.

In the power converter of Patent Literature 1, the control means controls, when determining that a plurality of phase currents flow through the coil, the plurality of auxiliary switching elements to make the amount of current flowing through at least one phase smaller than the preset amount, and therefore, the control means does not make soft switching of a main switch corresponding to the at least one phase.

### CITATION LIST

### Patent Literature

Patent Literature 1: JP 2010-233306 A

### SUMMARY OF INVENTION

An object of the present disclosure is to provide a power converter having the ability to make soft switching with more reliability.

A power converter according to an aspect of the present disclosure includes a first DC terminal and a second DC terminal, a power converter circuit, a plurality of AC terminals, a plurality of switches, a plurality of resonant capacitors, a resonant inductor, a regenerative capacitor, and a controller. The power converter circuit includes a plurality of first switching elements and a plurality of second switching elements. In the power converter circuit, a plurality of switching circuits, in each of which one of the plurality of first switching elements and a corresponding one of the plurality of second switching elements are connected one to one in series, are connected to each other in parallel. In the power converter circuit, the plurality of first switching elements are connected to the first DC terminal, and the plurality of second switching elements are connected to the second DC terminal. The plurality of AC terminals are provided one to one for the plurality of switching circuits. Each of the plurality of AC terminals is connected to a connection node between the first switching element and the second switching element of a corresponding one of the plurality of switching circuits. The plurality of switches are provided one to one for the plurality of switching circuits. Each of the plurality of switches has a first terminal thereof connected to the connection node between the first switching element and the second switching element of a corresponding one of the plurality of switching circuits. The plurality of switches have their respective second terminals connected in common to a common connection node. The plurality of resonant capacitors are provided one to one for the plurality of switches. Each of the plurality of resonant capacitors is connected between the first terminal of a corresponding one of the plurality of switches and the second DC terminal. The resonant inductor has a first terminal and a second terminal. In the resonant inductor, the first terminal of the resonant inductor is connected to the common connection node. The regenerative capacitor has a third terminal and a fourth terminal. In the regenerative capacitor, the third terminal is connected to either the first DC terminal or the second DC terminal. The controller applies a control signal, having a potential alternating between a high level and a low level, to each of the plurality of first switching elements, the plurality of second switching elements, and the plurality of switches. The controller is able to perform a first control operation and a second control operation when determining that resonant currents, each passing through a corresponding one of two or more switches belonging to the plurality of switches, flow simultaneously through the resonant inductor. The first control operation includes allowing a high-level period of a control signal for each of the two or more switches to overlap, for a predetermined period, with a dead time period associated with each of two or more switching circuits respectively connected to the two or more switches which belong to the plurality of switching circuits. The second control operation includes determining a beginning of a high-level period of a control signal for at least one of the plurality of switches by a load current of at least one phase flowing through an AC load connected to the plurality of AC terminals.

### BRIEF DESCRIPTION OF DRAWINGS

FIG. 1 is a circuit diagram of a system including a power converter according to a first embodiment;

FIG. 2 shows how duties and load currents, respectively corresponding to three-phase voltage instructions in an AC load connected to a plurality of AC terminals of the power converter, change with time;

FIG. 3 illustrates how the power converter operates in a situation where its controller has performed a basic operation when a load current>0 and its resonant capacitor is subjected to a charging operation;

FIG. 4 also illustrates how the power converter operates in a situation where its controller has performed the basic operation when the load current>0 and its resonant capacitor is subjected to the charging operation;

FIG. 5 shows a first current threshold value and a second current threshold value for use in the controller of the power converter;

FIG. 6 illustrates how the power converter operates in a situation where its controller has performed the basic operation when a load current>0 and its resonant capacitor is subjected to a discharging operation;

FIG. 7 also illustrates how the power converter operates in a situation where its controller has performed the basic operation when the load current<0 and its resonant capacitor is subjected to the discharging operation;

FIG. 8 illustrates how the power converter operates in a situation where its controller has performed the basic operation when the load current<0 and its resonant capacitor is subjected to the charging operation;

FIG. 9 is a timing chart illustrating how the power converter operates in a situation where its controller has performed a first control operation, a second control operation, and a third control operation;

FIG. 10 is a timing chart illustrating how the power converter operates in a situation where its controller does not perform any of the first control operation, the second control operation, or the third control operation;

FIG. 11 is a timing chart illustrating an exemplary situation where the controller of the power converter presumes that two-phase resonant currents overlap with each other;

FIG. 12 is a timing chart illustrating another exemplary situation where the controller of the power converter presumes that the two-phase resonant currents overlap with each other;

FIG. 13 is a timing chart illustrating still another exemplary situation where the controller of the power converter presumes that the two-phase resonant currents overlap with each other;

FIG. 14 also shows how duties and load currents, respectively corresponding to the three-phase voltage instructions in the AC load connected to the plurality of AC terminals of the power converter, change with time;

FIG. 15 is a timing chart illustrating yet another exemplary situation where the controller of the power converter presumes that the two-phase resonant currents overlap with each other;

FIG. 16 is a timing chart illustrating how the power converter operates in a situation where its controller has performed the first control operation, the second control operation, and the third control operation;

FIG. 17 is a timing chart illustrating how the power converter operates in a situation where its controller does not perform any of the first control operation, the second control operation, or the third control operation;

FIG. 18 is a timing chart illustrating how the power converter operates in a situation where its controller has performed the first control operation and the third control operation;

FIG. 19 is a timing chart illustrating how the power converter operates in a situation where its controller performs neither the first control operation nor the third control operation;

FIG. 20 is a timing chart illustrating yet another exemplary situation where the controller of the power converter presumes that the three-phase resonant currents overlap with each other;

FIG. 21 is a timing chart illustrating yet another exemplary situation where the controller of the power converter presumes that the three-phase resonant currents overlap with each other;

FIG. 22 is a timing chart illustrating yet another exemplary situation where the controller of the power converter presumes that the two-phase resonant currents overlap with each other;

FIG. 23 is a timing chart illustrating yet another exemplary situation where the controller of the power converter presumes that the two-phase resonant currents overlap with each other;

FIG. 24 is a timing chart illustrating how the power converter operates in a situation where its controller has performed the first control operation and the third control operation;

FIG. 25 is a timing chart illustrating how the power converter operates in a situation where its controller performs neither the first control operation nor the third control operation;

FIG. 26 is a timing chart illustrating how a power converter according to a first variation of the first embodiment operates in a situation where its controller has performed the first control operation and the second control operation;

FIG. 27 is a timing chart illustrating how a power converter according to a second variation of the first embodiment operates in a situation where its controller has performed the first control operation and the second control operation;

FIG. 28 is a timing chart illustrating how the power converter operates in a situation where its controller performs neither the first control operation nor the second control operation;

FIG. 29 is a timing chart illustrating how a power converter according to a third variation of the first embodiment operates in a situation where its controller has performed the first control operation and the second control operation;

FIG. 30 is a timing chart illustrating how a power converter according to a fourth variation of the first embodiment operates in a situation where its controller has performed the first control operation, the second control operation, and the third control operation;

FIG. 31 is a timing chart illustrating how a power converter according to a fifth variation of the first embodiment operates in a situation where its controller has performed the first control operation and the second control operation;

FIG. 32 is a timing chart illustrating how the power converter operates in the situation where its controller has performed the first control operation and the second control operation;

FIG. 33 illustrates the premise of the operation of a power converter according to a sixth variation of the first embodiment;

FIG. 34 is a timing chart illustrating how the power converter operates in a situation where its controller has performed the first control operation, the second control operation, and the third control operation;

FIG. 35 is a timing chart illustrating how a power converter according to a seventh variation of the first embodiment operates in a situation where its controller has performed the first control operation and the second control operation;

FIG. 36 is a circuit diagram of a system including a power converter according to an eighth variation of the first embodiment;

FIG. 37 is a circuit diagram of a system including a power converter according to a ninth variation of the first embodiment;

FIG. 38 is a circuit diagram of a system including a power converter according to a tenth variation of the first embodiment;

FIG. 39 is a circuit diagram of a system including a power converter according to an eleventh variation of the first embodiment;

FIG. 40 is a circuit diagram of a system including a power converter according to a twelfth variation of the first embodiment;

FIG. 41 is a circuit diagram of a system including a power converter according to a thirteenth variation of the first embodiment;

FIG. 42 is a circuit diagram of a system including a power converter according to a second embodiment; and

FIG. 43 is a circuit diagram of a system including a power converter according to a third embodiment.

### DESCRIPTION OF EMBODIMENTS

### First Embodiment

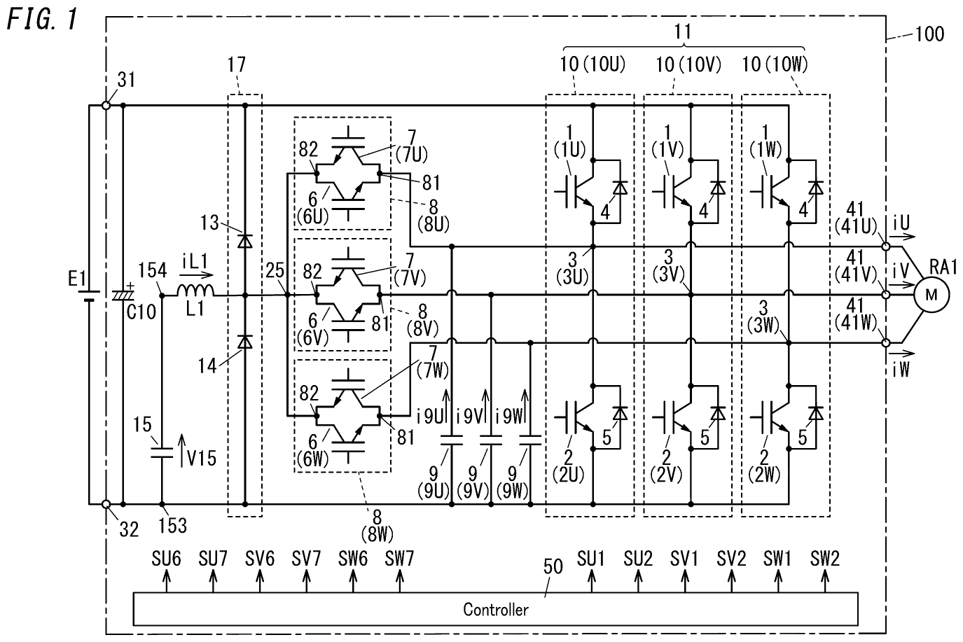

A power converter 100 according to a first embodiment will be described with reference to FIGS. 1-25.

### (1) Overall Configuration for Power Converter

The power converter 100 includes a first DC terminal 31 and a second DC terminal 32, and a plurality of (e.g., three) AC terminals 41 as shown in FIG. 1, for example. A DC power supply E1 is connected between the first DC terminal 31 and the second DC terminal 32. An AC load RA1 is connected to the plurality of AC terminals 41. The AC load RA1 may be, for example, a three-phase motor. The power converter 100 converts the DC output of the DC power supply E1 into AC power and outputs the AC power to the AC load RA1. The DC power supply E1 may include, for example, a solar cell or a fuel cell. The DC power supply E1 may include a DC-DC converter. In the power converter 100, if the plurality of AC terminals 41 are three AC terminals 41, then the AC power may be, for example, three-phase AC power having U-, V-, and W-phases.

The power converter 100 includes a power converter circuit 11, a plurality of (e.g., three) switches 8, a plurality of (e.g., three) resonant capacitors 9, a regenerative capacitor 15, a resonant inductor L1, and a controller 50. The power converter 100 further includes a protection circuit 17 and a capacitor C10. Each of the plurality of switches 8 may be, for example, a bidirectional switch.

The power converter circuit 11 includes a plurality of (e.g., three) first switching elements 1 and a plurality of (e.g., three) second switching elements 2. In the power converter circuit 11, a plurality of (e.g., three) switching circuits 10, in each of which one of the plurality of first switching elements 1 and a corresponding one of the plurality of second switching elements 2 are connected one to one in series, are connected in parallel. In the power converter circuit 11, the plurality of first switching elements 1 are connected to the first DC terminal 31 and the plurality of second switching elements 2 are connected to the second DC terminal 32. The plurality of AC terminals 41 are provided one to one for the plurality of switching circuits 10. Each of the plurality of AC terminals 41 is connected to a connection node 3 between the first switching element 1 and the second switching element 2 of a corresponding one of the plurality of switching circuits 10. The plurality of switches 8 are provided one to one for the plurality of switching circuits 10. Each of the plurality of switches 8 has a first terminal 81 thereof connected to the connection node 3 between the first switching element 1 and the second switching element 2 of a corresponding one of the plurality of switching circuits 10. The plurality of resonant capacitors 9 are provided one to one for the plurality of switches 8. Each of the plurality of resonant capacitors 9 is connected between the first terminal 81 of a corresponding one of the plurality of switches 8 and the second DC terminal 32. The resonant inductor L1 has a first terminal and a second terminal. The first terminal of the resonant inductor L1 is connected to a common connection node 25. The regenerative capacitor 15 has a third terminal 153 and a fourth terminal 154. In the regenerative capacitor 15, the third terminal 153 thereof is connected to the second DC terminal 32 and the fourth terminal 154 thereof is connected to the common connection node 25 via the resonant inductor L1. The controller 50 controls the plurality of first switching elements 1, the plurality of second switching elements 2, and the plurality of switches 8.

### (2) Details of Power Converter

In the following description, as for the plurality of switching circuits 10, the switching circuits 10 for the U-, V, and W-phases will be hereinafter referred to as a “switching circuit 10U,” a “switching circuit 10V,” and a “switching circuit 10W,” respectively, for the sake of convenience of description. Also, in the following description, the first switching element 1 and second switching element 2 of the switching circuit 10U will be hereinafter referred to as a “first switching element 1U” and a “second switching element 2U,” respectively. Likewise, in the following description, the first switching element 1 and second switching element 2 of the switching circuit 10V will be hereinafter referred to as a “first switching element 1V” and a “second switching element 2V,” respectively. Likewise, in the following description, the first switching element 1 and second switching element 2 of the switching circuit 10W will be hereinafter referred to as a “first switching element 1W” and a “second switching element 2W,” respectively. Furthermore, in the following description, the connection node 3 between the first switching element 1U and the second switching element 2U will be hereinafter referred to as a “connection node 3U,” the connection node 3 between the first switching element 1V and the second switching element 2V will be hereinafter referred to as a “connection node 3V,” and the connection node 3 between the first switching element 1W and the second switching element 2W will be hereinafter referred to as a “connection node 3W.” Furthermore, in the following description, the AC terminal 41 connected to the connection node 3U will be hereinafter referred to as an “AC terminal 41U,” the AC terminal 41 connected to the connection node 3V will be hereinafter referred to as an “AC terminal 41V,” and the AC terminal 41 connected to the connection node 3W will be hereinafter referred to as an “AC terminal 41W.” Furthermore, in the following description, the resonant capacitor 9 connected to the second switching element 2U in parallel will be hereinafter referred to as a “resonant capacitor 9U,” the resonant capacitor 9 connected to the second switching element 2V in parallel will be hereinafter referred to as a “resonant capacitor 9V,” and the resonant capacitor 9 connected to the second switching element 2W in parallel will be hereinafter referred to as a “resonant capacitor 9W.” Furthermore, in the following description, the switch 8 connected to the connection node 3U will be hereinafter referred to as a “switch 8U,” the switch 8 connected to the connection node 3V will be hereinafter referred to as a “switch 8V,” and the switch 8 connected to the connection node 3W will be hereinafter referred to as a “switch 8W.” In the power converter 100, the higher-potential output terminal (positive electrode) of the DC power supply E1 is connected to the first DC terminal 31, and the lower-potential output terminal (negative electrode) of the DC power supply E1 is connected to the second DC terminal 32. Also, in the power converter 100, the U-, V, and W-phase terminals of the AC load RA1 are connected to the three AC terminals 41U, 41V, and 41W, respectively.

In the power converter circuit 11, each of the plurality of (e.g., three) first switching elements 1 and the plurality of (e.g., three) second switching elements 2 has a control terminal, a first main terminal, and a second main terminal. The respective control terminals of the plurality of first switching elements 1 and the plurality of second switching elements 2 are connected to the controller 50. In each of the plurality of switching circuits 10 of the power converter 100, the first main terminal of the first switching element 1 is connected to the first DC terminal 31, the second main terminal of the first switching element 1 is connected to the first main terminal of the second switching element 2, and the second main terminal of the second switching element 2 is connected to the second DC terminal 32. In each of the plurality of switching circuits 10, the first switching element 1 is a high-side switching element (P-side switching element) and the second switching element 2 is a low-side switching element (N-side switching element). Each of the plurality of first switching elements 1 and the plurality of second switching elements 2 may be, for example, an insulated gate bipolar transistor (IGBT). Thus, in each of the plurality of first switching elements 1 and the plurality of second switching elements 2, the control terminal, the first main terminal, and the second main terminal thereof are a gate terminal, a collector terminal, and an emitter terminal, respectively.

The power converter circuit 11 further includes a plurality of (e.g., three) first diodes 4 which are connected one to one to the plurality of (e.g., three) first switching elements 1 in antiparallel and a plurality of (e.g., three) second diodes 5 which are connected one to one to the plurality of (e.g., three) second switching elements 2 in antiparallel. In each of the plurality of first diodes 4, the anode of the first diode 4 is connected to the second main terminal (emitter terminal) of the first switching element 1 corresponding to the first diode 4, and the cathode of the first diode 4 is connected to the first main terminal (collector terminal) of the first switching element 1 corresponding to the first diode 4. In each of the plurality of second diodes 5, the anode of the second diode 5 is connected to the second main terminal (emitter terminal) of the second switching element 2 corresponding to the second diode 5, and the cathode of the second diode 5 is connected to the first main terminal (collector terminal) of the second switching element 2 corresponding to the second diode 5.

The U-phase terminal of the AC load RA1 may be connected, for example, to the connection node 3U between the first switching element 1U and the second switching element 2U via the AC terminal 41U. The V-phase of the AC load RA1 may be connected, for example, to the connection node 3V between the first switching element 1V and the second switching element 2V via the AC terminal 41V. The W-phase of the AC load RA1 may be connected, for example, to the connection node 3W between the first switching element 1W and the second switching element 2W via the AC terminal 41W.

The plurality of resonant capacitors 9 are provided one to one for the plurality of switches 8. Each of the plurality of resonant capacitors 9 is connected between the first terminal 81 of its corresponding switch 8 and the second DC terminal 32. The power converter 100 includes a plurality of resonant circuits. The plurality of resonant circuits includes a resonant circuit having the resonant capacitor 9U and the resonant inductor L1, a resonant circuit having the resonant capacitor 9V and the resonant inductor L1, and a resonant circuit having the resonant capacitor 9W and the resonant inductor L1. The plurality of resonant circuits shares the resonant inductor L1 in common.

Each of the plurality of switches 8 may include, for example, two IGBTs, namely, a first IGBT 6 and a second IGBT 7, which are connected together in antiparallel. In each of the plurality of switches 8, the collector terminal of the first IGBT 6 and the emitter terminal of the second IGBT 7 are connected to each other and the emitter terminal of the first IGBT 6 and the collector terminal of the second IGBT 7 are connected to each other. In each of the plurality of switches 8, the emitter terminal of the first IGBT 6 is connected to the connection node 3 of the switching circuit 10 corresponding to the switch 8 including the first IGBT 6. In each of the plurality of switches 8, the collector terminal of the second IGBT 7 is connected to the connection node 3 of the switching circuit 10 corresponding to the switch 8 including the second IGBT 7. The switch 8U is connected to the connection node 3U between the first switching element 1U and the second switching element 2U. The switch 8V is connected to the connection node 3V between the first switching element 1V and the second switching element 2V. The switch 8W is connected to the connection node 3W between the first switching element 1W and the second switching element 2W. In the following description, the first IGBT 6 and second IGBT 7 of the switch 8U will be hereinafter referred to as a “first IGBT 6U” and a “second IGBT 7U,” respectively, the first IGBT 6 and second IGBT 7 of the switch 8V will be hereinafter referred to as a “first IGBT 6V” and a “second IGBT 7V,” respectively, and the first IGBT 6 and second IGBT 7 of the switch 8W will be hereinafter referred to as a “first IGBT 6W” and a “second IGBT 7W,” respectively, for the sake of convenience of description.

The plurality of switches 8 are controlled by the controller 50. In other words, the first IGBT 6U, the second IGBT 7U, the first IGBT 6V, the second IGBT 7V, the first IGBT 6W, and the second IGBT 7W are controlled by the controller 50.

The resonant inductor L1 has a first terminal and a second terminal. In the resonant inductor L1, the first terminal of the resonant inductor L1 is connected to the common connection node 25 and the second terminal of the resonant inductor L1 is connected to the fourth terminal 154 of the regenerative capacitor 15.

The regenerative capacitor 15 is connected between the second terminal of the resonant inductor L1 and the second DC terminal 32. The regenerative capacitor 15 may be, for example, a film capacitor.

The protection circuit 17 includes a third diode 13 and a fourth diode 14. The third diode 13 is connected between the common connection node 25 and the first DC terminal 31. In the third diode 13, the anode of the third diode 13 is connected to the common connection node 25 and the cathode of the third diode 13 is connected to the first DC terminal 31. The fourth diode 14 is connected between the common connection node 25 and the second DC terminal 32. In the fourth diode 14, the anode of the fourth diode 14 is connected to the second DC terminal 32 and the cathode of the fourth diode 14 is connected to the common connection node 25. Thus, the fourth diode 14 is connected to the third diode 13 in series.

The capacitor C10 is connected between the first DC terminal 31 and the second DC terminal 32 and is connected to the power converter circuit 11 in parallel. The capacitor C10 may be, for example, an electrolytic capacitor.

The controller 50 controls the plurality of first switching elements 1, the plurality of second switching elements 2, and the plurality of switches 8. The agent that performs the functions of the controller 50 includes a computer system. The computer system includes a single or a plurality of computers. The computer system may include a processor and a memory as principal hardware components thereof. The computer system serves as the agent that performs the functions of the controller 50 according to the present disclosure by making the processor execute a program stored in the memory of the computer system. The program may be stored in advance in the memory of the computer system. Alternatively, the program may also be downloaded through a telecommunications line or be distributed after having been recorded in a non-transitory storage medium such as a memory card, an optical disc, or a hard disk drive (magnetic disk), any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

The controller 50 outputs control signals SU1, SV1, SW1 to control the ON/OFF states of the plurality of first switching elements 1U, 1V, 1W, respectively. Each of the control signals SU1, SV1, SW1 may be, for example, a pulse width modulation (PWM) signal having, for example, a potential level that alternates between a first potential level (hereinafter referred to as a “low level”) and a second potential level (hereinafter referred to as a “high level”) higher than the first potential level. The first switching elements 1U, 1V, 1W respectively turn ON when the control signals SU1, SV1, SW1 have high level and respectively turn OFF when the control signals SU1, SV1, SW1 have low level. In addition, the controller 50 also outputs control signals SU2, SV2, SW2 to control the ON/OFF states of the plurality of second switching elements 2U, 2V, 2W, respectively. Each of the control signals SU2, SV2, SW2 may be, for example, a PWM signal having, for example, a potential level that alternates between the first potential level (hereinafter referred to as a “low level”) and the second potential level (hereinafter referred to as a “high level”) higher than the first potential level. The second switching elements 2U, 2V, 2W respectively turn ON when the control signals SU2, SV2, SW2 have high level and respectively turn OFF when the control signals SU2, SV2, SW2 have low level.

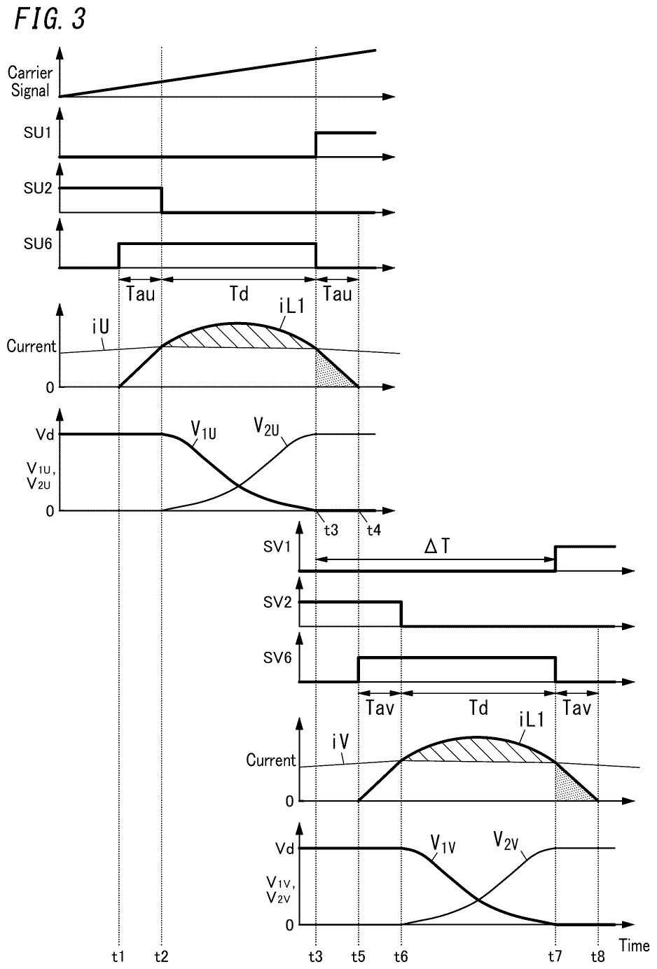

The controller 50 generates, using a carrier signal (refer to FIG. 3) having a saw-tooth waveform, the control signals SU1, SV1, SW1 for the plurality of first switching elements 1U, 1V, 1W, respectively, and the control signals SU2, SV2, SW2 for the plurality of second switching elements 2U, 2V, 2W, respectively. More specifically, the controller 50 generates, based on at least the carrier signal and a U-phase voltage instruction, the control signals SU1, SU2 to be applied to the first switching element 1U and the second switching element 2U, respectively. Also, the controller 50 generates, based on at least the carrier signal and a V-phase voltage instruction, the control signals SV1, SV2 to be applied to the first switching element 1V and the second switching element 2V, respectively. Furthermore, the controller 50 generates, based on at least the carrier signal and a W-phase voltage instruction, the control signals SW1, SW2 to be applied to the first switching element 1W and the second switching element 2W, respectively. The U-phase voltage instruction, the V-phase voltage instruction, and the W-phase voltage instruction may be, for example, sinusoidal wave signals, of which the phases are different from each other by 120 degrees and of which the amplitude (voltage instruction value) changes with time. Note that the waveform of the carrier signal does not have to be the saw-tooth waveform but may also be a triangular waveform or a mirror-reversed version of the saw-tooth waveform shown in FIG. 3. Also, the U-phase voltage instruction, the V-phase voltage instruction, and the W-phase voltage instruction each have one cycle of the same length. In addition, one cycle of the U-phase voltage instruction, the V-phase voltage instruction, and the W-phase voltage instruction is longer than one cycle of the carrier signal.

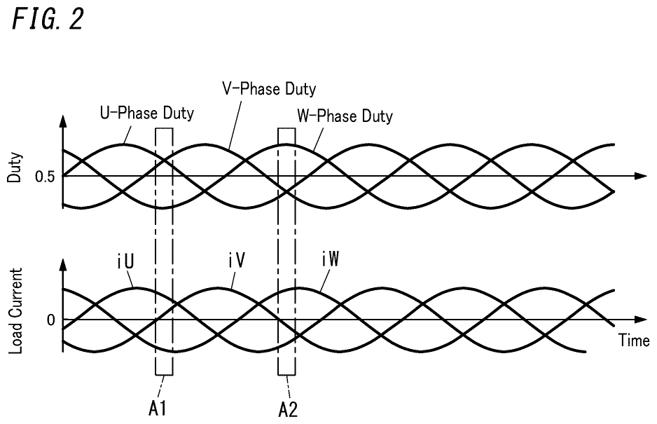

The duty of the control signals SU1, SU2 to be applied from the controller 50 to the first switching element 1U and the second switching element 2U, respectively, varies in accordance with the U-phase voltage instruction. In FIG. 2, the duty of the control signal SU1 is shown as a “U-phase duty.” The controller 50 (refer to FIG. 1) generates the control signal SU1 to be applied to the first switching element 1U by comparing the U-phase voltage instruction with the carrier signal. The controller 50 generates the control signal SU2 to be applied to the second switching element 2U by inverting the control signal SU1 to be applied to the first switching element 1U. In addition, to prevent the respective ON periods of the first switching element 1U and the second switching element 2U from overlapping with each other, the controller 50 sets a dead time period Td (refer to FIG. 3) between a high-level period of the control signal SU1 and a high-level period of the control signal SU2.

The duty of the control signals SV1, SV2 to be applied from the controller 50 to the first switching element 1V and the second switching element 2V, respectively, varies in accordance with the V-phase voltage instruction. In FIG. 2, the duty of the control signal SV1 is shown as a “V-phase duty.” The controller 50 (refer to FIG. 1) generates the control signal SV1 to be applied to the first switching element 1V by comparing the V-phase voltage instruction with the carrier signal. The controller 50 also generates the control signal SV2 to be applied to the second switching element 2V by inverting the control signal SV1 to be applied to the first switching element 1V. In addition, to prevent the respective ON periods of the first switching element 1V and the second switching element 2V from overlapping with each other, the controller 50 sets a dead time period Td (refer to FIG. 3) between a high-level period of the control signal SV1 and a high-level period of the control signal SV2.

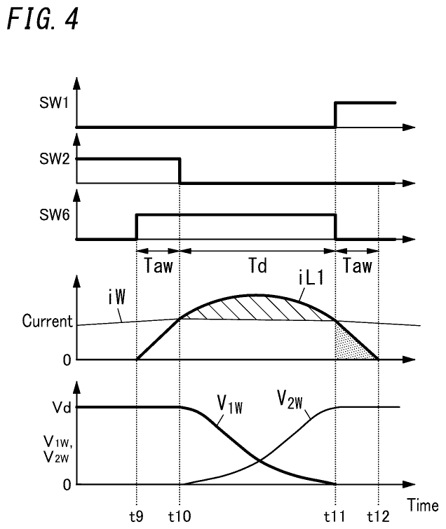

The duty of the control signals SW1, SW2 to be applied from the controller 50 to the first switching element 1W and the second switching element 2W, respectively, varies in accordance with the W-phase voltage instruction. In FIG. 2, the duty of the control signal SW1 is shown as a “W-phase duty.” The controller 50 (refer to FIG. 1) generates the control signal SW1 to be applied to the first switching element 1W by comparing the W-phase voltage instruction with the carrier signal. The controller 50 generates the control signal SW2 to be applied to the second switching element 2W by inverting the control signal SW1 to be applied to the first switching element 1W. In addition, to prevent the respective ON periods of the first switching element 1W and the second switching element 2W from overlapping with each other, the controller 50 sets a dead time period Td (refer to FIG. 4) between a high-level period of the control signal SW1 and a high-level period of the control signal SW2.

The U-phase voltage instruction, the V-phase voltage instruction, and the W-phase voltage instruction may be, for example, sinusoidal wave signals, of which the phases are different from each other by 120 degrees and of which the amplitude changes with time. Thus, the respective duties (i.e., U-, V-, and W-phase duties) of the control signals SU1, SV1, SW1 change in the form of sinusoidal waves, of which the phases are different from each other by 120 degrees, as shown in FIG. 2, for example. In the same way, the respective duties of the control signals SU2, SV2, SW2 also change in the form of sinusoidal waves, of which the phases are different from each other by 120 degrees.

The controller 50 generates the respective control signals SU1, SU2, SV1, SV2, SW1, SW2 based on the carrier signal, the respective voltage instructions, and information about the state of the AC load RA1. For example, if the AC load RA1 is a three-phase motor, the information about the state of the AC load RA1 may include, for example, detection values provided by a plurality of current sensors for respectively detecting output currents (hereinafter referred to as “load currents”) iU, iV, iW flowing respectively through the U-, V-, and W-phases of the AC load RA1.

The plurality of switches 8, the resonant inductor L1, the plurality of resonant capacitors 9, and the regenerative capacitor 15 are provided to make zero-voltage soft switching of the plurality of first switching elements 1 and the plurality of second switching elements 2.

In this power converter 100, the controller 50 controls not only the plurality of first switching elements 1 and the plurality of second switching elements 2 of the power converter circuit 11 but also the plurality of switches 8 as well.

The controller 50 generates control signals SU6, SU7, SV6, SV7, SW6, SW7 for controlling the respective ON/OFF states of the first IGBT 6U, the second IGBT 7U, the first IGBT 6V, the second IGBT 7V, the first IGBT 6W, and the second IGBT 7W, respectively, and outputs the control signals SU6, SU7, SV6, SV7, SW6, SW7 to the respective gate terminals of the first IGBT 6U, the second IGBT 7U, the first IGBT 6V, the second IGBT 7V, the first IGBT 6W, and the second IGBT 7W.

If the first IGBT 6U is ON and the second IGBT 7U is OFF, the switch 8U allows a charging current that flows through the regenerative capacitor 15, the resonant inductor L1, the switch 8U, and the resonant capacitor 9U in this order to pass therethrough. The charging current is a current for charging the resonant capacitor 9U with electricity. On the other hand, if the first IGBT 6U is OFF and the second IGBT 7U is ON, the switch 8U allows a discharging current that flows through the resonant capacitor 9U, the switch 8U, the resonant inductor L1, and the regenerative capacitor 15 in this order to pass therethrough. The discharging current is a current for discharging electricity from the resonant capacitor 9U.

If the first IGBT 6V is ON and the second IGBT 7V is OFF, the switch 8V allows a charging current that flows through the regenerative capacitor 15, the resonant inductor L1, the switch 8V, and the resonant capacitor 9V in this order to pass therethrough. The charging current is a current for charging the resonant capacitor 9V with electricity. On the other hand, if the first IGBT 6V is OFF and the second IGBT 7V is ON, the switch 8V allows a discharging current that flows through the resonant capacitor 9V, the switch 8V, the resonant inductor L1, and the regenerative capacitor 15 in this order to pass therethrough. The discharging current is a current for discharging electricity from the resonant capacitor 9V.

If the first IGBT 6W is ON and the second IGBT 7W is OFF, the switch 8W allows a charging current that flows through the regenerative capacitor 15, the resonant inductor L1, the switch 8W, and the resonant capacitor 9W in this order to pass therethrough. The charging current is a current for charging the resonant capacitor 9W with electricity. On the other hand, if the first IGBT 6W is OFF and the second IGBT 7W is ON, the switch 8W allows a discharging current that flows through the resonant capacitor 9W, the switch 8W, the resonant inductor L1, and the regenerative capacitor 15 in this order to pass therethrough. The discharging current is a current for discharging electricity from the resonant capacitor 9W.

### (3) Operation of Power Converter

In the following description, as for a currents iL1 flowing through the resonant inductor L1, if the current flows in the direction indicated by the arrow shown in FIG. 1, then the polarity of the current iL1 is supposed to be positive. On the other hand, if the current iL1 flows in the direction opposite from the one indicated by the arrow shown in FIG. 1, then the polarity of the current iL1 is supposed to be negative. In addition, in the following description, as for each of the load currents iU, iV, iW respectively flowing through the U-, V-, and W-phases of the AC load RA1, if the load current iU, iV, iW flows in the direction indicated by a corresponding one of the arrows shown in FIG. 1, then the polarity of the load current iU, iV, iW is supposed to be positive. On the other hand, if the load current iU, iV, iW flows in the direction opposite from the one indicated by the arrow shown in FIG. 1, then the polarity of the load current iU, iV, iW is supposed to be negative. Furthermore, as for each of currents i9U, i9V, i9W flowing through the resonant capacitors 9U, 9V, 9W, respectively, if the current i9U, i9V, i9W flows in the direction indicated by a corresponding one of the arrows shown in FIG. 1, then the polarity of the current i9U, i9V, i9W is supposed to be positive. On the other hand, if the current i9U, i9V, i9W flows in the direction opposite from the one indicated by the arrow shown in FIG. 1, then the polarity of the current i9U, i9V, i9W is supposed to be negative. Thus, in the case of the discharging operation of discharging electricity from the resonant capacitor 9U, 9V, 9W, the polarity of the current i9U, i9V, i9W is positive. On the other hand, in the case of the charging operation of charging the resonant capacitor 9U, 9V, 9W with electricity, the polarity of the current i9U, i9V, i9W is negative.

In this power converter 100, the first IGBT 6U of the switch 8U may turn OFF in a state where the first IGBT 6U of the switch 8U is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Also, in this power converter 100, the second IGBT 7U of the switch 8U may turn OFF in a state where the second IGBT 7U of the switch 8U is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6V of the switch 8V may turn OFF in a state where the first IGBT 6V of the switch 8V is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Furthermore, in this power converter 100, the second IGBT 7V of the switch 8V may turn OFF in a state where the second IGBT 7V of the switch 8V is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6W of the switch 8W may turn OFF in a state where the first IGBT 6W of the switch 8W is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Furthermore, in this power converter 100, the second IGBT 7W of the switch 8W may turn OFF in a state where the second IGBT 7W of the switch 8W is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

The controller 50 sets, with respect to each of the plurality of switching circuits 10, a dead time period Td between a high-level period of the control signal SU1, SV1, SW1 for the first switching element 1U, 1V, 1W and a high-level period of the control signal SU2, SV2, SW2 for the second switching element 2U, 2V, 2W.

Next, a basic operation of zero-voltage soft switching to be performed on each of the plurality of first switching elements 1 and the plurality of second switching elements 2 will be described with reference to FIGS. 1 and 2. As used herein, the “basic operation” refers to an operation to be performed when a resonant current, passing through each of two or more switches 8 belonging to the plurality of switches 8, does not flow simultaneously through the resonant inductor L1. It will be described, after the basic operation has been described, how this power converter 100 operates when the controller 50 determines that the resonant current passing through each of the two or more switches 8 belonging to the plurality of switches 8 flow simultaneously.

### (3.1) Basic Operation

When the zero-voltage soft switching is performed on the first switching element 1, the voltage across the first switching element 1 needs to be reduced to zero just before the first switching element 1 as the target of zero-voltage soft switching turns ON. When the zero-voltage soft switching is performed on the second switching element 2, the voltage across the second switching element 2 needs to be reduced to zero just before the second switching element 2 as the target of zero-voltage soft switching turns ON. In the following description, the switching element (which is either the first switching element 1 or the second switching element 2) as the target of the zero-voltage soft switching will be hereinafter referred to as a “target switching element.”

The basic operation of the controller 50 changes according to the polarity (i.e., either positive or negative) of a load current flowing through the AC terminal 41 connected to the target switching element and depending on whether the resonant capacitor 9 connected to the target switching element in series or in parallel is performing the charging operation or the discharging operation. The load current has positive polarity when flowing from the AC terminal 41 toward the AC load RA1 and has negative polarity when flowing from the AC load RA1 toward the AC terminal 41. While the resonant capacitor 9 is performing the charging operation, the voltage across the resonant capacitor 9 increases. On the other hand, while the resonant capacitor 9 is performing the discharging operation, the voltage across the resonant capacitor 9 decreases. The voltage across each of the plurality of second switching elements 2 is the same as the voltage across the resonant capacitor 9 connected to the second switching element 2 in parallel.

### (3.1.1) Operation of Making Soft Switching of First Switching Element When Load Current>0

If the target of the soft switching is a first switching element 1 (hereinafter referred to as a “target first switching element 1”) and the polarity of the load current flowing through the AC terminal 41 connected to the target first switching element 1 is positive, then the controller 50 turns ON the first IGBT 6 corresponding to the target first switching element 1. In this manner, the controller 50 causes the resonant inductor L1 and resonant capacitor 9 connected to the target first switching element 1 to produce resonance, thereby charging the resonant capacitor 9 with electric charges removed from the regenerative capacitor 15 and reducing the voltage across the target first switching element 1 to zero. This allows the power converter 100 to make zero-voltage soft switching of the target first switching element 1.

The control signals SU1, SU2 to be respectively applied from the controller 50 to the first switching element 1U and the second switching element 2U of the switching circuit 10U in a situation where the target first switching element 1 is the first switching element 1U of the switching circuit 10U are shown in FIG. 3. In addition, the control signal SU6 to be applied from the controller 50 to the first IGBT 6U of the switch 8U, the load current iU flowing through the U-phase of the AC load RA1, the current iL1 flowing through the resonant inductor L1, the voltage V_{1U} across the first switching element 1U, and the voltage V_{2U} across the second switching element 2U are also shown in FIG. 3. Furthermore, the control signals SV1, SV2 to be respectively applied from the controller 50 to the first switching element 1V and the second switching element 2V of the switching circuit 10V in a situation where the target first switching element 1 is the first switching element 1V of the switching circuit 10V are also shown in FIG. 3. In addition, the control signal SV6 to be applied from the controller 50 to the first IGBT 6V of the switch 8V, the load current iV flowing through the V-phase of the AC load RA1, the current iL1 flowing through the resonant inductor L1, the voltage V_{1V} across the first switching element 1V, and the voltage V_{2V} across the second switching element 2V are also shown in FIG. 3.

Furthermore, the dead time period Td that the controller 50 sets to prevent the first switching element 1 and the second switching element 2 of the same phase from turning ON simultaneously is also shown in FIG. 3. Besides, an additional time Tau set by the controller 50 with respect to the control signal SU6 for the first IGBT 6U of the switch 8U and an additional time Tav set by the controller 50 with respect to the control signal SV6 for the first IGBT 6V of the switch 8V are also shown in FIG. 3. The additional time Tau and the additional time Tav will be described later.

The control signals SW1, SW2 to be respectively applied from the controller 50 to the first switching element 1W and the second switching element 2W of the switching circuit 10W in a situation where the target first switching element 1 is the first switching element 1W of the switching circuit 10W are shown in FIG. 4. In addition, the control signal SW6 to be applied from the controller 50 to the first IGBT 6W of the switch 8W and the load current iW flowing through the W-phase of the AC load RA1 are also shown in FIG. 4. The current iL1 flowing through the resonant inductor L1 is also shown in FIG. 4. The voltage V_{1W} across the first switching element 1W and the voltage V_{2W} across the second switching element 2 are also shown in FIG. 4. In FIG. 4, the voltage value of the DC power supply E1 is designated by Vd.

Furthermore, the dead time period Td that the controller 50 sets to prevent the first switching element 1W and the second switching element 2W from turning ON simultaneously is also shown in FIG. 4. Besides, an additional time Taw set by the controller 50 with respect to the control signal SW6 for the first IGBT 6W of the switch 8W is also shown in FIG. 4. The additional time Taw will be described later.

The additional time Tau is an amount of time that the controller 50 provides to make the high-level period of the control signal SU6 longer than the dead time period Td by setting the beginning (time t1) of the high-level period of the control signal SU6 at a point in time earlier than the beginning (time t2) of the dead time period Td as shown in FIG. 3. The length of the additional time Tau is determined by the value of the load current iU. To start producing the LC resonance from the beginning (time t2) of the dead time period Td, it is preferable that the value of the current iL1 agree with the value of the load current iU at the beginning (time t2) of the dead time period Td. This is because as long as iL1<iU is satisfied, all of the current iL1 flows through the AC load RA1, and therefore, the resonant capacitor 9U cannot be charged. The end of the high-level period of the control signal SU6 may be simultaneous with, or later than, the end (time t3) of the dead time period Td. In the example shown in FIG. 3, the end of the high-level period of the control signal SU6 is set to be simultaneous with the end (time t3) of the dead time period Td. The controller 50 sets the high-level period of the control signal SU6 at Tau+Td. In the switching circuit 10U, the voltage V2U across the second switching element 2U becomes Vd at the end (time t3) of the dead time period Td, and the voltage V_{1U} across the first switching element 1U goes zero at the end (time t3) of the dead time period Td. In the example shown in FIG. 3, the current iL1 starts flowing through the resonant inductor L1 at the beginning (time t1) of the high-level period of the control signal SU6 and goes zero at a time t4 when the additional time Tau has passed since the end (time t3) of the dead time period Td. As for the current iL1, the current iL1 satisfies iL1≥iU from the beginning (time t2) of the dead time period Td, and therefore, the current iL1 in the hatched part of the current waveform shown as the fifth waveform from the top of FIG. 3 flows into the resonant capacitor 9U to produce LC resonance. From the end (time t3) of the dead time period Td and on, the current iL1 will be regenerated to the power converter circuit 11 via the third diode 13 directly connected to the resonant inductor L1.

To start producing the LC resonance at the beginning (time t2) of the dead time period Td and end a resonant half cycle at the end of the dead time period Td as described above, the controller 50 determines the additional time Tau based on the load current iU such that iL1=iU is satisfied at the beginning (time t2) of the dead time period Td. More specifically, using either the detection result of the load current iU by a current sensor or a signal processing value thereof, or an estimated value of the load current iU, the inductance L of the resonant inductor L1 that has been stored in advance, and the detection result of the potential V15 at the regenerative capacitor 15, for example, the controller 50 determines the additional time Tau by the equation: Tau=iU×(L/V15). In this case, as the detection result of the load current iU or the signal processing value thereof, either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the inverse number of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

The additional time Tav is an amount of time that the controller 50 provides to make the high-level period of the control signal SV6 longer than the dead time period Td by setting the beginning (time t5) of the high-level period of the control signal SV6 at a point in time earlier than the beginning (time t6) of the dead time period Td as shown in FIG. 3. The length of the additional time Tav is determined by the value of the load current iV. To start producing LC resonance from the beginning (time t6) of the dead time period Td, it is preferable that the value of the current iL1 agree with the value of the load current iV at the beginning (time t6) of the dead time period Td. This is because as long as iL1<iV is satisfied, all of the current iL1 flows through the AC load RA1, and therefore, the resonant capacitor 9V cannot be charged. The end of the high-level period of the control signal SV6 may be simultaneous with, or later than, the end (time t7) of the dead time period Td. In the example shown in FIG. 3, the end of the high-level period of the control signal SV6 is set to be simultaneous with the end (time t7) of the dead time period Td. The controller 50 sets the high-level period of the control signal SV6 at Tav+Td. The voltage V_{1V} across the first switching element 1V goes zero at the end (time t7) of the dead time period Td. In the example shown in FIG. 3, the current iL1 starts flowing through the resonant inductor L1 at the beginning (time t5) of the high-level period of the control signal SV6 and goes zero at a time t8 when the additional time Tav has passed since the end (time t7) of the dead time period Td. As for the current iL1, the current iL1 satisfies iL1≥iV from the beginning (time t6) of the dead time period Td and on, and therefore, the current iL1 in the hatched part of the current waveform shown as the tenth waveform from the top of FIG. 3 flows into the resonant capacitor 9V to produce the LC resonance. From the end (time t7) of the dead time period Td and on, the current iL1 will be regenerated to the power converter circuit 11 via the third diode 13 directly connected to the resonant inductor L1.

To start producing the LC resonance at the beginning (time t6) of the dead time period Td as described above, the controller 50 determines the additional time Tav based on the load current iV such that iL1=iV is satisfied at the beginning (time t6) of the dead time period Td. More specifically, using either the detection result of the load current iV by a current sensor or a signal processing value thereof, or an estimated value of the load current iV, the inductance L of the resonant inductor L1 that has been stored in advance, and the detection result of the potential V15 at the regenerative capacitor 15, for example, the controller 50 determines the additional time Tav by the equation: Tav=iV×(L/V15). In this case, as the detection result of the load current iV or the signal processing value thereof, either a detection value at a carrier cycle at which the additional time Tav is added or a detection value at a timing closest to the carrier cycle may be used. Also, in this case, as the estimated value of the load current iV, a value of the load current iV estimated at the carrier cycle at which the additional time Tav is added may be used, for example.

The additional time Taw is an amount of time that the controller 50 provides to make the high-level period of the control signal SW6 longer than the dead time period Td by setting the beginning (time t9) of the high-level period of the control signal SW6 at a point in time earlier than the beginning (time t10) of the dead time period Td as shown in FIG. 4. The length of the additional time Taw is determined by the value of the load current iW. To start producing LC resonance from the beginning (time t10) of the dead time period Td, it is preferable that the value of the current iL1 agree with the value of the load current iW at the beginning (time t10) of the dead time period Td. This is because as long as iL1<iW is satisfied, all of the current IL1 flows through the AC load RA1, and therefore, the resonant capacitor 9W cannot be charged. The end of the high-level period of the control signal SW6 may be simultaneous with, or later than, the end (time t11) of the dead time period Td. In the example shown in FIG. 4, the end of the high-level period of the control signal SW6 is set to be simultaneous with the end (time t11) of the dead time period Td. The controller 50 sets the high-level period of the control signal SW6 at Taw+Td. The voltage V_{1W} across the first switching element 1W goes zero at the end (time t11) of the dead time period Td. In the example shown in FIG. 4, the current iL1 starts flowing through the resonant inductor L1 at the beginning (time t9) of the high-level period of the control signal SW6 and goes zero at a time t12 when the additional time Taw has passed since the end (time t11) of the dead time period Td. As for the current iL1, the current iL1 satisfies iL1≥iW from the beginning (time t10) of the dead time period Td and on, and therefore, the current iL1 in the hatched part of the current waveform shown as the fourth waveform from the top of FIG. 4 flows into the resonant capacitor 9W to produce the LC resonance. From the end (time t11) of the dead time period Td and on, the current iL1 will be regenerated to the power converter circuit 11 via the third diode 13 directly connected to the resonant inductor L1.

The controller 50 determines the additional time Taw based on the load current iW. More specifically, using the detection result of the load current iW by a current sensor, the inductance L of the resonant inductor L1 that has been stored in advance, and the detection result of the potential V15 at the regenerative capacitor 15, for example, the controller 50 determines the additional time Taw by the equation: Taw=iW×(L/V15). In this case, as the detection result of the load current iW or the signal processing value thereof, either a detection value at a carrier cycle at which the additional time Taw is added or a detection value at a timing closest to the carrier cycle may be used. Also, in this case, as the estimated value of the load current iW, a value of the load current iW estimated at the carrier cycle at which the additional time Taw is added may be used, for example.

### (3.1.2) Operation of Making Soft Switching of Second Switching Element When Load Current>0

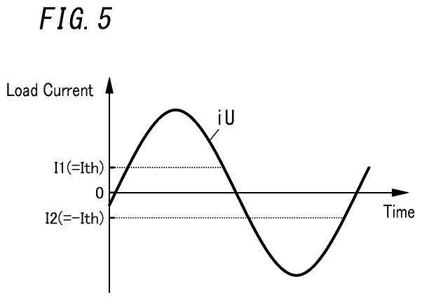

If the target of the soft switching is a second switching element 2 (hereinafter referred to as a “target second switching element 2”) and the polarity of the load current (which is the load current iU, the load current iV, or the load current iW) flowing through the AC terminal 41 connected to the target second switching element 2 is positive, then the controller 50 compares the current value of the load current with a first current threshold value I1 (=Ith, refer to FIG. 5). If the current value of the load current is greater than the first current threshold value I1, the controller 50 does not turn the switch 8 ON. On the other hand, if the current value of the load current is less than the first current threshold value I1, the controller 50 turns the switch 8 ON in the dead time period Td. In the power converter 100, if the current value of the load current is greater than the first current threshold value I1, the controller 50 may perform, using the load current iU, a discharging operation on the resonant capacitor 9U connected to the target second switching element 2 in parallel without turning ON the switch 8 corresponding to the target second switching element 2. This allows the power converter 100 to make zero-voltage soft switching of the target second switching element 2.

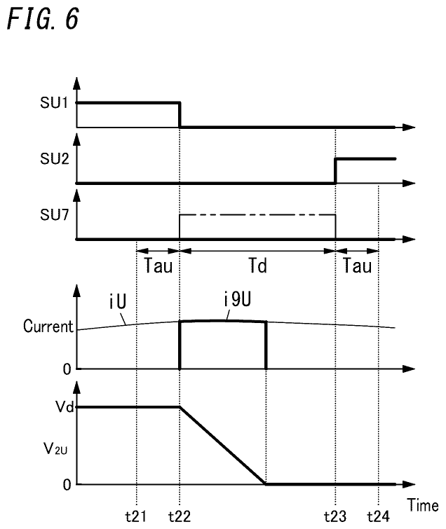

In FIG. 6, the control signals SU1, SU2, SU7, the load current iU, a current i9U flowing from the resonant capacitor 9U, and the voltage V_{2U} across the second switching element 2 are shown as for a situation where the target second switching element 2 is the second switching element 2U of the switching circuit 10U and the current value of the load current is greater than the first current threshold value I1. In addition, the dead time period Td and the additional time Tau set by the controller 50 with respect to a control signal SU7 for the second IGBT 7U of the switch 8U are also shown in FIG. 6.

If the current value of the load current iU is greater than the first current threshold value I1, the controller 50 does not provide any high-level period for the control signal SU7. In that case, in the power converter 100, a current iU9 starts flowing from the resonant capacitor 9U at the beginning (time t22) of the dead time period Td, the current i9U decreases to zero before the end (time t23) of the dead time period Td, and the voltage V_{2U} across the second switching element 2 goes zero before the end (time t23) of the dead time period Td. Thus, in the power converter 100, when the control signal SU2 changes from low level to high level at the end (time t23) of the dead time period Td, the second switching element 2 is subjected to zero-voltage soft switching.

If the current value of the load current iU is less than the first current threshold value I1, then the controller 50 provides a high-level period for the control signal SU7 as indicated by the two-dot chain in FIG. 6, for example. In that case, the beginning of the high-level period of the control signal SU7 may be simultaneous with, for example, the beginning (time t22) of the dead time period Td. Also, the end of the high-level period of the control signal SU7 is simultaneous with the end (time t23) of the dead time period Td. Thus, in the power converter 100, the voltage V_{2U} across the second switching element 2U goes zero before the end (time t23) of the dead time period Td. Consequently, in the power converter 100, when the control signal SU2 changes from low level to high level at the end (time t23) of the dead time period Td, the second switching element 2 is subjected to zero-voltage soft switching. Alternatively, the beginning of the high-level period of the control signal SU7 may be a time t21 which is earlier than the beginning of the dead time period Td by the additional time Tau. The end of the high-level period of the control signal SU7 may be a time t24 which is later than the end (time t23) of the dead time period Td by the additional time Tau. Note that the time before or after the high-level period overlaps with the dead time period Td does not have to be the additional time Tau but may also be any other preset time.

### (3.1.3) Operation of Making Soft Switching of Second Switching Element When Load Current<0

If the polarity of the load current (which is the load current iU, the load current iV, or the load current iW) flowing through the AC terminal 41 connected to the target second switching element 2 is negative, then the controller 50 turns ON the second IGBT 7 corresponding to the target second switching element 2. In this manner, the controller 50 causes the resonant capacitor 9 and the resonant inductor L1 connected to the target second switching element 2 to produce resonance, thereby discharging electricity from the resonant capacitor 9 and reducing the voltage across the target second switching element 2 to zero. This allows the power converter 100 to make zero-voltage soft switching of the target second switching element 2.

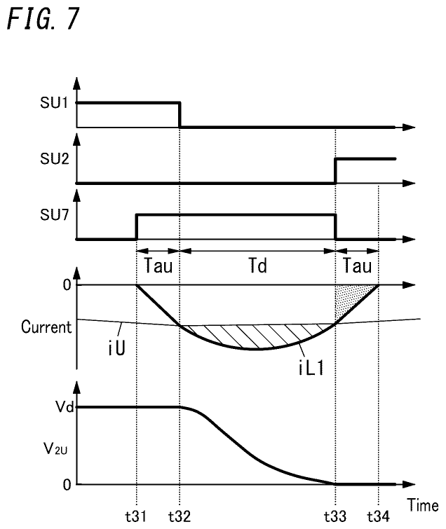

In FIG. 7, the control signals SU1, SU2, SU7, the load current iU, a current iL1 flowing through the resonant inductor L1, and the voltage V_{2U} across the second switching element 2 are shown as for a situation where the target second switching element 2 is the second switching element 2U of the switching circuit 10U.

Furthermore, the dead time period Td that the controller 50 sets to prevent the first switching element 1 and the second switching element 2 of the same phase from turning ON simultaneously is also shown in FIG. 7. Besides, an additional time Tau set by the controller 50 with respect to the control signal SU7 for the second IGBT 7U of the switch 8U is also shown in FIG. 7. The end of the high-level period of the control signal SU7 may be simultaneous with, or later than, the end (time t33) of the dead time period Td. In the example shown in FIG. 7 the end of the high-level period of the control signal SU7 is set to be simultaneous with the end (time t33) of the dead time period Td. The controller 50 sets the high-level period of the control signal SU7 at Tau+Td. In the switching circuit 10U, the voltage V_{2U} across the second switching element 2U goes zero at the end (time t33) of the dead time period Td. In the example shown in FIG. 7, the current iL1 starts flowing through the resonant inductor L1 at the beginning (time t31) of the high-level period of the control signal SU7 and goes zero at a time t34 when the additional time Tau has passed since the end (time t33) of the dead time period Td. As for the current iL1, the current iL1 satisfies iL1≥iU from the beginning (time t32) of the dead time period Td, and therefore, LC resonance is produced to cause a resonant current (i.e., a discharging current from the resonant capacitor 9U) to flow from the resonant capacitor 9U toward the resonant inductor L1. From the end (time t33) of the dead time period Td and on, the current iL1 will be regenerated to the power converter circuit 11 via the fourth diode 14 directly connected to the resonant inductor L1.

To start producing the LC resonance at the beginning (time t32) of the dead time period Td and end a resonant half cycle at the end (time t33) of the dead time period Td, the controller 50 determines the additional time Tau based on the load current iU such that iL1=iU is satisfied at the beginning (time t32) of the dead time period Td. More specifically, using either the detection result of the output current iU by a current sensor or a signal processing value thereof, or an estimated value of the load current iU, the inductance L of the resonant inductor L1 that has been stored in advance, and the detection result of the potential V15 at the regenerative capacitor 15, for example, the controller 50 determines the additional time Tau by the equation: Tau =iU x (L/V15). In this case, as the detection result of the load current iU or the signal processing value thereof, either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the inverse number of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

### (3.1.4) Operation of Making Soft Switching f First Switching Element When Load Current<0

If the polarity of the load current (which is the load current iU, the load current iV, or the load current iW) flowing through the AC terminal 41 connected to the target first switching element 1 is negative, then the controller 50 compares the current value of the load current with a second current threshold value I2 (=−Ith, refer to FIG. 5). If the current value of the load current is less than the second current threshold value I2, the controller 50 does not turn the switch 8 ON. On the other hand, if the current value of the load current is greater than the second current threshold value I2, the controller 50 turns the switch 8 ON in the dead time period Td. In the power converter 100, if the current value of the load current is less than the second current threshold value I2, the controller 50 may charge, using the load current, the resonant capacitor 9U connected to the target first switching element 1 in series without turning ON the switch 8 corresponding to the target first switching element 1. This allows the power converter 100 to make zero-voltage soft switching of the target first switching element 1.

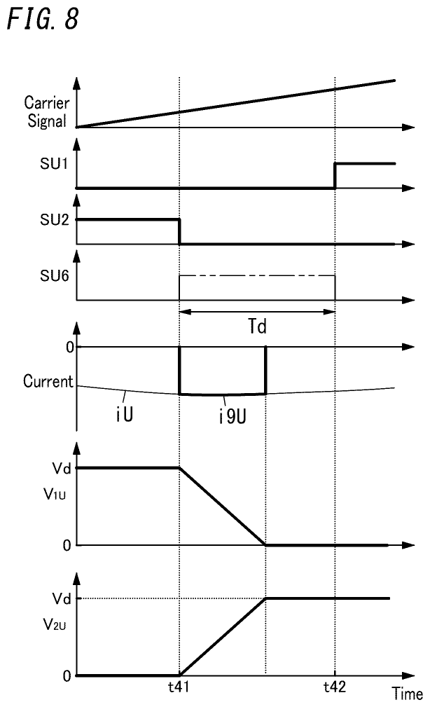

In FIG. 8, the control signals SU1, SU2, SU6, the load current iU, a current i9U flowing from the resonant capacitor 9U, and the voltage V_{2U} across the second switching element 2U are shown as for a situation where the target first switching element 1 is the first switching element 1U of the switching circuit 10U and the current value of the load current is greater than the second current threshold value I2 (in other words, a situation where the absolute value of the current value of the load current is less than the absolute value of the second current threshold value I2). In addition, the dead time period Td is also shown in FIG. 8.

If the current value of the load current is less than the second current threshold value I2 (in other words, if the absolute value of the load current is greater than the absolute value of the second current threshold value I2), the controller 50 does not provide any high-level period for the control signal SU6. In that case, in the power converter 100, a current iU9 starts flowing through the resonant capacitor 9U at the beginning (time t41) of the dead time period Td. As a result, in the power converter 100, the resonant capacitor 9U is charged with electricity to cause an increase in the voltage V_{2U} across the second switching element 2U. The current i9U goes zero before the end (time t23) of the dead time period Td, and the voltage V_{1U} across the first switching element 1 goes zero before the end (time t42) of the dead time period Td. Thus, in the power converter 100, when the control signal SU1 changes from low level to high level at the end (time t42) of the dead time period Td, the first switching element 1 is subjected to zero-voltage soft switching.

If the current value of the load current is greater than the second current threshold value I2 (in other words, if the absolute value of the load current is less than the absolute value of the second current threshold value), then the controller 50 provides a high-level period for the control signal SU6 as indicated by the two-dot chain in FIG. 8, for example. In that case, the beginning of the high-level period of the control signal SU6 may be simultaneous with, for example, the beginning (time t41) of the dead time period Td. Also, the end of the high-level period of the control signal SU6 is simultaneous with the end (time t42) of the dead time period Td. Thus, in the power converter 100, the voltage V_{1U} across the first switching element 1U goes zero before the end (time t42) of the dead time period Td. Consequently, in the power converter 100, when the control signal SU1 changes from low level to high level at the end (time t42) of the dead time period Td, the first switching element 1 is subjected to zero-voltage soft switching.

### (3.2) Operation to Be Performed When Determination is Made That Two-Phase Resonant Currents Flow Simultaneously

The controller 50 may perform a first control operation, a second control operation, and a third control operation when determining that resonant currents, respectively passing through two of the plurality of switches 8, flow simultaneously through the resonant inductor L1. As used herein, the expression “when determining that resonant currents, respectively passing through two of the plurality of switches 8, flow simultaneously” refers to a situation where it has been presumed in advance that the resonant currents respectively passing through the two switches 8 will flow simultaneously through the resonant inductor L1.

### (3.2.1) Determining Whether Resonant Currents Flow Simultaneously

In the power converter 100, the phases of three-phase (i.e., U-, V-, and W-phase) voltage instructions are different from each other by 120 degrees, but the instruction values of two-phase voltage instructions approach each other every electrical angle of 60 degrees and the duties of two-phase control signals approach each other (refer to regions A1, A2 shown in FIG. 2). Specifically, in the region A1 shown in FIG. 2, the duty of the U-phase control signal and the duty of the V-phase control signal become around 0.75. In the region A2 shown in FIG. 2, the duty of the U-phase control signal and the duty of the V-phase control signal become around 0.25. The polarity of the resonant current is the same as the polarity of the current iL1. In the region A1, the polarity of the resonant current is positive. In the region A2, the polarity of the resonant current is negative. In the region A1, the time lag between the beginning (time t1; refer to FIG. 3) of the high-level period of the control signal SU6 to be applied to the first IGBT 6U and the beginning (time t5; refer to FIG. 3) of the high-level period of the control signal SV6 to be applied to the first IGBT 6V becomes so short in one cycle time of the carrier signal that the U-phase resonant current and the V-phase resonant current may flow simultaneously through the resonant inductor L1. In the power converter 100, the direction of the resonant current in the region A2 is reverse from that of the resonant current in the region A1 but the U-phase resonant current and the V-phase resonant current may flow simultaneously through the resonant inductor L1.

Supposing the capacitance of each of the plurality of resonant capacitors 9U, 9U, and 9W is C, if a U-phase current and a V-phase current flow simultaneously through the resonant inductor L1, a capacitor having a combined capacitance (=2×C) of the resonant capacitor 9U and the resonant capacitor 9V is connected to the resonant inductor L1 in series in an equivalent circuit. Thus, in the power converter 100, if two-phase currents flow simultaneously through the resonant inductor L1, then the resonant frequency of a resonant circuit including the resonant inductor L1 changes compared to a situation where a single-phase current flows through the resonant inductor L1. Consequently, the power converter 100 may be unable to make zero-voltage soft switching.

### (3.2.1.1) When Charging Operation is Performed on Resonant Capacitor

FIG. 3 shows an exemplary boundary condition between a situation where the U-phase resonant current and the V-phase resonant current do not overlap with each other (i.e., do not flow simultaneously) and a situation where the U-phase resonant current and the V-phase resonant current overlap with each other (i.e., flow simultaneously). The boundary condition will be described with reference to FIG. 3.

In the power converter 100, if the time lag ΔT between the beginning (time t3) of the high-level period of the control signal SU1 and the beginning (time t7) of the high-level period of the control signal SV1 is equal to or greater than (Tau+Tav+Td), then the U-phase resonant current and the V-phase resonant current do not overlap with each other. On the other hand, if the time lag ΔT is less than (Tau+Tav+Td), then the U-phase resonant current and the V-phase resonant current overlap with each other. That is to say, with a threshold value for the time lag ΔT set at (Tau+Tav+Td), if the time lag ΔT is less than the threshold value, the controller 50 presumes that resonant currents corresponding to the two phases of the switching circuit 10U and the switching circuit 10V belonging to the plurality of switching circuits 10 would flow simultaneously through the resonant inductor L1. Note that this threshold value is only an example, and the threshold value may also be set at any other value. For example, with the error of the additional time Tau and the error of the additional time Tav taken into account, the threshold value may also be set at a value even larger than (Tau+Tav+Td). Optionally, the controller 50 may also set a threshold value with respect to the time lag ΔT at the same value as, for example, a resonant half cycle (in this embodiment, resonant half cycle =dead time period Td). In that case, if the time lag ΔT is less than the length of the dead time period Td, then the controller 50 presumes that resonant currents corresponding to the two phases of the switching circuits 10U and 10V will flow simultaneously through the resonant inductor L1. In addition, the above-described method for calculating the time lag to determine whether the two-phase resonant currents flow simultaneously is only an example. Rather, any other calculating method may also be adopted as long as a time lag corresponding to the time lag described above may be calculated. For example, as the time lag for use to determine whether the two-phase resonant currents flow simultaneously, a time lag between the end (time t2) of the high-level period of the control signal SU2 and the end (time t6) of the high-level period of the control signal SV2 may also be used.

In the power converter 100, if the time lag between the beginning (time t3) of the high-level period of the control signal SU1 and the beginning (time t11) of the high-level period of the control signal SW1 is equal to or greater than (Tau+Taw+Td), then the U-phase resonant current and the W-phase resonant current do not overlap with each other. On the other hand, if the time lag is less than (Tau+Taw+Td), then the U-phase resonant current and the W-phase resonant current overlap with each other. That is to say, with a threshold value for the time lag set at (Tau+Taw+Td), if the time lag is less than the threshold value, the controller 50 presumes that resonant currents corresponding to the two phases of the switching circuit 10U and the switching circuit 10W belonging to the plurality of switching circuits 10 would flow simultaneously through the resonant inductor L1. Note that this threshold value is only an example, and the threshold value may also be set at any other value. For example, with the error of the additional time Tau and the error of the additional time Taw taken into account, the threshold value may also be set at a value even larger than (Tau+Taw+Td). Furthermore, the controller 50 may set the threshold value for the time lag at the same value as the resonant half cycle (in this embodiment, resonant half cycle=dead time period Td). In that case, if the time lag is less than the length of the dead time period Td, then the controller 50 presumes that resonant currents corresponding to the two phases of the switching circuits 10U and 10V will flow simultaneously through the resonant inductor L1. In addition, the above-described method for calculating the time lag to determine whether the two-phase resonant currents flow simultaneously is only an example. Rather, any other calculating method may also be adopted as long as a time lag corresponding to the time lag described above may be calculated. For example, as the time lag for use to determine whether the two-phase resonant currents flow simultaneously, a time lag between the end (time t2) of the high-level period of the control signal SU2 and the end (time t10) of the high-level period of the control signal SW2 may also be used.

In the power converter 100, if the time lag between the beginning (time t7) of the high-level period of the control signal SV1 to be applied to the first switching element 1V of the switching circuit 10V and the beginning (time t11) of the high-level period of the control signal SW1 to be applied to the first switching element 1W of the switching circuit 10W is equal to or greater than (Tav+Taw+Td), then the V-phase resonant current and the W-phase resonant current do not overlap with each other. On the other hand, if the time lag is less than (Tav+Taw+Td), then the V-phase resonant current and the W-phase resonant current overlap with each other. That is to say, with a threshold value for the time lag set at (Tav+Taw+Td), if the time lag is less than the threshold value, the controller 50 presumes that resonant currents corresponding to the two phases of the switching circuit 10V and the switching circuit 10W belonging to the plurality of switching circuits 10 would flow simultaneously through the resonant inductor L1. Note that this threshold value is only an example, and the threshold value may also be set at any other value. For example, with the error of the additional time Tav and the error of the additional time Taw taken into account, the threshold value may also be set at a value even larger than (Tav+Taw+Td). Furthermore, the controller 50 may set the threshold value for the time lag at the same value as the resonant half cycle (in this embodiment, resonant half cycle=dead time period Td). In that case, if the time lag is less than the length of the dead time period Td, then the controller 50 presumes that resonant currents corresponding to the two phases of the switching circuits 10V and 10W will flow simultaneously through the resonant inductor L1. In addition, the above-described method for calculating the time lag to determine whether the two-phase resonant currents flow simultaneously is only an example. Rather, any other calculating method may also be adopted as long as a time lag corresponding to the time lag described above may be calculated. For example, as the time lag for use to determine whether the two-phase resonant currents flow simultaneously, a time lag between the end (time t6) of the high-level period of the control signal SV2 and the end (time t10) of the high-level period of the control signal SW2 may also be used.

### (3.2.1.2) When Discharging Operation is Performed on Resonant Capacitor

When performing a discharging operation on the resonant capacitor 9, the controller 50 may also determine, using the same time lag and threshold value as in the case of performing the charging operation on the resonant capacitor 9, whether two-phase resonant currents flow simultaneously.

For example, if the time lag between the beginning of the high-level period of the control signal SU2 and the beginning of the high-level period of the control signal SV2 is less than the threshold value (e.g., Tau+Tav+Td), then the controller 50 presumes that the U-phase resonant current and the V-phase resonant current would overlap with each other.

Also, if the time lag between the beginning of the high-level period of the control signal SU2 and the beginning of the high-level period of the control signal SW2 is less than the threshold value (e.g., Tau+Taw+Td), then the controller 50 presumes that the U-phase resonant current and the W-phase resonant current would overlap with each other.

Furthermore, if the time lag between the beginning of the high-level period of the control signal SV2 and the beginning of the high-level period of the control signal SW2 is less than the threshold value (e.g., Tav+Taw+Td), then the controller 50 presumes that the V-phase resonant current and the W-phase resonant current would overlap with each other.

### (3.2.2) First Control Operation, Second Control Operation, and Third Control Operation

### (3.2.2.1) Operation Performed to Make Soft Switching of First Switching Element

The controller 50 performs the first control operation by allowing the respective high-level periods of control signals for two switches 8 to overlap with the dead time period Td corresponding to each of two switching circuits 10 connected to the two switches 8 for a predetermined period.

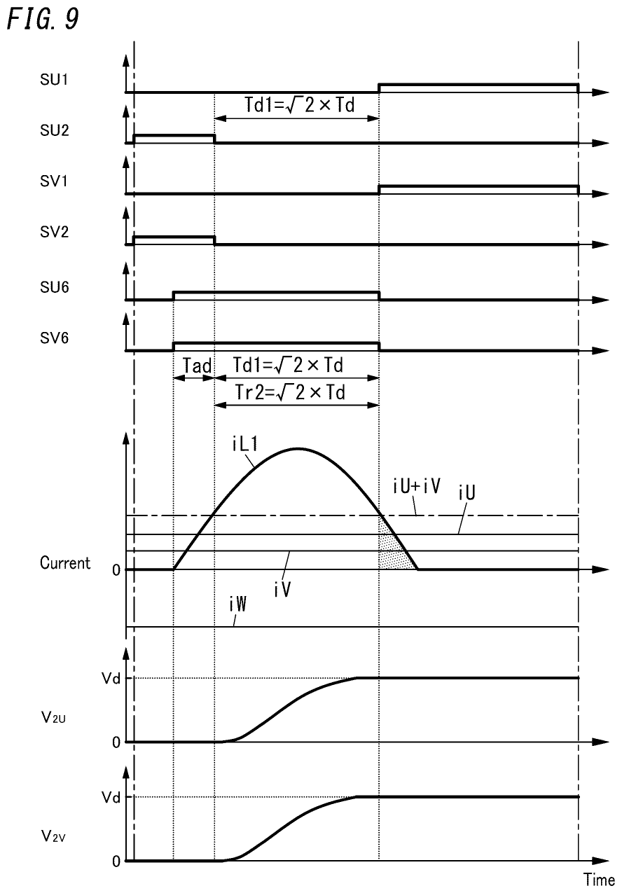

The controller 50 performs the second control operation by determining the beginning of the high-level period of a control signal for at least one of the plurality of switches 8 according to the load current flowing through the AC load RA1. In this case, the controller 50 performs the second control operation by shifting the beginnings of respective high-level periods of two control signals for two switches 8 belonging to the plurality of switches 8 according to the total value of two-phase load currents respectively flowing through two AC terminals 41 connected to two switches 8 which belong to the plurality of AC terminals 41. In the example shown in FIGS. 9, the beginnings of respective high-level periods of control signals SU6, SV6 for two switches 8 are shifted according to the total value of the U-phase load current iU flowing through the AC terminal 41U and the V-phase load current iV flowing through the AC terminal 41V.

The controller 50 may perform the third control operation by making the dead time periods Td1, Td2 respectively corresponding to two or more switching circuits 10 connected to two or more switches 8 which belong to the plurality of switching circuits 10 longer than a predetermined dead time period Td by an additional time Tad. The predetermined dead time period Td is the dead time period Td in the case of the basic operation.

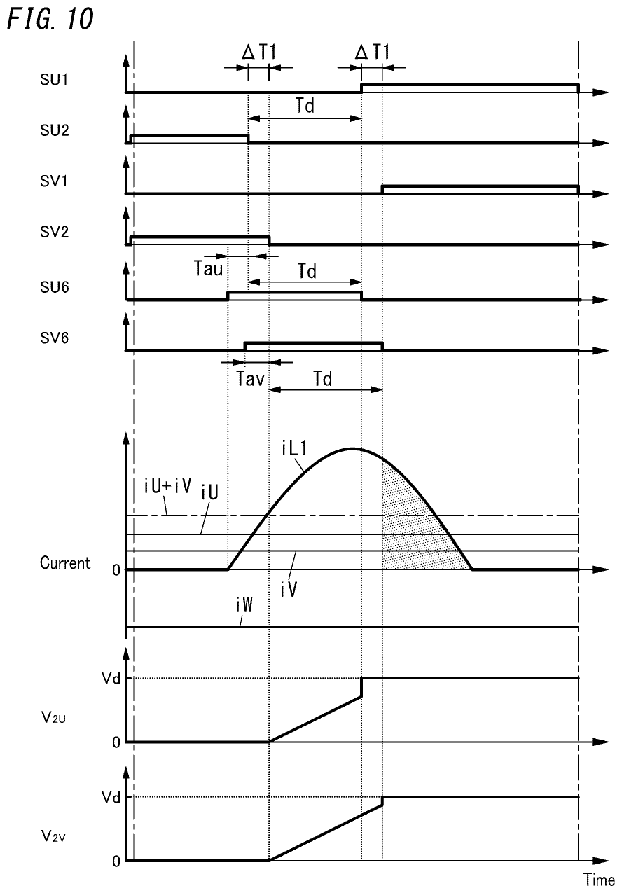

FIG. 9 is a timing chart illustrating how the power converter 100 operates if the controller 50 has performed the first, second, and third control operations. FIG. 10 is a timing chart illustrating how the power converter 100 operates if the controller 50 does not perform the first control operation, the second control operation, or the third control operation. As used herein, the predetermined period may form at least part of one resonant half cycle of a resonant circuit including, for example, the resonant inductor L1 and two resonant capacitors 9 (e.g., the resonant capacitors 9U, 9V in this example). Supposing the resonant half cycle in a situation where the resonant circuit includes two resonant capacitors 9 (in other words, in a situation where the current iL1 flowing through the resonant inductor L1 includes two-phase resonant currents) is Tr2, the resonant half cycle Tr2 is one half of a resonant cycle, which is the inverse number of the resonant frequency of a resonant circuit including the resonant inductor L1 and the two resonant capacitors 9. If the resonant circuit includes two resonant capacitors 9, the resonant half cycle Tr2 of the resonant circuit is given by Tr2=2^{1/2}×π×(L·C)^{1/2}, where L is the inductance of the resonant inductor L1, and C is the capacitance of each of the two resonant capacitors 9. In the example shown in FIG. 9, the predetermined period is all of the resonant half cycle Tr2. In other words, the length of the predetermined period is 100% of the resonant half cycle Tr2.

Next, it will be described in further detail how the controller 50 operates.

When determining that two-phase resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U-and W phases and the combination of V-and W-phases as well.

The first step includes synchronizing U-phase control signals SU1, SU2 with V-phase control signals SV1, SV2. In the example shown in FIG. 9, the U-phase control signals SU1, SU2 are synchronized with the V-phase control signals SV1, SV2 by shifting (advancing), by ΔT1, the beginning of the high-level period of the V-phase control signal SV1 and the end of the high-level period of the V-phase control signal SV2 compared with the example shown in FIG. 10. In the power converter 100 according to the first embodiment, the first step corresponds to the first control operation to be performed by the controller 50. In the example shown in FIG. 10, ΔT1 is either the time lag between the beginning of the high-level period of the control signal SU1 and the beginning of the high-level period of the control signal SV1 or the time lag between the end of the high-level period of the control signal SU2 and the end of the high-level period of the control signal SV2. Alternatively, the first step may include synchronizing the U-phase control signals SU1, SU2 with the V-phase control signals SV1, SV2 by shifting (postponing), by ΔT1, the respective high-level periods of the U-phase control signals SU1, SU2. Still alternatively, the first step may include synchronizing the U-phase control signals SU1, SU2 with the V-phase control signals SV1, SV2 by shifting, by ΔT1 in total, the U-phase control signals SU1, SU2 and the V-phase control signals SV1, SV2.

The second step includes adding an additional time Tad corresponding to the total current value |iU+iV| of the two-phase load currents iU, iV to the respective high-level periods of control signals SU6, SV6 for two-phase switches 8 corresponding to the two-phase dead time periods Td (refer to FIG. 10), respectively. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/V15. In the power converter 100 according to the first embodiment, the second step corresponds to the second control operation to be performed by the controller 50.

The third step includes changing the lengths of the respective high-level periods and dead time periods Td of the control signals SU6, SV6 according to the resonant half cycle Tr2 (=2^{1/2}×π×(L·C)^{1/2}) of the resonant circuit. More specifically, the controller 50 subtracts the additional time Tad from the high-level period of each of the control signals SU6, SV6 and sets the length of the remainder period as the resonant half cycle Tr2 of the resonant circuit and changes the dead time period Td into a dead time period Td1 which is equal to the resonant half cycle Tr2 of the resonant circuit. In the power converter 100 according to the first embodiment, the third step corresponds to the third control operation to be performed by the controller 50. Note that the end of the control signal SU6, SV6 may be simultaneous with, or later than, the end of the resonant half cycle Tr2.

In this power converter 100, if the controller 50 does not perform any of the first, second, and third control operations, then the voltage V_{2U}, V_{2V} across the second switching element 2U, 2V has not risen to Vd at a point in time when the control signal SU1, SV1 makes transition from the low-level period to the high-level period (i.e., at the end of the dead time period Td corresponding to each of the U- and V-phases) as shown in FIG. 10. That is to say, if the controller 50 does not perform any of the first, second, and third control operations, then the resonant capacitor 9U, 9V has not been charged fully yet at the end of the dead time period Td corresponding to each of the U- and V-phases. Thus, if the controller 50 does not perform any of the first, second, and third control operations, then the voltage across each of the first switching elements 1U, 1V has not decreased to zero at the end of the dead time period Td corresponding to each of the U- and V-phases. As a result, in the power converter 100, the first switching element 1U, 1V is switched by hard switching.

On the other hand, if the controller 50 has performed the first, second, and third control operations, then the voltage V_{2U}, V_{2V} across the second switching element 2U, 2V rises to Vd at a point in time when the control signal SU1, SV1 makes transition from the low-level period to the high-level period (i.e., at the end of the dead time period Td corresponding to each of the U-and V-phases) as shown in FIG. 9. That is to say, if the controller 50 has performed the first, second, and third control operations, then the resonant capacitor 9U, 9V is charged fully at the end of the dead time period Td corresponding to each of the U-and V-phases. Thus, if the controller 50 has performed the first, second, and third control operations, the first switching element 1U, 1V is switched by zero-voltage soft switching in the power converter 100.

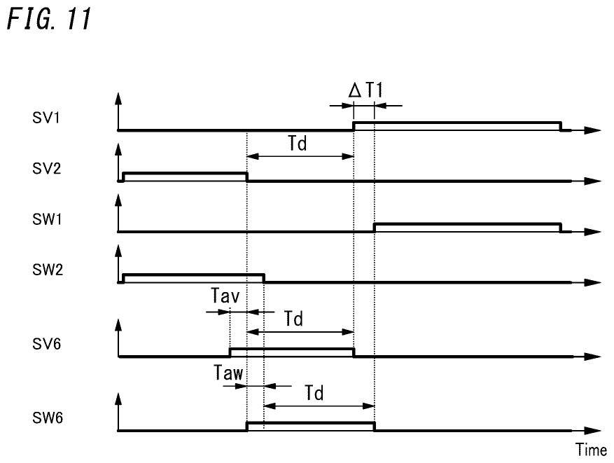

Note that FIG. 10 shows the relation between the respective control signals SU1, SU2, SV1, SV2, SU6, SV6 and other physical quantities in an exemplary situation where the control signal SU6 for the U-phase switch 8 and the control signal SV6 for the V-phase switch 8 overlap with each other. However, this is only an example and should not be construed as limiting. Rather, no matter whether the V- and W-phases overlap with each other or the W-and U-phases overlap with each other, for example, zero-voltage soft switching may also be made by having the controller 50 perform the first, second, and third control operations. FIG. 11 shows an exemplary relation between the respective control signals SV1, SV2, SW1, SW2, SV6, SW6 in an exemplary situation where the control signal SV6 for the V-phase switch 8 and the control signal SW6 for the W-phase switch 8 overlap with each other.

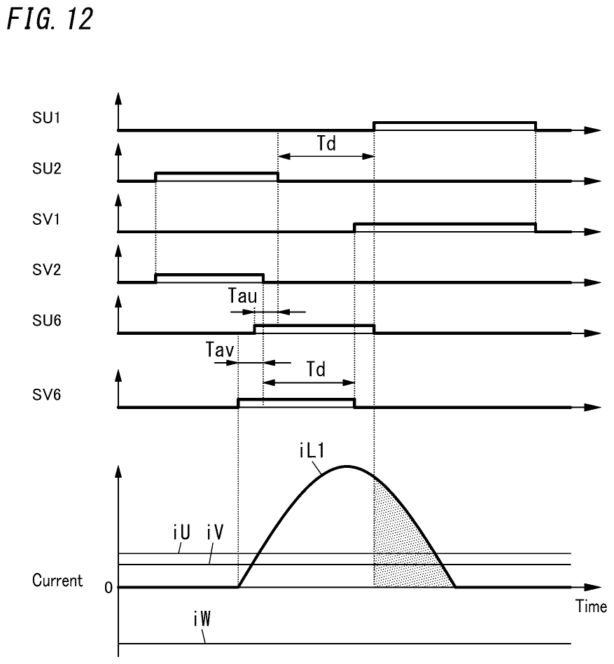

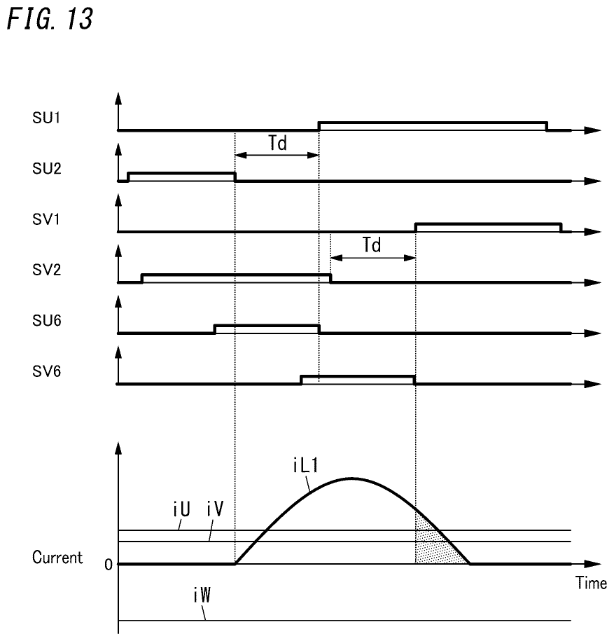

Also, if two-phase resonant currents are determined to overlap with each other, then two control signals for two switches 8 need to overlap with each other at least partially. In that case, neither the temporal relation between control signals for the first switching elements 1 nor the temporal relation between control signals for the second switching elements 2 is particularly limited. For example, as shown in FIG. 12, the beginning of the high-level period of the control signal SV1 may be earlier than the beginning of the high-level period of the control signal SU1 and the beginning of the high-level period of the control signal SV6 may be earlier than the beginning of the high-level period of the control signal SU6 as shown in FIG. 12. Also, the dead time period Td between the control signals SU1, SU2 does not have to overlap with the dead time period Td between the control signals SV1, SV2 but the respective high-level periods of the control signals SU6, SV6 may partially overlap with each other as shown in FIG. 13.

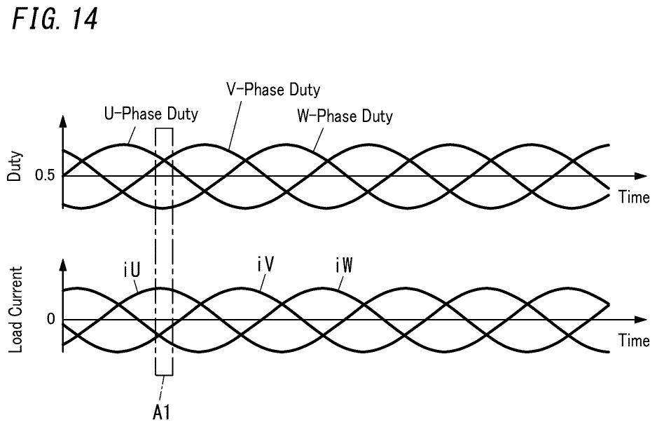

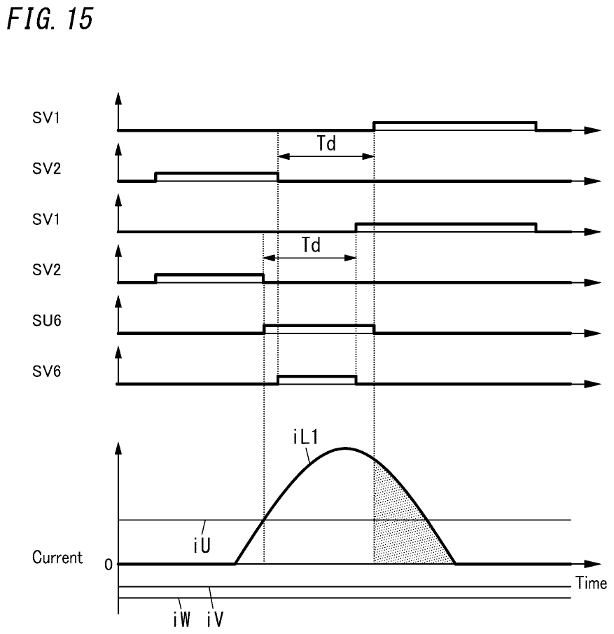

Furthermore, in a situation where two-phase resonant currents overlap with each other, the relation in polarity and magnitude between the two-phase load currents is not limited to the relation iU>iV>0 in the region A1 of the example shown in FIG. 2 but may also be the relation iU>0>iV in the region A1 of the example shown in FIG. 14. In that case, the control signals SU6 and SV6 overlap with each other and the two-phase resonant currents overlap with each other as shown in FIG. 15, for example.

### (3.2.2.2) Operation Performed to Make Soft Switching of Second Switching Element

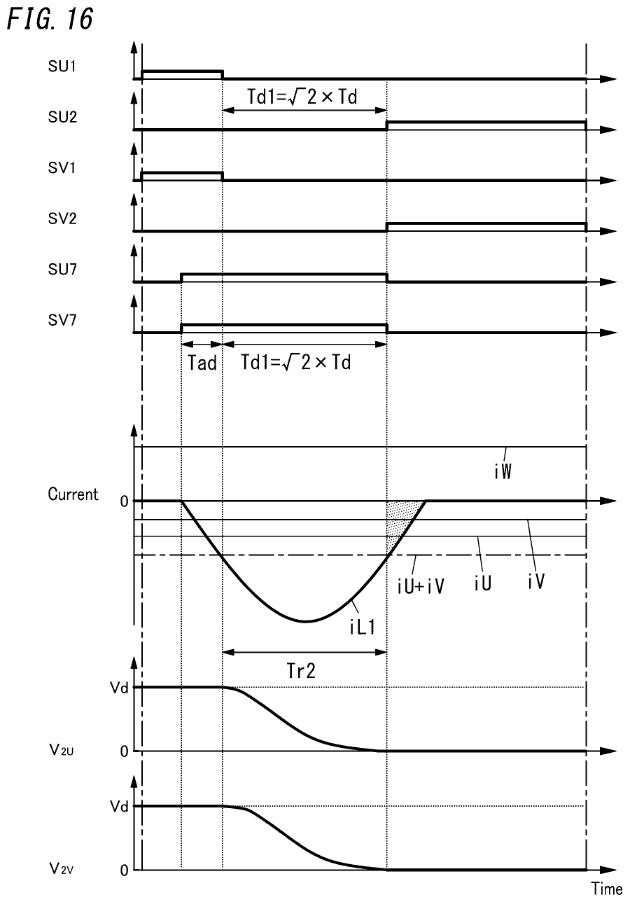

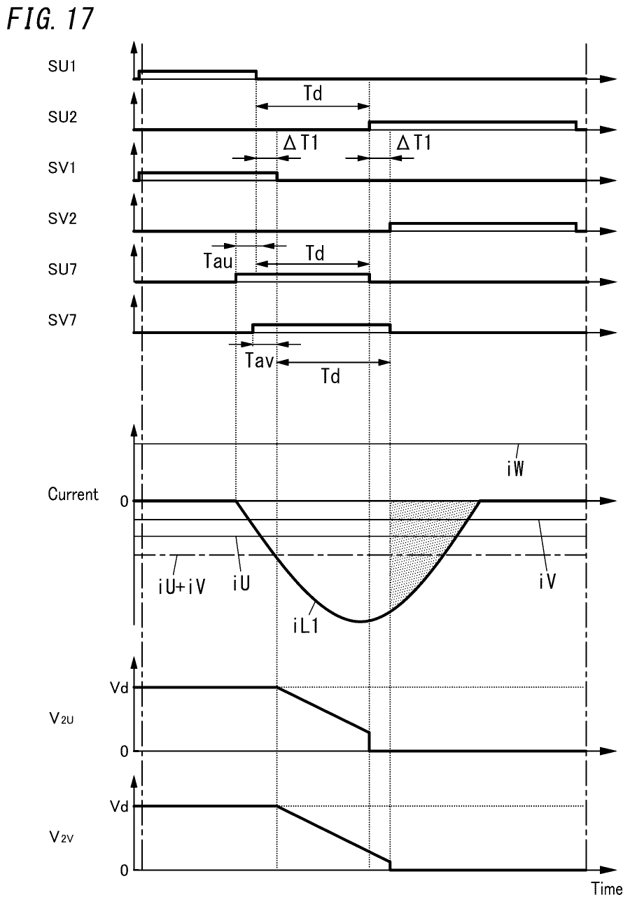

The controller 50 performs the first control operation by allowing the respective high-level periods of control signals for two or more switches 8 to overlap, for a predetermined period, with the dead time period Td (refer to FIG. 17, for example) corresponding to each of two switching circuits 10 respectively connected to the two switches 8 which belong to the plurality of switching circuits 10. FIG. 16 is a timing chart illustrating how the power converter 100 operates if the controller 50 has performed the first control operation, the second control operation, and the third control operation. FIG. 17 is a timing chart illustrating how the power converter 100 operates if the controller 50 does not perform the first control operation, the second control operation, or the third control operation. As used herein, the predetermined period may form at least part of one resonant half cycle Tr2 of a resonant circuit including, for example, the resonant inductor L1 and two resonant capacitors 9 respectively connected to the two switches 8. The resonant half cycle Tr2 is given by Tr2=2^{1/2}×π×(L·C)^{1/2}. In the example shown in FIG. 16, the predetermined period is all of the resonant half cycle Tr2. In other words, the length of the predetermined period is 100% of the length of the resonant half cycle.

Next, it will be described in further detail how the controller 50 operates.

When determining that resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U-and W phases and the combination of V- and W-phases as well.

The first step includes synchronizing U-phase control signals SU1, SU2 with V-phase control signals SV1, SV2. In the example shown in FIG. 16, the U-phase control signals SU1, SU2 are synchronized with the V-phase control signals SV1, SV2 by shifting (advancing), by ΔT1, the end of the high-level period of the V-phase control signal SV1 and the beginning of the high-level period of the V-phase control signal SV2 compared with the example shown in FIG. 17. In the power converter 100 according to the first embodiment, the first step corresponds to the first control operation to be performed by the controller 50. Alternatively, the first step may include synchronizing the U-phase control signals SU1, SU2 with the V-phase control signals SV1, SV2 by shifting (postponing), by ΔT1, the respective high-level periods of the U-phase control signals SU1, SU2. Still alternatively, the first step may include synchronizing the U-phase control signals SU1, SU2 with the V-phase control signals SV1, SV2 by shifting, by ΔT1 in total, the U-phase control signals SU1, SU2 and the V-phase control signals SV1, SV2.

The second step includes adding the additional time Tad corresponding to the total current value of the two-phase load currents iU, iV to the respective high-level periods of control signals SU7, SV7 for two-phase switches 8 corresponding to the two-phase dead time periods Td, respectively. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/V15. In the power converter 100 according to the first embodiment, the second step corresponds to the second control operation to be performed by the controller 50.

The third step includes changing the lengths of the respective high-level periods and dead time periods Td of the control signals SU7, SV7 according to the resonant half cycle Tr2 (=2^{1/2}×π×(L·C)^{1/2}) of the resonant circuit. More specifically, the controller 50 subtracts the additional time Tad from the high-level period of each of the control signals SU7, SV7 and sets the length of the remainder period as the resonant half cycle Tr2 of the resonant circuit and changes the dead time period Td into a dead time period Td1 which is equal to the resonant half cycle Tr2 of the resonant circuit. In the power converter 100 according to the first embodiment, the third step corresponds to the third control operation to be performed by the controller 50. Note that the end of the control signal SU7, SV7 may be simultaneous with, or later than, the end of the resonant half cycle Tr2.

In this power converter 100, if the controller 50 does not perform any of the first, second, and third control operations, then the voltage V_{2U}, V_{2V} across the second switching element 2U, 2V has not decreased to zero at a point in time when the control signal SU2, SV2 makes transition from the low-level period to the high-level period (i.e., at the end of the dead time period Td corresponding to each of the U- and V-phases) as shown in FIG. 17. That is to say, if the controller 50 does not perform any of the first, second, and third control operations, then the discharging of the resonant capacitor 9U, 9V has not been done yet at the end of the dead time period Td corresponding to each of the U- and V-phases in the power converter 100. Thus, if the controller 50 does not perform any of the first, second, and third control operations, the second switching element 2U, 2V is switched by hard switching in the power converter 100.

On the other hand, if the controller 50 has performed the first, second, and third control operations, then the voltage V_{2U}, V_{2V} across the second switching element 2U, 2V decreases to zero at a point in time when the control signal SU2, SV2 makes transition from the low-level period to the high-level period (i.e., at the end of the dead time period Td corresponding to each of the U- and V-phases) as shown in FIG. 16. That is to say, if the controller 50 has performed the first, second, and third control operations, then discharging of the resonant capacitor 9U, 9V is finished at the end of the dead time period Td1 corresponding to each of the U- and V-phases. Thus, if the controller 50 has performed the first, second, and third control operations, the second switching element 2U, 2V is switched by zero-voltage soft switching in the power converter 100.

### (3.3) Operation to Be Performed When Three-Phase Resonant Currents are Determined to Flow Simultaneously

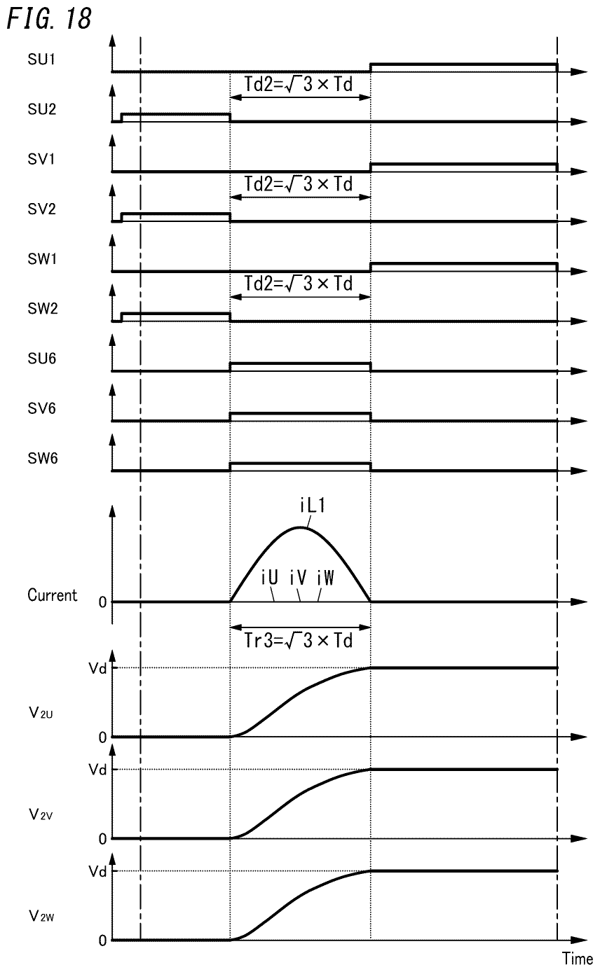

Next, it will be described with reference to FIG. 18 how the controller 50 operates when determining that resonant currents respectively passing through three switches 8 belonging to the plurality of switches 8 flow simultaneously through the resonant inductor L1. When determining that the resonant currents respectively passing through three switches 8 belonging to the plurality of switches 8 flow simultaneously through the resonant inductor L1, the controller 50 performs the first control operation. As used herein, the expression “when determining that the resonant currents respectively passing through three switches 8 belonging to the plurality of switches 8 flow simultaneously” refers to a situation where it has been presumed in advance that the resonant currents respectively passing through the three switches 8 would flow simultaneously through the resonant inductor L1. The three-phase resonant currents are supposed to overlap with each other in a situation where the status of the AC load RA1 is a light load and iU=0, iV=0, and iW=0. Such a state arises, for example, when the AC load RA1 is a motor, particularly when the motor is running at low velocities or when the rotational velocity of the motor is zero (e.g., when the motor is locked). Thus, when the rotational velocity (e.g., number of revolutions (rpm)) of the motor is less than a rotational velocity threshold value, for example, the controller 50 determines that three-phase resonant currents should flow simultaneously. In this case, the controller 50 determines that three-phase resonant currents should flow simultaneously, for example, if the rotational velocity determined by calculation, or estimated, based on sensor information provided by a sensor device (such as an encoder or a resolver) for detecting the number of revolutions of the motor is less than the rotational velocity threshold value.

Supposing the capacitance of each of the plurality of resonant capacitors 9U, 9U, and 9W is C, if a U-phase current, a V-phase current, and a W-phase current flow simultaneously through the resonant inductor L1, a capacitor having a combined capacitance (=3×C) of the resonant capacitor 9U, the resonant capacitor 9V, and the resonant capacitor 9W is connected to the resonant inductor L1 in series in an equivalent circuit. Thus, in the power converter 100, if three-phase currents flow simultaneously through the resonant inductor L1, then the resonant frequency of a resonant circuit including the resonant inductor L1 changes compared to a situation where a single-phase current flows through the resonant inductor L1. Consequently, the power converter 100 may be unable to make zero-voltage soft switching.

### (3.3.1) First Control Operation

### (3.3.1.1) Operation Performed to Make Soft Switching of First Switching Element

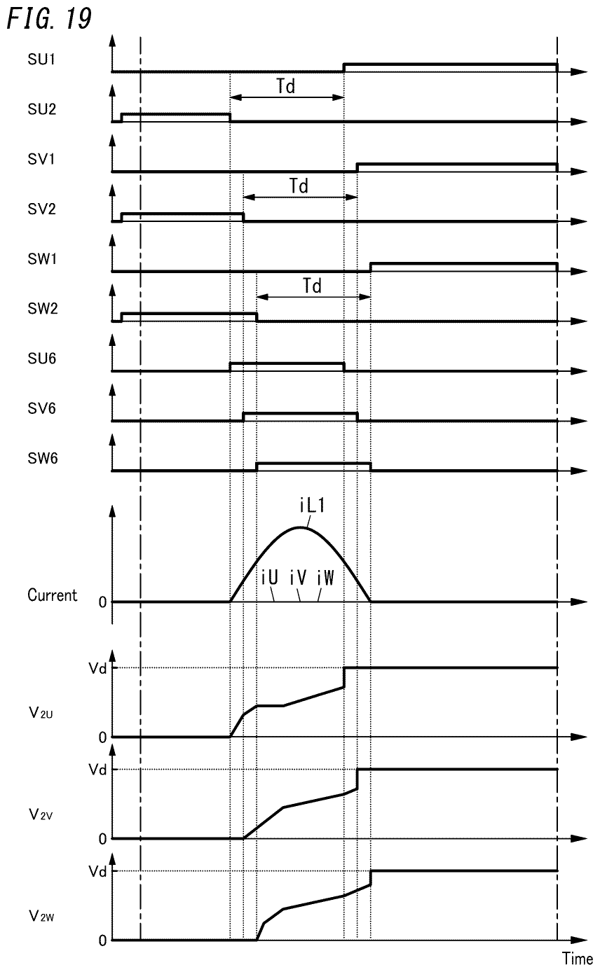

The controller 50 performs the first control operation by allowing the respective high-level periods of control signals for three switches 8 to overlap, for a predetermined period, with the dead time period Td (refer to FIG. 19, for example) corresponding to each of three switching circuits 10 respectively connected to the three switches 8 which belong to the plurality of switching circuits 10. FIG. 18 is a timing chart illustrating how the power converter 100 operates in a situation where its controller 50 has performed the first control operation. FIG. 19 is a timing chart illustrating how the power converter 100 operates in a situation where its controller 50 does not perform the first control operation. As used herein, the predetermined period may form at least part of one resonant half cycle of a resonant circuit including, for example, the resonant inductor L1 and three resonant capacitors 9 respectively connected to the three switches 8. Supposing the resonant half cycle in a situation where the resonant circuit includes three resonant capacitors 9 (in other words, in a situation where the current iL1 flowing through the resonant inductor L1 includes three-phase resonant currents) is Tr3, the resonant half cycle Tr3 is one half of a resonant cycle, which is the inverse number of the resonant frequency of a resonant circuit including the resonant inductor L1 and the three resonant capacitors 9. If the resonant circuit includes three resonant capacitors 9, the resonant half cycle Tr3 of the resonant circuit is given by Tr3=3^{1/2}×π×(L·C)^{1/2}, where L is the inductance of the resonant inductor L1, and C is the capacitance of each of the three resonant capacitors 9. In the example shown in FIG. 18, the predetermined period is all of the resonant half cycle Tr3. In other words, the length of the predetermined period is 100% of the resonant half cycle.

When performing the first control operation, the controller 50 makes the dead time period Td2 as long as the resonant half cycle Tr3. Thus, when performing the first control operation, the controller 50 sets the length the dead time period Td2 at 3^{1/2} times the length of the dead time period Td in the case of the basic operation. In addition, the controller 50 also synchronizes not only respective beginnings of the high-level periods of control signals SU6, SV6, SW6 for the first IGBTs 6U, 6V, 6W of the three switches 8, through which the resonant currents flow with each other but also respective ends of the high-level periods thereof with each other.

Next, it will be described in further detail how the controller 50 operates.

When determining that three-phase resonant currents overlap with each other, the controller 50 performs a first step and a second step in this order.

The first step includes synchronizing U-phase control signals SU1, SU2, V-phase control signals SV1, SV2, and W-phase control signals SW1, SW2 with each other. In the example shown in FIG. 18, the U-phase control signals SU1, SU2, the V-phase control signals SV1, SV2, and the W-phase control signals SW1, SW2 are synchronized with each other by shifting (advancing) the beginning of the high-level period of the V-phase control signal SV1 and the end of the high-level period of the V-phase control signal SV2 and shifting (advancing) the beginning of the high-level period of the W-phase control signal SW1 and the end of the high-level period of the W-phase control signal SW2 compared with the example shown in FIG. 19. Alternatively, the first step may include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (advancing) the high-level period of each of the W-phase control signals SW1, SW2. Still alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (postponing) the high-level period of each of the V-phase control signals SV1, SV2. Yet alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2, shifting (postponing) the high-level period of each of the V-phase control signals SV1, SV2, and shifting (advancing) the high-level period of each of the W-phase control signals SW1, SW2.

The second step includes changing the respective high-level periods and dead time periods Td of the control signals SU6, SV6, SW6 according to the resonant half cycle Tr3 (=3^{1/2}×π×(L·C)^{1/2}) of the resonant circuit. More specifically, the controller 50 sets the length of the high-level period of each of the control signals SU6, SV6, SW6 at the resonant half cycle Tr3 of the resonant circuit and sets the dead time period Td at a dead time period Td2 which is equal to the resonant half cycle Tr3 of the resonant circuit. Note that if load current iU=0, load current iV=0, and load current iW=0, then the controller 50 sets each of the additional times Tau, Tav, Taw at zero.

In this power converter 100, if the controller 50 does not perform the first control operation, then the voltage V_{2U}, V_{2V}, V_{2W} across the second switching element 2U, 2V, 2W has not risen to Vd at a point in time when the control signal SU1, SV1, SW1 makes transition from the low-level period to the high-level period (i.e., at the end of the dead time period Td corresponding to each of the U-, V-, and W-phases) as shown in FIG. 19. That is to say, in the power converter 100, if the controller 50 does not perform the first control operation, then the resonant capacitor 9U, 9V, 9W has not been charged fully yet at the end of the dead time period Td corresponding to each of the U-, V-, and W-phases. Thus, in the power converter 100, if the controller 50 does not perform the first control operation, then the voltage across each of the first switching elements 1U, 1V, 1W has not decreased to zero at the end of the dead time period Td corresponding to each of the U-, V-, and W-phases. As a result, in the power converter 100, the first switching element 1U, 1V, 1W is switched by hard switching.

On the other hand, in the power converter 100, if the controller 50 has performed the first control operation, then the voltage V_{2U}, V_{2V}, V_{2W} across the second switching element 2U, 2V, 2W rises to Vd at a point in time when the control signal SU1, SV1, SW1 makes transition from the low-level period to the high-level period (i.e., at the end of the dead time period Td2 corresponding to each of the U-, V-, and V-phases) as shown in FIG. 18. That is to say, in the power converter 100, if the controller 50 has performed the first control operation, then the resonant capacitor 9U, 9V, 9W is charged fully at the end of the dead time period Td2 corresponding to each of the U-, V-, and W-phases. Thus, in the power converter 100, if the controller 50 has performed the first control operation, the first switching element 1U, 1V, 1W is switched by zero-voltage soft switching.

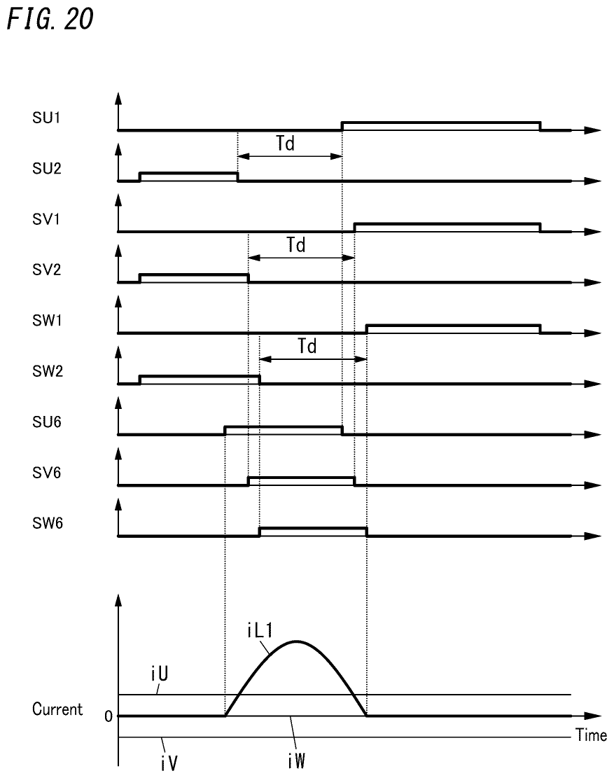

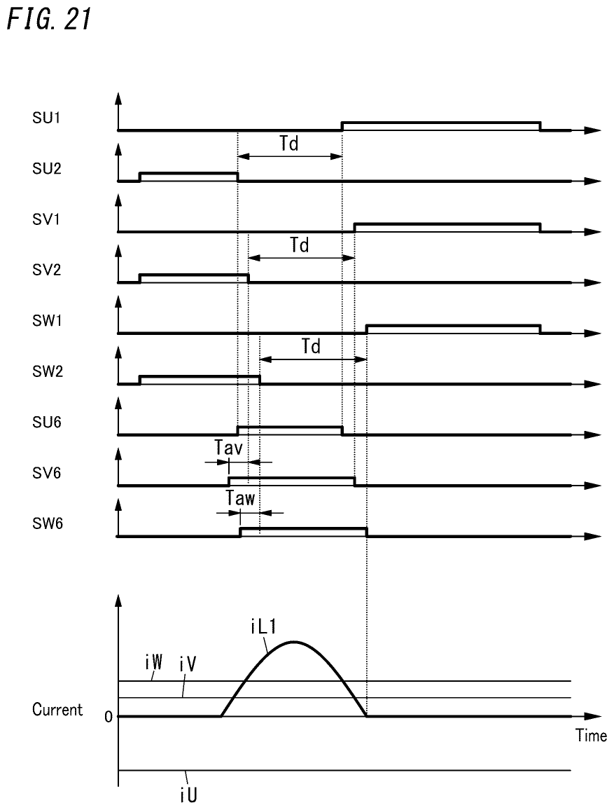

Furthermore, in a situation where three-phase resonant currents are determined to overlap with each other, the relation in polarity and magnitude between the three-phase load currents is not limited to the relation iU=0, iV=0, and iW=0 in the example shown in FIG. 20, for example, but may also be the relation iU>0>iV as shown in FIG. 20 or the relation iW>iV>0>iU as shown in FIG. 21, for example.

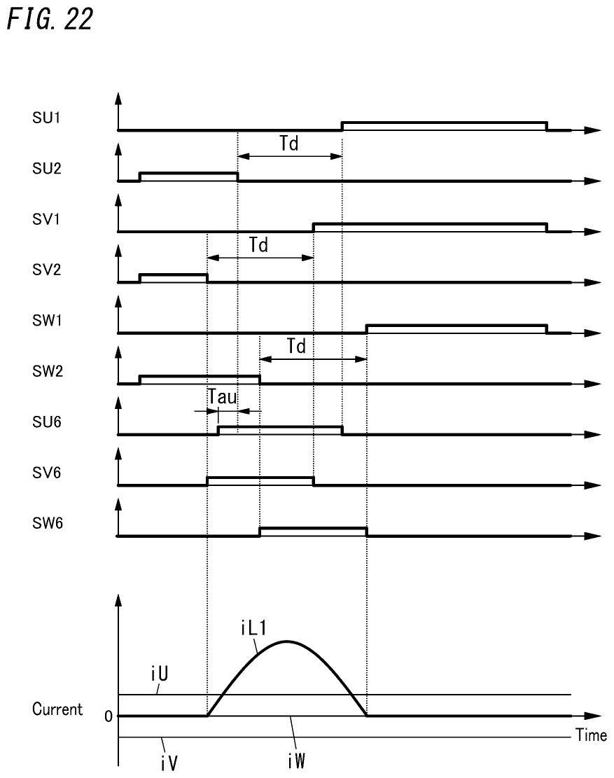

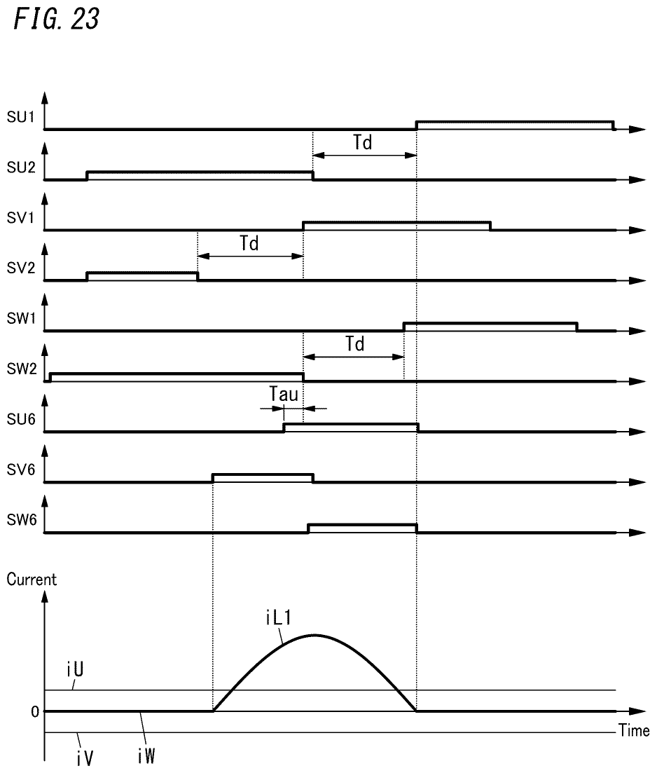

Also, three control signals for three switches 8 need to overlap with each other at least partially. In that case, neither the temporal relation between control signals for the first switching elements 1 nor the relation between control signals for the second switching elements 2 is not limited. For example, as shown in FIG. 22, the beginning of the high-level period of the control signal SV1 may be earlier than the beginning of the high-level period of the control signal SU1, the beginning of the high-level period of the control signal SU1 may be earlier than the beginning of the high-level period of the control signal SW1, the beginning of the high-level period of the control signal SV6 may be earlier than the beginning of the high-level period of the control signal SU6, and the beginning of the high-level period of the control signal SU6 may be earlier than the beginning of the high-level period of the control signal SW6 as shown in FIG. 22. Also, the dead time period Td between the control signals SU1, SU2 does not have to overlap with the dead time period Td between the control signals SV1, SV2 but the respective high-level periods of the control signals SU6, SV6, SW may partially overlap with each other as shown in FIG. 23. Note that in the case of the operation to make soft switching of the first switching element 1 (i.e., in the case of performing a charging operation on the resonant capacitor 9), in a situation where three-phase resonant currents flow simultaneously, the additional time Tau, Tav, Taw is preferably added to the high-level period of a switch 8 associated with the phase through which a positive load current flows when the load current is positive as well as when the basic operation is performed.

### (3.3.1.2) Operation Performed to Make Soft Switching of Second Switching Element

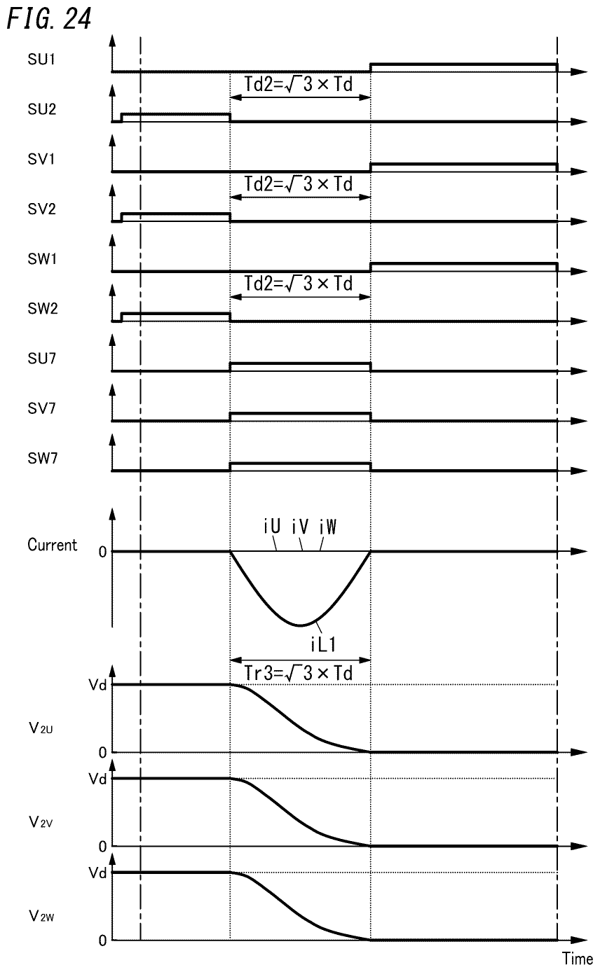

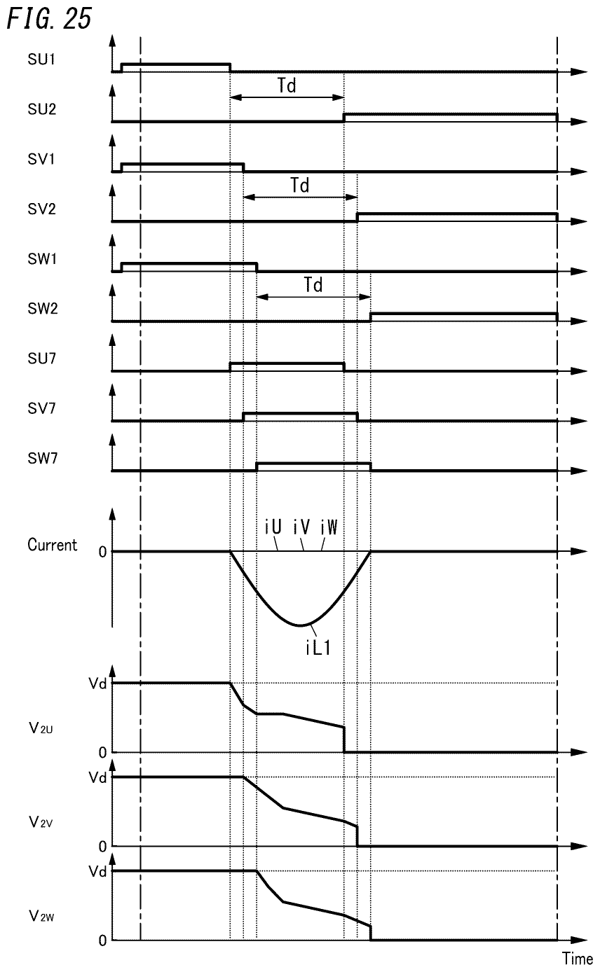

The first control operation includes allowing the respective high-level periods of control signals SU7, SV7, SW7 for the three switches 8 to overlap, for a predetermined period, with the dead time period Td2 (refer to FIG. 24, for example) corresponding to each of three switching circuits 10. FIG. 24 is a timing chart illustrating how the power converter 100 operates if the controller 50 has performed the first control operation. FIG. 25 is a timing chart illustrating how the power converter 100 operates if the controller 50 does not perform the first control operation. FIGS. 24 and 25 each illustrate a timing chart in a situation where there is a period in which the resonant circuit includes the resonant capacitors 9U, 9V, 9W. As used herein, the predetermined period may form at least part of one resonant half cycle Tr3 of a resonant circuit including, for example, the resonant inductor L1 and three resonant capacitors 9. The resonant half cycle Tr3 is given by Tr3=3^{1/2}×π×(L·C)^{1/2}. In the example shown in FIG. 24, the predetermined period is all of the resonant half cycle Tr3. In other words, the length of the predetermined period is 100% of the resonant half cycle Tr3.

When performing the first control operation, the controller 50 makes the dead time period Td2 as long as the resonant half cycle Tr3. Thus, when performing the first control operation, the controller 50 sets the length the dead time period Td2 at 3^{1/2} times the length of the dead time period Td in the case of the basic operation. In addition, the controller 50 also synchronizes not only respective beginnings of the high-level periods of control signals SU7, SV7, SW7 for the three second IGBTs 7U, 7V, 7W with each other but also respective ends of the high-level periods thereof with each other.

Next, it will be described in further detail how the controller 50 operates.

When determining that three-phase resonant currents overlap with each other, the controller 50 performs a first step and a second step in this order.

The first step includes synchronizing U-phase control signals SU1, SU2, V-phase control signals SV1, SV2, and W-phase control signals SW1, SW2 with each other. In the example shown in FIG. 24, the U-phase control signals SU1, SU2, the V-phase control signals SV1, SV2, and the W-phase control signals SW1, SW2 are synchronized with each other by shifting (advancing) the end of the high-level period of the V-phase control signal SV1 and the beginning of the high-level period of the V-phase control signal SV2 and shifting (advancing) the end of the high-level period of the W-phase control signal SW1 and the beginning of the high-level period of the control signal SW2 compared with the example shown in FIG. 25. Alternatively, the first step may include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (advancing) the high-level period of each of the W-phase control signals SW1, SW2. Still alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (postponing) the high-level period of each of the V-phase control signals SV1, SV2. Yet alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2, shifting (postponing) the high-level period of each of the V-phase control signals SV1, SV2, and shifting (advancing) the high-level period of each of the W-phase control signals SW1, SW2.

The second step includes changing the respective high-level periods and dead time periods Td of the control signals SU6, SV6, SW6 according to the resonant half cycle Tr3 (=3^{1/2}×π×(L·C)^{1/2}) of the resonant circuit. More specifically, the controller 50 sets the length of the high-level period of each of the control signals SU6, SV6, SW6 at the resonant half cycle Tr3 of the resonant circuit and sets the dead time period Td at a dead time period Td2 which is equal to the resonant half cycle Tr3 of the resonant circuit. Note that if load current iU=0, load current iV=0, and load current iW=0, then the controller 50 sets each of the additional times Tau, Tav, Taw at zero.

If the controller 50 does not perform the first control operation, then the voltage V_{2U}, V_{2V}, V_{2W} across the second switching element 2U, 2V, 2W has not decreased to zero at a point in time when the control signal SU2, SV2, SW2 makes transition from the low-level period to the high-level period (i.e., at the end of the dead time period Td corresponding to each of the U-, V-, and W-phases) as shown in FIG. 25. That is to say, in the power converter 100, if the controller 50 does not perform the first control operation, then the resonant capacitor 9U, 9V, 9W has not been discharged fully yet at the end of the dead time period Td corresponding to each of the U-, V-, and W-phases. Thus, in the power converter 100, if the controller 50 does not perform the first control operation, then the second switching element 2U, 2V, 2W is switched by hard switching.

On the other hand, in the power converter 100, if the controller 50 has performed the first control operation, then the voltage V_{2U}, V_{2V}, V_{2W} across the second switching element 2U, 2V, 2W decreases to zero at a point in time when the control signal SU2, SV2, SW2 makes transition from the low-level period to the high-level period (i.e., at the end of the dead time period Td2 corresponding to each of the U-, V-, and V-phases) as shown in FIG. 24. That is to say, in the power converter 100, if the controller 50 has performed the first control operation, then the discharging of the resonant capacitor 9U, 9V, 9W is finished at the end of the dead time period Td2. Thus, in the power converter 100, if the controller 50 has performed the first control operation, the second switching element 2U, 2V, 2W is switched by soft switching.

### (4) Recapitulation

In the power converter 100 according to the first embodiment, the controller 50 may perform a first control operation and a second control operation when determining that resonant currents, each passing through a corresponding one of two or more switches 8 belonging to the plurality of switches 8, flow simultaneously through the resonant inductor L1. The first control operation includes allowing a high-level period of a control signal for each of the two or more switches 8 to overlap, for a predetermined period, with a dead time period (Td1, Td2) associated with each of two or more switching circuits 10 connected to the two or more switches 8 which belong to the plurality of switching circuits 10. The second control operation includes determining a beginning of a high-level period of a control signal for at least one of the plurality of switches 8 by a load current of at least one phase flowing through an AC load RA1 connected to the plurality of AC terminals 41. This allows the power converter 100 to make soft switching with more reliability.

In addition, in the power converter 100 according to the first embodiment, the predetermined period is all of the resonant half cycle. This allows the power converter 100 according to the first embodiment to make zero-voltage soft switching with more reliability.

Furthermore, in the power converter 100 according to the first embodiment, the controller 50 performs the second control operation by shifting a beginning of a high-level period of a control signal for at least one of the plurality of switches 8 according to a total amount of load currents of two or more phases flowing respectively through two or more AC terminals 41 connected to the two or more switches 8 which belong to the plurality of AC terminals 41. This allows the power converter 100 to start producing resonance at the beginning of the dead time period Td1, Td2.

Furthermore, in the power converter 100 according to the first embodiment, the controller 50 may perform a third control operation including making the dead time period Td1, Td2 associated with each of the two or more switching circuits 10 connected to the two or more switches 8 which belong to the plurality of switching circuits 10 longer than a predefined dead time period Td by an additional time Tad. This allows the power converter 100 to make zero-voltage soft switching even if the resonant half cycle Tr2, Tr3 is longer than the dead time period Td.

### First Variation

A power converter 100 according to a first variation of the first embodiment has the same circuit configuration as the power converter 100 (refer to FIG. 1) according to the first embodiment, and therefore, illustration and description thereof will be omitted herein.

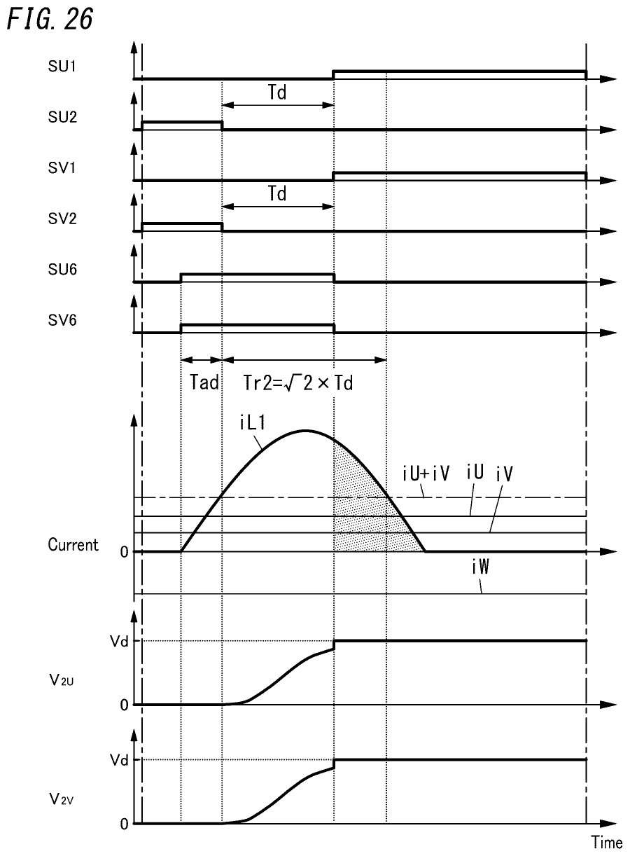

In the power converter 100 according to the first variation, when determining that two-phase resonant currents overlap with each other, the controller 50 operates partially differently from the controller 50 according to the first embodiment. In the following description, it will be described with reference to FIG. 26 and other drawings how the controller 50 operates to make soft switching of the first switching element 1.

The controller 50 performs the first control operation by allowing the respective high-level periods of control signals for two or more switches 8 to overlap, for a predetermined period, with the dead time period Td (refer to FIG. 26, for example) corresponding to each of two switching circuits 10 respectively connected to the two switches 8 which belong to the plurality of switching circuits 10. FIG. 26 is a timing chart illustrating how the power converter 100 operates if the controller 50 has performed the first and second control operations. As used herein, the predetermined period may form part of one resonant half cycle Tr2 of a resonant circuit including, for example, the resonant inductor L1 and two resonant capacitors 9 respectively connected to the two switches 8. In the example shown in FIG. 26, the predetermined period accounts for 60% of the resonant half cycle Tr2. In other words, the length of the predetermined period is 60% of the length of the resonant half cycle.

In addition, the controller 50 synchronizes not only the beginnings of respective high-level periods of two control signals for the first IGBTs 6 of the two switches 8, through which resonant currents flow, with each other but also the ends of the respective high-level periods thereof with each other. In the example shown in FIG. 26, the controller 50 synchronizes not only the beginnings of respective high-level periods of the control signals SU6, SV6 for the first IGBTs 6U, 6V with each other but also the ends of the respective high-level periods thereof with each other.

Next, it will be described in further detail how the controller 50 operates.

When determining that two-phase resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U- and W phases and the combination of V-and W-phases as well.

The first step includes synchronizing U-phase control signals SU1, SU2 with V-phase control signals SV1, SV2. In the example shown in FIG. 26, the U-phase control signals SU1, SU2 are synchronized with the V-phase control signals SV1, SV2 by shifting (advancing), by ΔT1, the high-level period of each of the V-phase control signals SV1, SV2 compared with the example shown in FIG. 10. The first step corresponds to the first control operation to be performed by the controller 50. Alternatively, the first step may include synchronizing the U-phase control signals SU1, SU2 with the V-phase control signals SV1, SV2 by shifting (postponing), by ΔT1, the respective high-level periods of the U-phase control signals SU1, SU2. Still alternatively, the first step may include synchronizing the U-phase control signals SU1, SU2 with the V-phase control signals SV1, SV2 by shifting, by ΔT1 in total, the U-phase control signals SU1, SU2 and the V-phase control signals SV1, SV2.

The second step includes adding the additional time Tad corresponding to the total current value of the two-phase load currents iU, iV to the respective high-level periods of control signals SU6, SV6 for two-phase switches 8 corresponding to the two-phase dead time periods Td, respectively. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/V15. The second step corresponds to the second control operation to be performed by the controller 50.

The third step includes changing the lengths of the respective high-level periods of the control signals SU6, SV6 according to the resonant half cycle Tr2 (=2^{1/2}×π×(L·C)^{1/2}) of the resonant circuit. More specifically, the controller 50 subtracts the additional time Tad from the high-level period of each of the control signals SU6, SV6 and sets the length of the remainder period at 60% of the resonant half cycle Tr2 of the resonant circuit. Note that the end of the control signal SU6, SV6 may be simultaneous with, or later than, the end of the resonant half cycle Tr2.

In the power converter 100 according to the first embodiment, if the controller 50 does not perform any of the first and second control operations, then the voltage V_{2U}, V_{2V} across the second switching element 2U, 2V has not risen to Vd at a point in time when the control signal SU1, SV1 makes transition from the low-level period to the high-level period (i.e., at the end of the dead time period Td) as shown in FIG. 10. That is to say, if the controller 50 does not perform any of the first and second control operations, then the resonant capacitor 9U, 9V has not been charged fully yet at the end of the dead time period Td. Thus, if the controller 50 does not perform any of the first and second control operations, the voltage across each of the first switching elements 1U, 1V does not decrease to zero at the end of the dead time period Td, and therefore, the first switching element 1U, 1V is switched by hard switching.

On the other hand, in the power converter 100 according to the first variation, if the controller 50 has performed the first and second control operations, then the voltage V_{2U}, V_{2V} across the second switching element 2U, 2V rises to a voltage closer to Vd at a point in time when the control signal SU1, SV1 makes transition from the low-level period to the high-level period (i.e., at the end of the dead time period Td) as shown in FIG. 26. That is to say, in the power converter 100 according to the first variation, if the controller 50 has performed the first and second control operations, then the first switching element 1U, 1V is switched by somewhat imperfect soft switching but the loss and noise may still be reduced compared to perfect hard switching.

### Second Variation

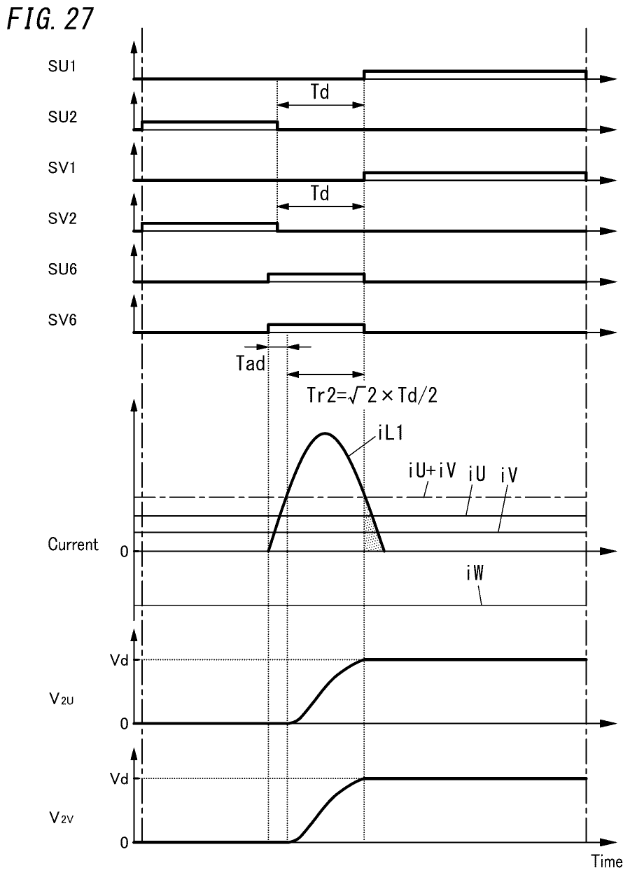

A power converter 100 according to a second variation of the first embodiment has the same circuit configuration as the power converter 100 (refer to FIG. 1) according to the first embodiment, and therefore, illustration and description thereof will be omitted herein. In the following description, it will be described with reference to FIG. 27 and other drawings how the controller 50 operates.

In the power converter 100 according to the second variation, the resonant half cycle in the case of the basic operation is half as long as the dead time period Td in the case of the basic operation, and the controller 50 operates partially differently from the controller 50 according to the first embodiment when determining that two-phase resonant currents should overlap with each other.

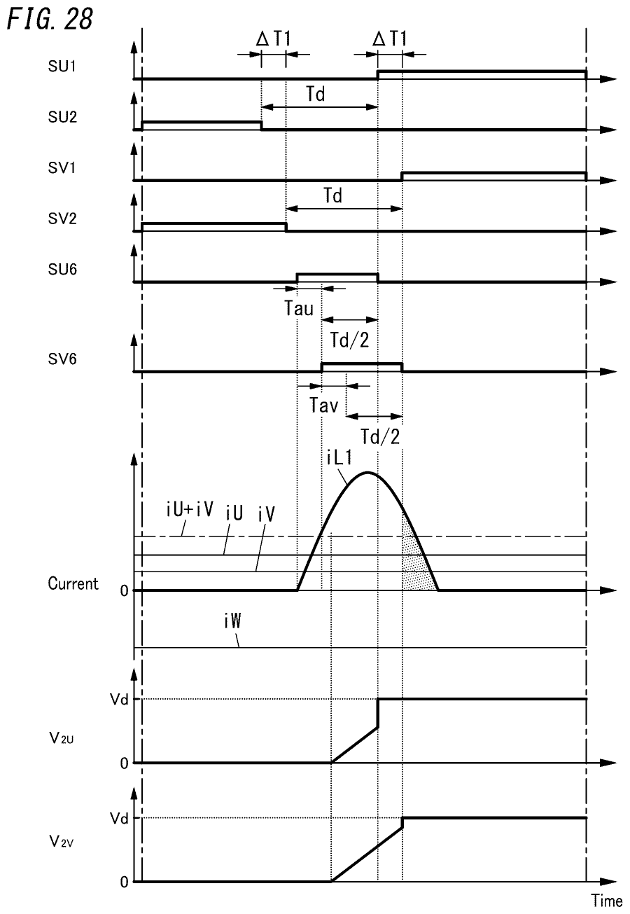

The controller 50 performs the first control operation by allowing the respective high-level periods of control signals for two or more switches 8 to overlap, for a predetermined period, with the dead time period Td corresponding to each of two switching circuits 10 respectively connected to the two switches 8 which belong to the plurality of switching circuits 10. FIG. 27 is a timing chart illustrating how the power converter 100 operates if the controller 50 has performed the first and second control operations. FIG. 28 is a timing chart illustrating how the power converter 100 operates if the controller 50 does not perform any of the first and second control operations. In this second variation, the resonant half cycle in the case of the basic operation is Td/2. As used herein, the predetermined period is all of one resonant half cycle Tr2 of a resonant circuit including, for example, the resonant inductor L1 and two resonant capacitors 9 respectively connected to the two switches 8. The resonant half cycle Tr2 has been set to satisfy the equation: Tr2=2^{1/2}×Td/2. In the example shown in FIG. 27, the length of the resonant half cycle Tr2 is shorter than the length of the dead time period Td, and the high-level period but the additional time Tad of each of the control signals SU6, SV6 overlaps entirely with the resonant half cycle Tr2. According to the second variation, if the resonant half cycle Tr2 is equal to or shorter than the dead time period Td in the case of the basic operation, there is no need to make the dead time period Td in the first control operation longer than the dead time period Td in the case of the basic operation.

Next, it will be described in further detail how the controller 50 operates.

When determining that resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U-and W phases and the combination of V-and W-phases as well.

The first step includes synchronizing U-phase control signals SU1, SU2 with V-phase control signals SV1, SV2. In the example shown in FIG. 27, the U-phase control signals SU1, SU2 are synchronized with the V-phase control signals SV1, SV2 by shifting (advancing), by ΔT1, the beginning of the high-level period of the V-phase control signal SV1 and the end of the high-level period of the control signal SV2 compared with the example shown in FIG. 28. The first step corresponds to the first control operation to be performed by the controller 50. Alternatively, the first step may include synchronizing the U-phase control signals SU1, SU2 with the V-phase control signals SV1, SV2 by shifting (postponing), by ΔT1, the high-level periods of the U-phase control signals SU1, SU2. Still alternatively, the first step may include synchronizing the U-phase control signals SU1, SU2 with the V-phase control signals SV1, SV2 by shifting, by ΔT1 in total, the U-phase control signals SU1, SU2 and the V-phase control signals SV1, SV2.

The second step includes adding the additional time Tad corresponding to the total current value of the two-phase load currents iU, iV to the respective high-level periods of control signals SU7, SV7 for two-phase switches 8 corresponding to the two-phase dead time periods Td, respectively. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/ V15. The second step corresponds to the second control operation to be performed by the controller 50.

The third step includes changing the lengths of the respective high-level periods of the control signals SU7, SV7 according to the resonant half cycle Tr2 (=2^{1/2}×Td/2 ) of the resonant circuit. More specifically, the controller 50 subtracts the additional time Tad from the high-level period of each of the control signals SU7, SV7 and sets the length of the remainder period as the resonant half cycle Tr2 of the resonant circuit. Note that the end of the control signal SU7, SV7 may be simultaneous with, or later than, the end of the resonant half cycle Tr2.

If the controller 50 does not perform any of the first and second control operations, then the voltage V_{2U}, V_{2V} across the second switching element 2U, 2V has not risen to Vd at a point in time when the control signal SU1, SV1 makes transition from the low-level period to the high-level period (i.e., at the end of the dead time period Td) as shown in FIG. 28. That is to say, if the controller 50 does not perform any of the first and second control operations, then the resonant capacitor 9U, 9V has not been charged fully yet at the end of the dead time period Td. Thus, in the power converter 100 according to the second variation, if the controller 50 does not perform any of the first and second control operations, the first switching element 1U, 1V is switched by hard switching.

On the other hand, in the power converter 100 according to the second variation, if the controller 50 has performed the first and second control operations, then the voltage V_{1U}, V_{1V} across the first switching element 1U, 1V decreases to zero at a point in time when the control signal SU1, SV1 makes transition from the low-level period to the high-level period (i.e., at the end of the dead time period Td) as shown in FIG. 27. That is to say, in the power converter 100 according to the second variation, if the controller 50 has performed the first and second control operations, then the resonant capacitor 9U, 9V is charged fully at the end of the dead time period Td. Thus, in the power converter 100 according to the second variation, if the controller 50 has performed the first and second control operations, the first switching element 1U, 1V is switched by zero-voltage soft switching.

### Third Variation

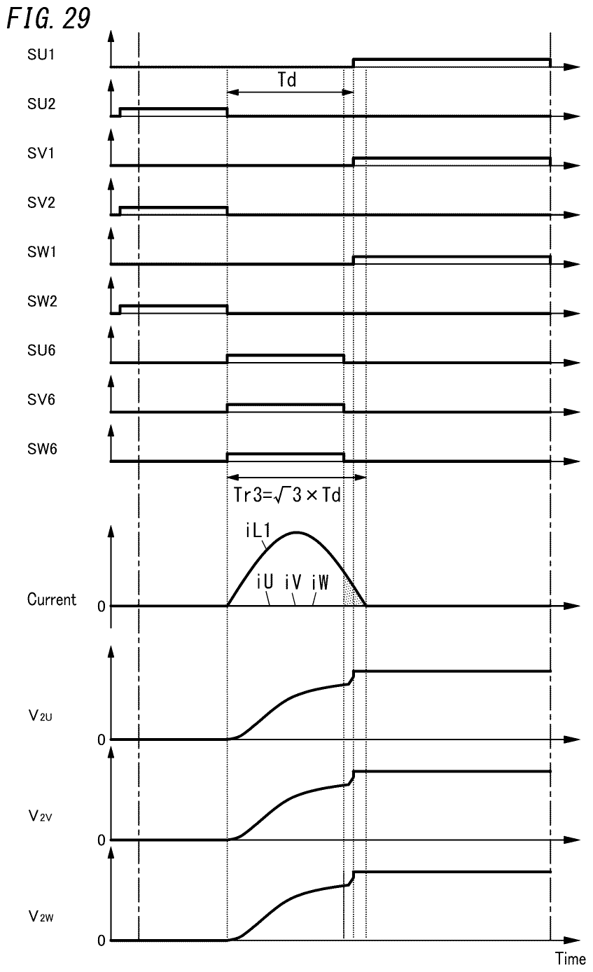

A power converter 100 according to a third variation of the first embodiment has the same circuit configuration as the power converter 100 (refer to FIG. 1) according to the first embodiment, and therefore, illustration and description thereof will be omitted herein. In the following description, it will be described with reference to FIG. 29 and other drawings how the controller 50 operates to make soft switching of the first switching element 1.

In the power converter 100 according to the third variation, the resonant half cycle in the case of the basic operation is half as long as the dead time period Td in the case of the basic operation, and the controller 50 operates partially differently from the controller 50 according to the first embodiment when determining that three-phase resonant currents should overlap with each other.

The controller 50 performs the first control operation by allowing the respective high-level periods of control signals for three switches 8 to overlap, for a predetermined period, with the dead time period Td corresponding to each of three switching circuits 10 connected to the three switches 8. FIG. 29 is a timing chart illustrating how the power converter 100 operates if the controller 50 has performed the first and second control operations. As used herein, the predetermined period may form part of one resonant half cycle Tr3 of a resonant circuit including, for example, the resonant inductor L1 and three resonant capacitors 9. In the example shown in FIG. 29, the predetermined period accounts for 60% of the resonant half cycle Tr2. In other words, the length of the predetermined period is 60% of the length of the resonant half cycle Tr2.

In addition, the controller 50 synchronizes not only the beginnings of respective high-level periods of three control signals SU6, SV6, SW6 for the first IGBTs 6 of the three switches 8, through which resonant currents flow, with each other but also the ends of the respective high-level periods thereof with each other.

Next, it will be described in further detail how the controller 50 operates.

When determining that three-phase resonant currents overlap with each other, the controller 50 performs a first step and a second step in this order.

The first step includes synchronizing U-phase control signals SU1, SU2, V-phase control signals SV1, SV2, and W-phase control signals SW1, SW2 with each other. In the example shown in FIG. 29, the U-phase control signals SU1, SU2, the V-phase control signals SV1, SV2, and the W-phase control signals SW1, SW2 are synchronized with each other by shifting (advancing) the high-level period of each of the V-phase control signals SV1, SV2 and shifting (advancing) the high-level period of each of the W-phase control signals SW1, SW2 compared with the example shown in FIG. 29. Alternatively, the first step may include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (advancing) the high-level period of each of the W-phase control signals SW1, SW2. Still alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (postponing) the high-level period of each of the V-phase control signals SV1, SV2. Yet alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2, shifting (postponing) the high-level period of each of the V-phase control signals SV1, SV2, and shifting (advancing) the high-level period of each of the W-phase control signals SW1, SW2.

The second step includes changing the respective high-level periods and dead time periods Td of the control signals SU6, SV6, SW6 according to the resonant half cycle Tr3 (=3^{1/2}×π×(L·C)^{1/2}) of the resonant circuit. More specifically, the controller 50 sets, with respect to each of the respective high-level periods of the control signals SU6, SV6, SW6, the predetermined period of the high-level period of each of the control signals SU6, SV6, SW6 to overlap with the dead time period Td at 60% of the resonant half cycle Tr3 of the resonant circuit. Note that if load current iU=0, load current iV=0, and load current iW=0, then the controller 50 sets each of the additional times Tau, Tav, Taw at zero.

If the controller 50 does not perform any of the first and second control operations, then the voltage V_{2U}, V_{2V}, V_{2W} across the second switching element 2U, 2V, 2W has not risen to Td at a point in time when the control signal SU1, SV1, SW1 makes transition from the low-level period to the high-level period (i.e., at the end of the dead time period Td corresponding to each of the U-, V-, and W-phases) as shown in FIG. 19. That is to say, in the power converter 100, if the controller 50 does not perform any of the first and second control operations, then the resonant capacitor 9U, 9V, 9W has not been charged fully yet at the end of the dead time period Td corresponding to each of the U-, V-, and W-phases. Thus, in the power converter 100, if the controller 50 does not perform any of the first and second control operations, then the first switching element 1U, 1V, 1W is switched by hard switching.

On the other hand, in the power converter 100, if the controller 50 has performed the first and second control operations, then the voltage V_{1U}, V_{1V}, V_{1W} across the first switching element 1U, 1V, 1W rises to a voltage closer to Vd at a point in time when the control signal SU1, SV1, SW1 makes transition from the low-level period to the high-level period (i.e., at the end of the dead time period Td of each of the U-, V-, and W-phases) as shown in FIG. 29. That is to say, in the power converter 100 according to the third variation, if the controller 50 has performed the first and second control operations, then the first switching element 1U, 1V is switched by somewhat imperfect soft switching but the loss and noise may still be reduced compared to perfect hard switching.

### Fourth Variation

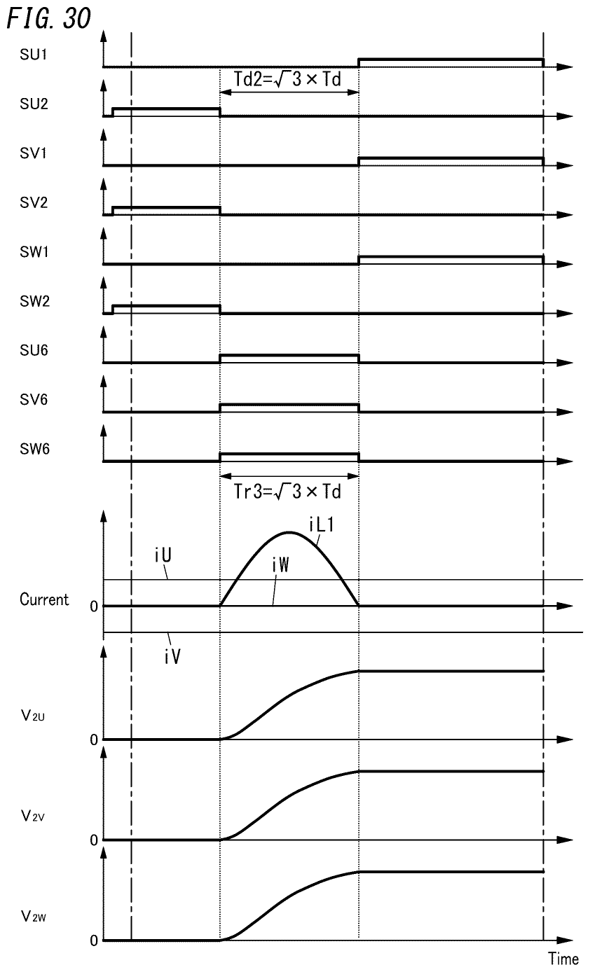

A power converter 100 according to a fourth variation of the first embodiment has the same circuit configuration as the power converter 100 (refer to FIG. 1) according to the first embodiment, and therefore, illustration and description thereof will be omitted herein. In the following description, it will be described with reference to FIG. 30 and other drawings how the controller 50 operates to make soft switching of the first switching element 1.

In the power converter 100 according to the fourth variation, the resonant half cycle in the case of the basic operation is half as long as the dead time period Td in the case of the basic operation, and the controller 50 operates partially differently from the controller 50 according to the first embodiment when determining that three-phase resonant currents should overlap with each other.

The controller 50 performs the first control operation by allowing the respective high-level periods of control signals for three switches 8 to overlap, for a predetermined period, with the dead time period Td corresponding to each of three switching circuits 10 connected to the three switches 8. FIG. 30 is a timing chart illustrating how the power converter 100 operates in a situation where its controller 50 has performed the first, second, and third control operations. The predetermined period may be, for example, all of the resonant half cycle Tr3 of the resonant circuit including the resonant inductor L1 and three resonant capacitors 9. In the example shown in FIG. 30, the length of the predetermined period is 100% of the resonant half cycle Tr3.

In addition, the controller 50 synchronizes not only the beginnings of respective high-level periods of three control signals SU6, SV6, SW6 for the first IGBTs 6 of the three switches 8, through which resonant currents flow, with each other but also the ends of the respective high-level periods thereof with each other.

Next, it will be described in further detail how the controller 50 operates.

When determining that three-phase resonant currents overlap with each other, the controller 50 performs a first step, a second step, and a third step in this order.

The first step includes synchronizing U-phase control signals SU1, SU2, V-phase control signals SV1, SV2, and W-phase control signals SW1, SW2 with each other. In the example shown in FIG. 30, in a situation where iU≠0, iV≠0, iW=0, and iU>0>iV, the U-phase control signals SU1, SU2, the V-phase control signals SV1, SV2, and the W-phase control signals SW1, SW2 are synchronized with each other by shifting (advancing) the high-level period of each of the V-phase control signals SV1, SV2 and shifting (advancing) the high-level period of each of the W-phase control signals SW1, SW2 compared with the example shown in FIG. 19. Alternatively, the first step may include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (advancing) the high-level period of each of the W-phase control signals SW1, SW2. Still alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (postponing) the high-level period of each of the V-phase control signals SV1, SV2. Yet alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2, shifting (postponing) the high-level period of each of the V-phase control signals SV1, SV2, and shifting (advancing) the high-level period of each of the W-phase control signals SW1, SW2.

The second step includes changing the additional time Tad of the high-level period of each of the control signals SU6, SV6, SW6 into a value calculated by the equation: Tad=|iU+iV+iW|/V15 using the value of the total load current (e.g., zero in the example shown in FIG. 30).

The third step includes changing the respective high-level periods and dead time periods Td of the control signals SU6, SV6, SW6 according to the resonant half cycle Tr3 (=3^{1/2}×π×(L·C)^{1/2}) of the resonant circuit. More specifically, the controller 50 sets the length of the high-level period of each of the control signals SU6, SV6, SW6 at the resonant half cycle Tr3 of the resonant circuit and sets the dead time period Td at the dead time period Td2 equal to the resonant half cycle Tr3 of the resonant circuit.

If the controller 50 does not perform any of the first, second, and third control operations, then the voltage V_{1U}, V_{1V}, V_{1W} across the second switching element 2U, 2V, 2W has not risen to Td at a point in time when the control signal SU1, SV1, SW1 makes transition from the low-level period to the high-level period (i.e., at the end of the dead time period Td corresponding to each of the U-, V-, and W-phases). That is to say, in the power converter 100, if the controller 50 does not perform any of the first, second, and third control operations, then the resonant capacitor 9U, 9V, 9W has not been charged fully yet at the end of the dead time period Td corresponding to each of the U-, V-, and W-phases. Thus, in the power converter 100, if the controller 50 does not perform any of the first, second, and third control operations, then the first switching element 1U, 1V, 1W is switched by hard switching.

On the other hand, in the power converter 100 according to the fourth variation, if the controller 50 has performed the first, second, and third control operations, then the voltage V_{2U}, V_{2V}, V_{2W} across the second switching element 2U, 2V, 2W rises to Vd at a point in time when the control signal SU1, SV1, SW1 makes transition from the low-level period to the high-level period (i.e., at the end of the dead time period Td of each of the U-, V-, and W-phases) as shown in FIG. 30. That is to say, in the power converter 100 according to the fourth variation, if the controller 50 has performed the first, second, and third control operations, then the first switching element 1U, 1V may be switched by zero-voltage soft switching.

### Fifth Variation

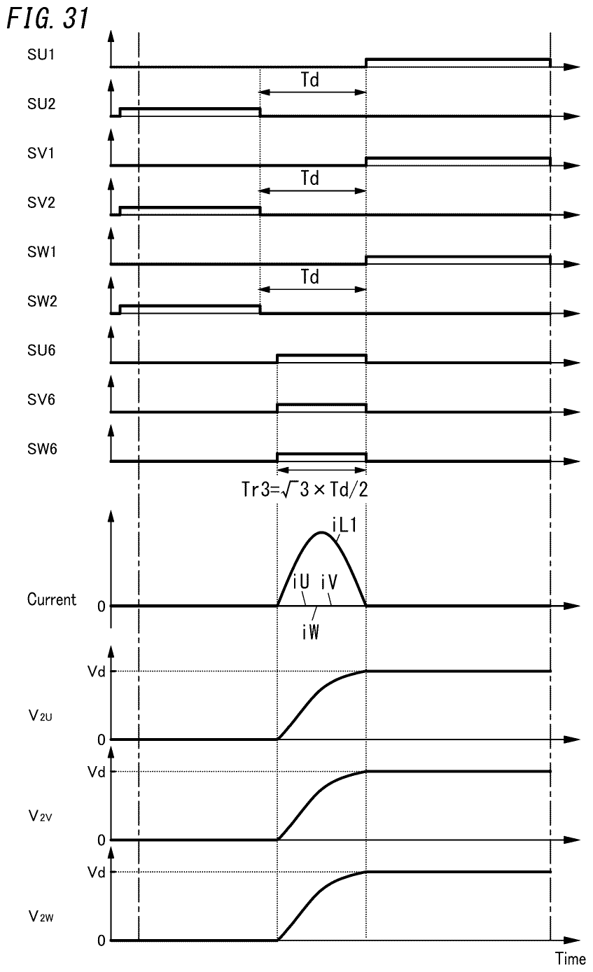

A power converter 100 according to a fifth variation of the first embodiment has the same circuit configuration as the power converter 100 (refer to FIG. 1) according to the first embodiment, and therefore, illustration and description thereof will be omitted herein. In the following description, it will be described with reference to FIG. 31 and other drawings how the controller 50 operates to make soft switching of the first switching element 1.

In the power converter 100 according to the fifth variation, the resonant half cycle in the case of the basic operation is half as long as the dead time period Td in the case of the basic operation, and the controller 50 operates partially differently from the controller 50 according to the first embodiment when determining that three-phase resonant currents should overlap with each other.

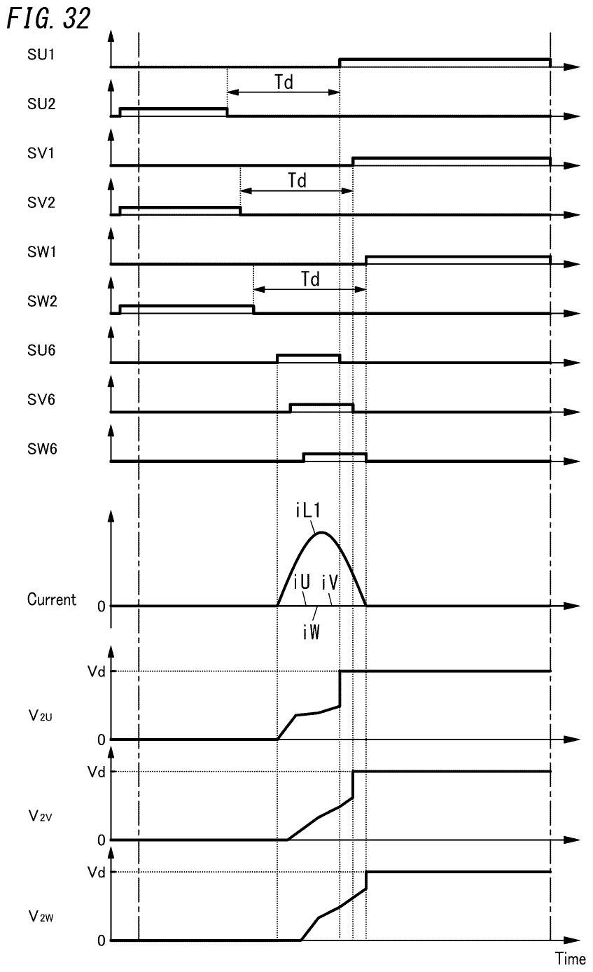

The controller 50 performs the first control operation by allowing the respective high-level periods of control signals for three switches 8 to overlap, for a predetermined period, with the dead time period Td corresponding to each of three switching circuits 10 connected to the three switches 8, respectively. FIG. 31 is a timing chart illustrating how the power converter 100 operates in a situation where its controller 50 has performed the first and second control operations. FIG. 32 is a timing chart illustrating how the power converter 100 operates in a situation where its controller 50 does not perform any of the first and second control operations. The predetermined period is all of the resonant half cycle Tr3 of a resonant circuit including the resonant inductor L1 and the three resonant capacitors 9, for example.

In addition, the controller 50 synchronizes not only the beginnings of respective high-level periods of three control signals SU6, SV6, SW6 for the first IGBTs 6 of the three switches 8, through which resonant currents flow, with each other but also the ends of the respective high-level periods thereof with each other.

Next, it will be described in further detail how the controller 50 operates.

When determining that three-phase resonant currents overlap with each other, the controller 50 performs a first step and a second step in this order.

The first step includes synchronizing U-phase control signals SU1, SU2, V-phase control signals SV1, SV2, and W-phase control signals SW1, SW2 with each other. In the example shown in FIG. 31, the U-phase control signals SU1, SU2, the V-phase control signals SV1, SV2, and the W-phase control signals SW1, SW2 are synchronized with each other by shifting (advancing) the high-level period of each of the V-phase control signals SV1, SV2 and shifting (advancing) the high-level period of each of the W-phase control signals SW1, SW2 compared with the example shown in FIG. 32. Alternatively, the first step may include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (advancing) the high-level period of each of the W-phase control signals SW1, SW2. Still alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2 and shifting (postponing) the high-level period of each of the V-phase control signals SV1, SV2. Yet alternatively, the first step may also include synchronizing the U-phase control signals SU1, SU2, the V-phase control signals SV1, SV2, and the W-phase control signals SW1, SW2 with each other by shifting (postponing) the high-level period of each of the U-phase control signals SU1, SU2, shifting (postponing) the high-level period of each of the V-phase control signals SV1, SV2, and shifting (advancing) the high-level period of each of the W-phase control signals SW1, SW2.

The second step includes setting the length of the high-level period of each of the control signals SU6, SV6, SW6 at the resonant half cycle Tr3 (=3^{1/2}×Td/2) of the resonant circuit.

In the power converter 100 according to the fifth variation, if the controller 50 does not perform any of the first and second control operations, then the voltage V_{2U}, V_{2V}, V_{2W} across the second switching element 2U, 2V, 2W has not risen to Td at a point in time when the control signal SU1, SV1, SW1 makes transition from the low-level period to the high-level period (i.e., at the end of the dead time period Td corresponding to each of the U-, V-, and W-phases) as shown in FIG. 32. That is to say, in the power converter 100, if the controller 50 does not perform any of the first and second control operations, then the resonant capacitor 9U, 9V, 9W has not been charged fully yet at the end of the dead time period Td corresponding to each of the U-, V-, and W-phases. Thus, in the power converter 100, if the controller 50 does not perform any of the first and second control operations, then the first switching element 1U, 1V, 1W is switched by hard switching.

On the other hand, in the power converter 100 according to the fifth variation, if the controller 50 has performed the first and second control operations, then the voltage V_{2U}, V_{2V}, V_{2W} across the second switching element 2U, 2V, 2W rises to Vd at a point in time when the control signal SU1, SV1, SW1 makes transition from the low-level period to the high-level period (i.e., at the end of the dead time period Td of each of the U-, V-, and W-phases) as shown in FIG. 31. Thus, in the power converter 100 according to the fifth variation, if the controller 50 has performed the first and second control operations, then the first switching element 1U, 1V may be switched by zero-voltage soft switching.

### Sixth Variation

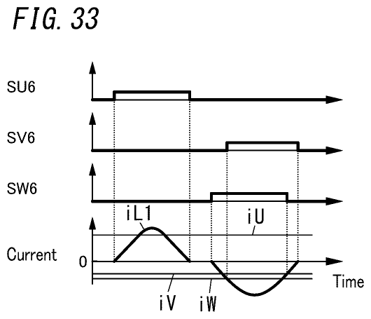

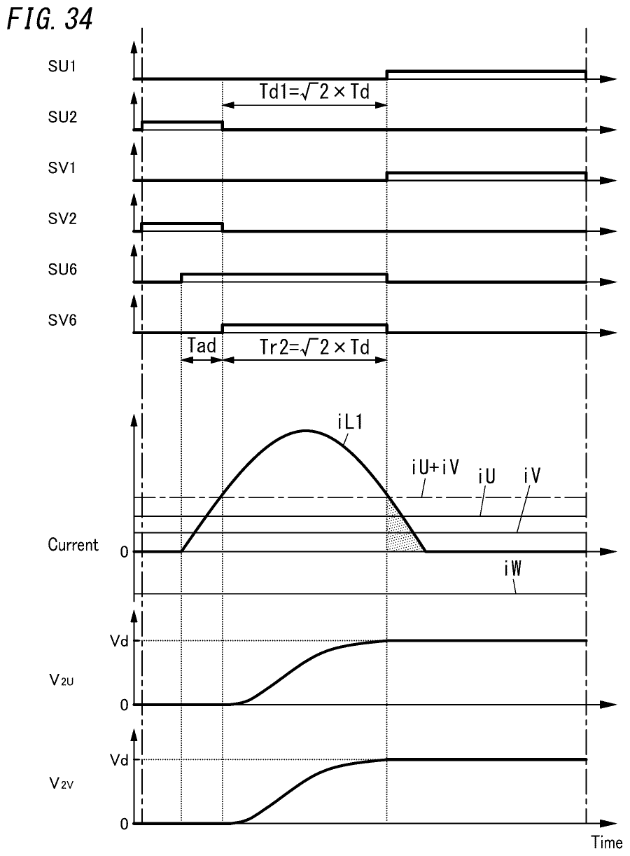

A power converter 100 according to a sixth variation of the first embodiment has the same circuit configuration as the power converter 100 (refer to FIG. 1) according to the first embodiment, and therefore, illustration and description thereof will be omitted herein. In the following description, it will be described with reference to FIGS. 33 and 34 and other drawings how the controller 50 operates.

In the power converter 100, when the controller 50 determines that two-phase resonant currents overlap with each other, the high-level periods of control signals for the two-phase switches 8 do not have to be made to overlap with each other completely. Instead, as shown in FIG. 33, for example, a control signal SV6, SW6 which causes one of the two-phase switches 8 to turn ON may be output until the current iL1 flowing through the resonant inductor L1 reaches iV+iW that is the total value of the two-phase load currents. FIG. 33 illustrates an exemplary situation where the V-phase resonant current and the W-phase resonant current overlap with each other. However, this is only an example and should not be construed as limiting. The same statement applies to a situation where the U-phase resonant current and the V-phase resonant current overlap with each other and a situation where the U-phase resonant current and the W-phase resonant current overlap with each other as well.

In the power converter 100 according to the sixth variation, the controller 50 operates partially differently from the controller 50 according to the first embodiment when determining that two-phase resonant currents should overlap with each other.

The controller 50 performs the first control operation by allowing the respective high-level periods of control signals for two switches 8 to overlap, for a predetermined period, with the dead time period Td corresponding to each of two switching circuits 10 connected to the two switches 8, respectively. FIG. 34 is a timing chart illustrating how the power converter 100 operates if the controller 50 has performed the first, second, and third control operations. In this sixth variation, the resonant half cycle in the case of the basic operation is equal in length to the dead time period Td, and the predetermined period is all of the resonant half cycle Tr2 of a resonant circuit including, for example, the resonant inductor L1 and two resonant capacitors 9 respectively connected to the two switches 8. The resonant half cycle Tr2 is given by the equation: Tr2=2^{1/2}×Td/2. In the example shown in FIG. 34, the dead time period Td is as long as the resonant half cycle Tr2 and the high-level period of each of the control signals SU6, SV6 fully overlaps with the entire resonant half cycle Tr2.

Next, it will be described in further detail how the controller 50 operates.

When determining that resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U- and W phases and the combination of V- and W-phases as well.

The first step includes synchronizing U-phase control signals SU1, SU2 with V-phase control signals SV1, SV2. In the example shown in FIG. 34, the U-phase control signals SU1, SU2 are synchronized with the V-phase control signals SV1, SV2 by shifting (advancing), by ΔT1, the high-level period of each of the V-phase control signals SV1, SV2. Alternatively, the first step may include synchronizing the U-phase control signals SU1, SU2 with the V-phase control signals SV1, SV2 by shifting (postponing), by ΔT1, the high-level periods of the U-phase control signals SU1, SU2. Still alternatively, the first step may include synchronizing the U-phase control signals SU1, SU2 with the V-phase control signals SV1, SV2 by shifting, by ΔT1 in total, the U-phase control signals SU1, SU2 and the V-phase control signals SV1, SV2.

The second step includes adding an additional time Tad corresponding to the total current value of the two-phase load currents iU, iV to the high-level period of the control signal SU6 for the U-phase switch 8. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/V15.

The third step includes changing the lengths of the respective high-level periods and dead time periods Td of the control signals SU6, SV6 according to the resonant half cycle Tr2 (=2^{1/2}×Td) of the resonant circuit. More specifically, the controller 50 subtracts the additional time Tad from the high-level period of the control signal SU6, sets the length of the remainder period as the resonant half cycle Tr2, sets the length of the high-level period of the control signal SV6 as the resonant half cycle Tr2, and determines the dead time period Td1 by the equation Td1=2^{1/2}×Td. Note that the end of the control signal SU6, SV6 may be simultaneous with, or later than, the end of the resonant half cycle Tr2.

If the controller 50 does not perform any of the first, second, and third control operations, then the voltage V_{2U}, V_{2V} across the second switching element 2U, 2V has not risen to Vd at a point in time when the control signal SU1, SV1 makes transition from the low-level period to the high-level period (i.e., at the end of the dead time period Td) as shown in FIG. 10. That is to say, if the controller 50 does not perform any of the first, second, and third control operations, then the resonant capacitor 9U, 9V has not been charged fully yet at the end of the dead time period Td. Thus, in the power converter 100 according to the sixth variation, if the controller 50 does not perform any of the first, second, and third control operations, the first switching element 1U, 1V is switched by hard switching.

On the other hand, in the power converter 100 according to the sixth variation, if the controller 50 has performed the first, second, and third control operations, then the voltage VIU, Viv across the first switching element 1U, 1V goes zero at a point in time when the control signal SU1, SV1 makes transition from the low-level period to the high-level period (i.e., at the end of the dead time period Td) as shown in FIG. 34. That is to say, in the power converter 100 according to the sixth variation, if the controller 50 has performed the first, second, and third control operations, then the resonant capacitor 9U, 9V is charged fully at the end of the dead time period Td. Consequently, in the power converter 100 according to the sixth variation, if the controller 50 has performed the first, second, and third control operations, then the first switching element 1U, 1V is switched by zero-voltage soft switching.

### Seventh Variation

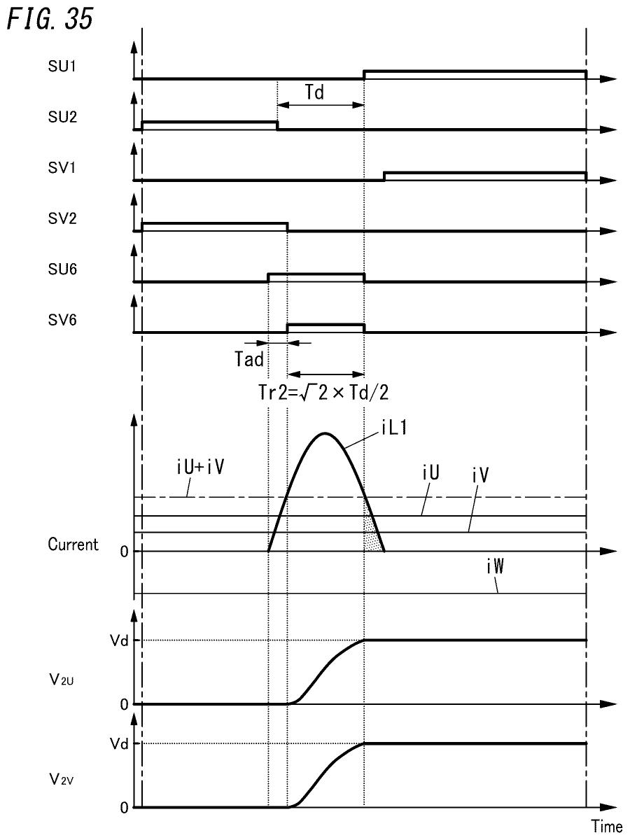

A power converter 100 according to a seventh variation of the first embodiment has the same circuit configuration as the power converter 100 (refer to FIG. 1) according to the first embodiment, and therefore, illustration and description thereof will be omitted herein. In the following description, it will be described with reference to FIG. 35 and other drawings how the controller 50 operates.

In the power converter 100 according to the seventh variation, the resonant half cycle in the case of the basic operation is half as long as the dead time period Td in the case of the basic operation, and the controller 50 operates partially differently from the controller 50 according to the first embodiment when determining that two-phase resonant currents should overlap with each other.

The controller 50 performs the first control operation by allowing the respective high-level periods of control signals for two switches 8 to overlap, for a predetermined period, with the dead time period Td corresponding to each of two switching circuits 10 connected to the two switches 8, respectively. FIG. 35 is a timing chart illustrating how the power converter 100 operates if the controller 50 has performed the first, second, and third control operations. In this seventh variation, the resonant half cycle in the case of the basic operation is as long as one half of the dead time period Td, and the predetermined period is all of the resonant half cycle Tr2 of a resonant circuit including, for example, the resonant inductor L1 and two resonant capacitors 9 respectively connected to the two switches 8. The resonant half cycle Tr2 is given by the equation: Tr2=2^{1/2}×Td/2. In the example shown in FIG. 35, the resonant half cycle Tr2 is shorter in length than the dead time period Td, the entire high-level period of the control signal SU6 but the additional time Tad fully overlaps with all of the resonant half cycle Tr2, and the entire high-level period of the control signal SV6 fully overlaps with all of the resonant half cycle Tr2. According to the seventh variation, if the resonant half cycle Tr2 is equal to or shorter than the dead time period Td in the case of the basic operation, there is no need to make the dead time period Td in the first control operation longer than the dead time period Td in the case of the basic operation.

Next, it will be described in further detail how the controller 50 operates.

When determining that resonant currents overlap with each other, the controller 50 performs a first step, a second step, and a third step in this order. In the following description, a situation where a resonant current flowing through the U-phase switch 8U and a resonant current flowing through the V-phase switch 8V would overlap with each other in the resonant inductor L1 will be described as an example. The same statement applies to the combination of U-and W phases and the combination of V-and W-phases as well.

The first step includes synchronizing the respective ends of the U-phase control signal SU6 and the V-phase control signal SV6 with each other. In the example shown in FIG. 35, the U-phase control signal SU6 is synchronized with the V-phase control signal SV6 by shifting (advancing), by ΔT1, the high-level period of the V-phase control signal SV6 compared with the example shown in FIG. 28.

The second step includes adding the additional time Tad corresponding to the total current value of the two-phase load currents iU, iV to the high-level period of the control signal SU6 for the U-phase switch 8. More specifically, using either the respective detection results of the load currents iU, iV by current sensors or signal processing values thereof, or estimated values of the load currents iU, iV, the inductance L of the resonant inductor L1 that has been stored in advance, and the detection result of the potential V15 at the regenerative capacitor 15, for example, the controller 50 determines the additional time Tad by the equation: Tad=L×|iU+iV|/V15.

The third step includes changing the lengths of the respective high-level periods of the control signals SU6, SV6 according to the resonant half cycle Tr2 (=2^{1/2}×Td) of the resonant circuit. More specifically, the controller 50 subtracts the additional time Tad from the high-level period of the control signal SU6, sets the length of the remainder period as the resonant half cycle Tr2, and sets the length of the high-level period of the control signal SV6 as the resonant half cycle Tr2. Note that the end of the control signal SU6, SV6 may be simultaneous with, or later than, the end of the resonant half cycle Tr2.

If the controller 50 does not perform any of the first, second, and third control operations, then the voltage V_{2U}, V_{2V} across the second switching element 2U, 2V has not risen to Vd at a point in time when the control signal SU1, SV1 makes transition from the low-level period to the high-level period (i.e., at the end of the dead time period Td) as shown in FIG. 28. That is to say, if the controller 50 does not perform any of the first, second, and third control operations, then the resonant capacitor 9U, 9V has not been charged fully yet at the end of the dead time period Td. Thus, in the power converter 100 according to the seventh variation, if the controller 50 does not perform any of the first, second, and third control operations, then the first switching element 1U, 1V is switched by hard switching.

On the other hand, in the power converter 100 according to the seventh variation, if the controller 50 has performed the first, second, and third control operations, then the voltage V_{1U}, V_{1V} across the first switching element 1U, 1V goes zero at a point in time when the control signal SU1, SV1 makes transition from the low-level period to the high-level period (i.e., at the end of the dead time period Td) as shown in FIG. 35. That is to say, in the power converter 100 according to the seventh variation, if the controller 50 has performed the first, second, and third control operations, then the resonant capacitor 9U, 9V is charged fully at the end of the dead time period Td. Thus, in the power converter 100 according to the seventh variation, if the controller 50 has performed the first, second, and third control operations, the first switching element 1U, 1V is switched by zero-voltage soft switching.

### Eighth Variation

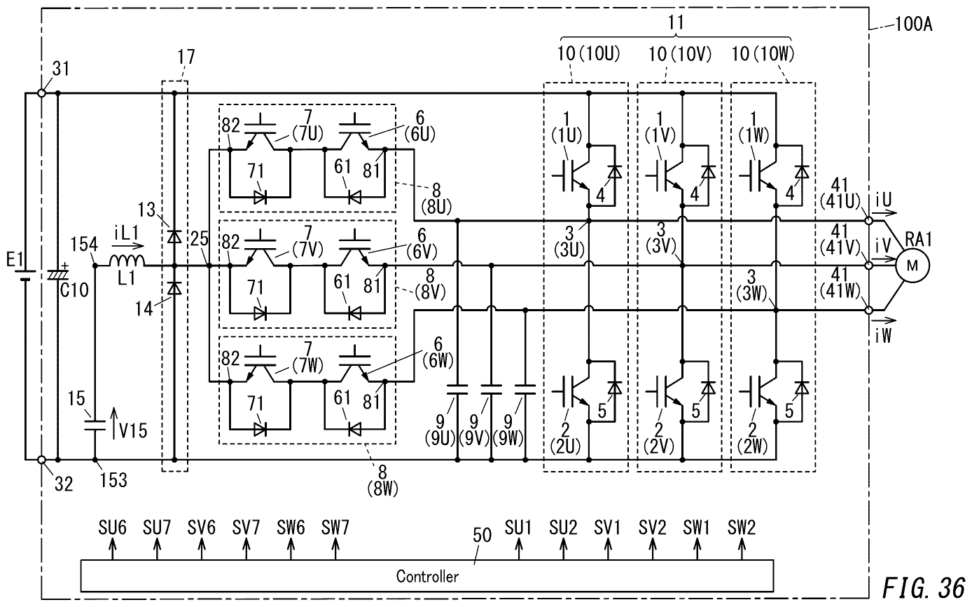

A power converter 100A according to an eighth variation of the first embodiment will be described with reference to FIG. 36. In the following description, any constituent element of the power converter 100A according to the eighth variation of the first embodiment, having the same function as a counterpart of the power converter 100 according to the first embodiment described above, will be designated by the same reference numeral as that counterpart's, and description thereof will be omitted herein.

In the power converter 100A according to the eighth variation, in each of the plurality of switches 8, the first IGBT 6 and second IGBT 7 thereof are connected in anti-series. In the power converter 100A according to the eighth variation, in each of the plurality of switches 8, the collector terminal of the first IGBT 6 and the collector terminal of the second IGBT 7 are connected to each other, the emitter terminal of the first IGBT 6 is connected to the connection node 3 of a corresponding one of the plurality of switching circuits 10, and the emitter terminal of the second IGBT 7 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100A according to the eighth variation, each of the first IGBT 6 and the second IGBT 7 may be replaced with either a MOSFET or a bipolar transistor. In that case, the diode 61 and diode 71 shown in FIG. 36 may be each replaced with, for example, either a parasitic diode of the replacement element or an element built in one chip of the replacement element. Also, in the power converter 100A according to the first variation, the diode 61 and the diode 71 do not have to be provided as external elements for the first IGBT 6 and the second IGBT 7, respectively, but may also be elements built in one chip.

### Ninth Variation

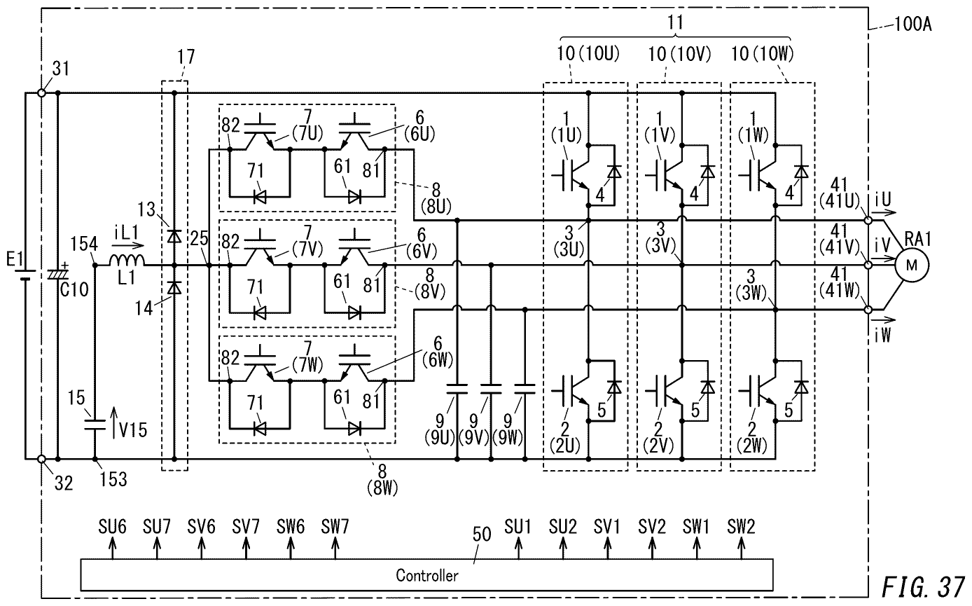

A power converter 100A according to a ninth variation of the first embodiment will be described with reference to FIG. 37. In the following description, any constituent element of the power converter 100A according to the tenth variation of the first embodiment, having the same function as a counterpart of the power converter 100 according to the first embodiment described above, will be designated by the same reference numeral as that counterpart's, and description thereof will be omitted herein.

In the power converter 100A according to the ninth variation, in each of the plurality of switches 8, the first IGBT 6 and second IGBT 7 thereof are connected in anti-series. In the power converter 100A according to the ninth variation, in each of the plurality of switches 8, the emitter terminal of the first IGBT 6 and the emitter terminal of the second IGBT 7 are connected to each other, the collector terminal of the first IGBT 6 is connected to the connection node 3 of a corresponding one of the plurality of switching circuits 10, and the collector terminal of the second IGBT 7 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100A according to the ninth variation, each of the first IGBT 6 and the second IGBT 7 may be replaced with either a MOSFET or a bipolar transistor. In that case, the diode 61 and diode 71 shown in FIG. 37 may be each replaced with, for example, either a parasitic diode of the replacement element or an element built in one chip of the replacement element. Also, in the power converter 100A according to the ninth variation, the diode 61 and the diode 71 do not have to be provided as external elements for the first IGBT 6 and the second IGBT 7, respectively, but may also be elements built in one chip.

### Tenth Variation

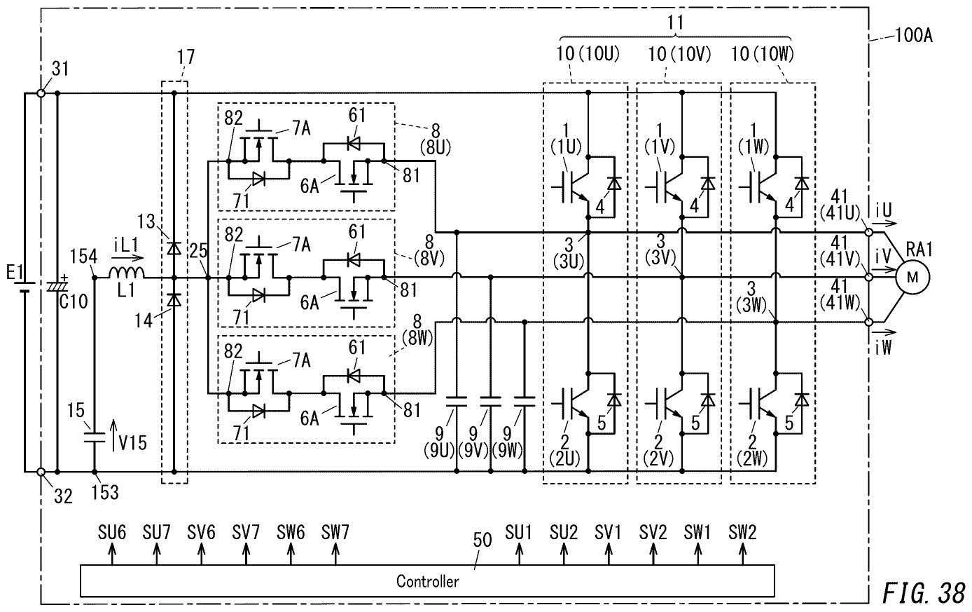

A power converter 100A according to a tenth variation of the first embodiment will be described with reference to FIG. 38. In the following description, any constituent element of the power converter 100A according to the tenth variation of the first embodiment, having the same function as a counterpart of the power converter 100 according to the first embodiment described above, will be designated by the same reference numeral as that counterpart's, and description thereof will be omitted herein.

In the power converter 100A according to the tenth variation, in each of the plurality of switches 8, a first MOSFET 6A and a second MOSFET 7A are connected in anti-series. In the power converter 100A according to the tenth variation, in each of the plurality of switches 8, the drain terminal of the first MOSFET 6A and the drain terminal of the second MOSFET 7A are connected to each other. In addition, each of the plurality of switches 8 further includes a diode 61 connected to the first MOSFET 6A in antiparallel and a diode 71 connected to the second MOSFET 7A in antiparallel. In each of the plurality of switches 8, the source terminal of the second MOSFET 7A is connected to the common connection node 25. In each of the plurality of switches 8, the source terminal of the first MOSFET 6A is connected to the connection node 3 of a switching circuit 10 corresponding to the switch 8 including the first MOSFET 6A. Control signals SU6, SU7 are respectively applied from the controller 50 to the first MOSFET 6A and second MOSFET 7A of the switch 8U. Control signals SV6, SV7 are respectively applied from the controller 50 to the first MOSFET 6A and second MOSFET 7A of the switch 8V. Control signals SW6, SW7 are respectively applied from the controller 50 to the first MOSFET 6A and second MOSFET 7A of the switch 8W.

### Eleventh Variation

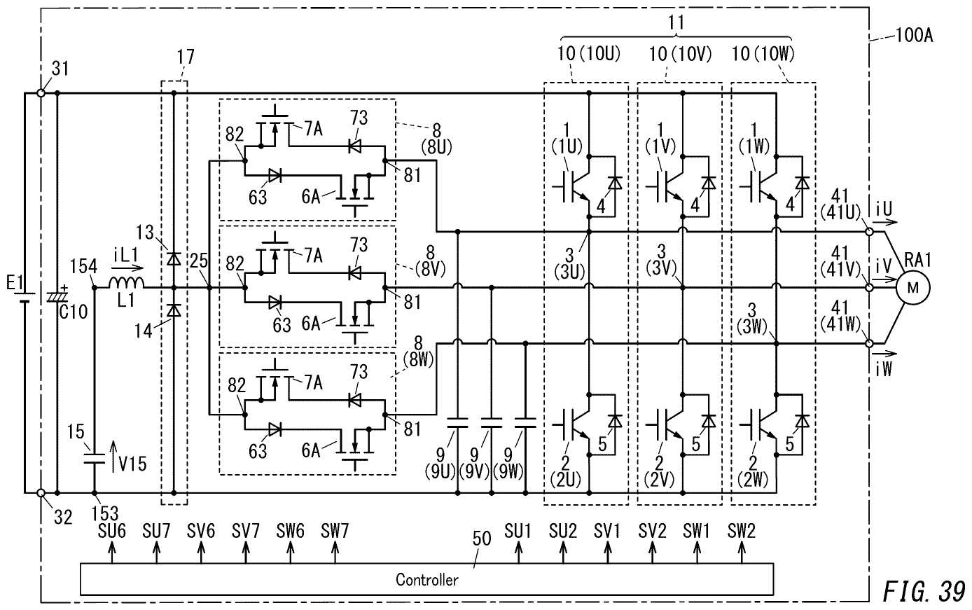

A power converter 100A according to an eleventh variation of the first embodiment will be described with reference to FIG. 39. In the following description, any constituent element of the power converter 100A according to the eleventh variation of the first embodiment, having the same function as a counterpart of the power converter 100 according to the first embodiment described above, will be designated by the same reference numeral as that counterpart's, and description thereof will be omitted herein.

In the power converter 100A according to the eleventh variation, in each of the plurality of switches 8, a diode 63 is connected to a first MOSFET 6A in series and a diode 73 is connected to a second MOSFET 7A in series. In the power converter 100A according to the eleventh variation, a series circuit of the first MOSFET 6A and the diode 63 and a series circuit of the second MOSFET 7A and the diode 73 are connected to each other in antiparallel.

### Twelfth Variation

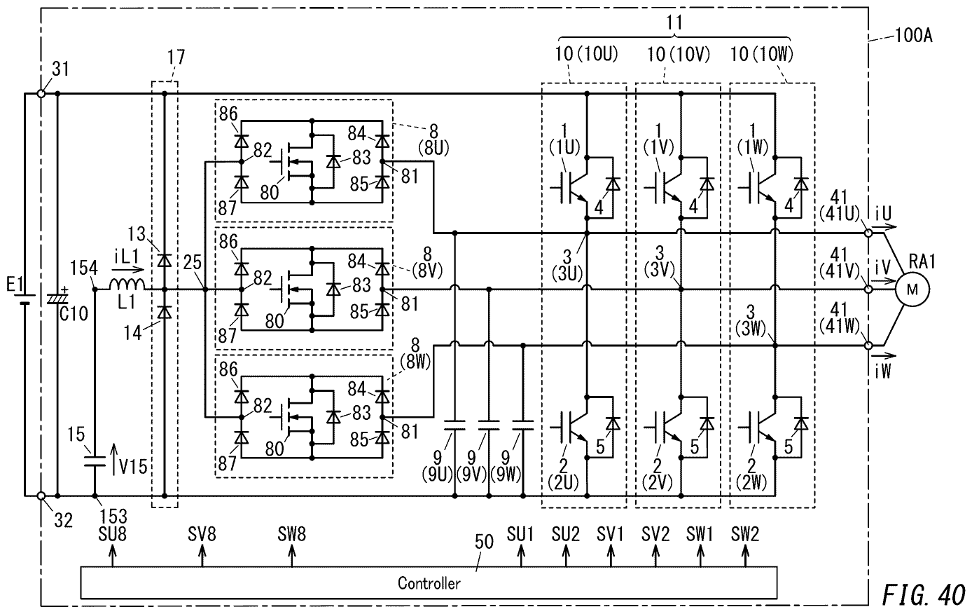

A power converter 100A according to a twelfth variation of the first embodiment will be described with reference to FIG. 40. In the following description, any constituent element of the power converter 100A according to the twelfth variation of the first embodiment, having the same function as a counterpart of the power converter 100 according to the first embodiment described above, will be designated by the same reference numeral as that counterpart's, and description thereof will be omitted herein.

In the power converter 100A according to the twelfth variation, each of the plurality of switches 8 includes: a MOSFET 80; a diode 83 connected to the MOSFET 80 in antiparallel; a series circuit of two diodes 84, 85 connected to the MOSFET 80 in antiparallel; and a series circuit of two diodes 86, 87 connected to the MOSFET 80 in antiparallel. In each of the plurality of switches 8, the connection node between the diodes 84, 85 in the switch 8 (i.e., a first terminal 81 of the switch 8) is connected to the connection node 3 of a corresponding one of the plurality of switching circuits 10, and a connection node between the diodes 86, 87 (i.e., a second terminal 82 of the switch 8) is connected to the common connection node 25. In each of the switches 8, when the MOSFET 80 is ON, the switch 8 is ON. On the other hand, when the MOSFET 80 is OFF, the switch 8 is OFF.

The MOSFETs 80 of the plurality of switches 8 are controlled by the controller 50. The controller 50 outputs a control signal SU8 for controlling the ON/OFF states of the MOSFET 80 of the switch 8U, a control signal SV8 for controlling the ON/OFF states of the MOSFET 80 of the switch 8V, and a control signal SW8 for controlling the ON/OFF states of the MOSFET 80 of the switch 8W.

In each of the switches 8, when its MOSFET 80 is ON, a resonant current produced by a resonant circuit including the resonant inductor L1 and the resonant capacitor 9 flows. In the power converter 100A, a charging current including the resonant current flows, when one of the plurality of switches 8 is ON, along the path passing through the regenerative capacitor 15, the resonant inductor L1, the diode 86, the MOSFET 80, the diode 85, and the resonant capacitor 9 in this order. Also, in the power converter 100A, a discharging current including the resonant current flows, when one of the plurality of switches 8 is ON, along the path passing through the resonant capacitor 9, the diode 84, the MOSFET 80, the diode 87, the resonant inductor L1, and regenerative capacitor 15 in this order.

In the power converter 100A according to the twelfth variation, each of the plurality of MOSFETs 80 may be replaced with an IGBT. Also, in the power converter 100A according to the twelfth variation, each of the plurality of switches 8 may include, for example, a bipolar transistor or a GaN-based gate injection transistor (GIT) instead of the MOSFET 80.

### Thirteenth Variation

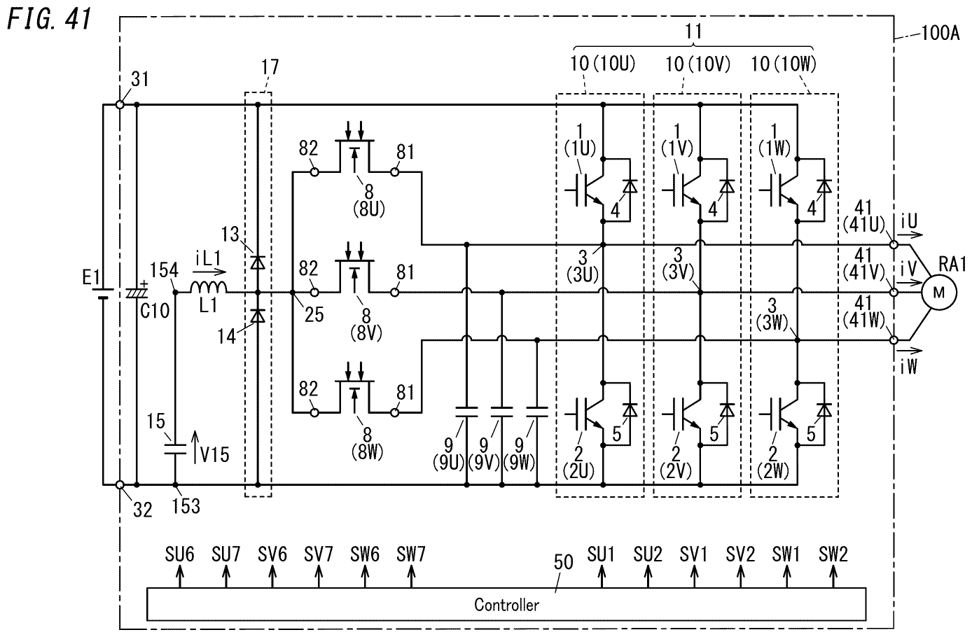

A power converter 100A according to a thirteenth variation of the first embodiment will be described with reference to FIG. 41. In the following description, any constituent element of the power converter 100A according to the thirteenth variation of the first embodiment, having the same function as a counterpart of the power converter 100 according to the first embodiment described above, will be designated by the same reference numeral as that counterpart's, and description thereof will be omitted herein.

In the power converter 100 according to the thirteenth variation, each of the plurality of switches 8 is a dual-gate GaN-based GIT including a first source terminal, a first gate terminal, a second gate terminal, and a second source terminal. In the power converter 100A according to the thirteenth variation, a control signal SU6 is applied to between the first gate terminal and first source terminal of a dual-gate GaN-based GIT serving as the switch 8U, and a control signal SU7 is applied to between the second gate terminal and the second source terminal thereof. In addition, a control signal SV6 is applied to between the first gate terminal and first source terminal of a dual-gate GaN-based GIT serving as the switch 8V, and a control signal SV7 is applied to between the second gate terminal and the second source terminal thereof. Furthermore, a control signal SW6 is applied to between the first gate terminal and first source terminal of a dual-gate GaN-63 based GIT serving as the switch 8W, and a control signal SW7 is applied to between the second gate terminal and the second source terminal thereof.

### Second Embodiment

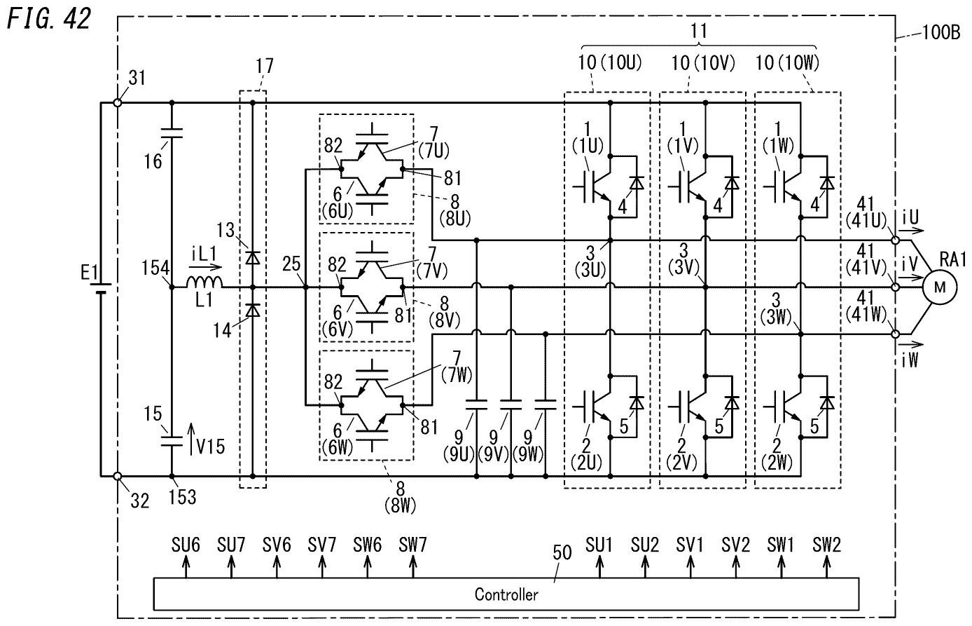

A power converter 100B according to a second embodiment will be described with reference to FIG. 42. The power converter 100B according to the second embodiment further includes a capacitor 16 connected between the second terminal of the resonant inductor L1 and the first DC terminal 31, which is a difference from the power converter 100 (refer to FIG. 1) according to the first embodiment. In the following description, any constituent element of the power converter 100B according to the second embodiment, having the same function as a counterpart of the power converter 100 according to the first embodiment described above, will be designated by the same reference numeral as that counterpart's, and description thereof will be omitted herein.

The power converter 100B does not include the capacitor C10 of the power converter 100 according to the first embodiment. The capacitor 16 is connected to the regenerative capacitor 15 in series. Thus, in this power converter 100B, a series circuit of the capacitor 16 and the regenerative capacitor 15 is connected between the first DC terminal 31 and the second DC terminal 32. The capacitance of the capacitor 16 is the same as the capacitance of the regenerative capacitor 15. As used herein, the expression “the capacitance of the capacitor 16 is the same as the capacitance of the regenerative capacitor 15” refers to not only a situation where the capacitance of the capacitor 16 is exactly equal to the capacitance of the regenerative capacitor 15 but also a situation where the capacitance of the capacitor 16 is equal to or greater than 95% and equal to or less than 105% of the capacitance of the regenerative capacitor 15 as well.

In the power converter 100B according to the second embodiment, the potential V15 at the fourth terminal 154 of the regenerative capacitor 15 has a value calculated by dividing the voltage value Vd of the DC power supply E1 by two that is the number of the capacitors, namely, the capacitor 16 and the regenerative capacitor 15. Thus, the potential V15 at the fourth terminal 154 of the regenerative capacitor 15 is Vd/2. In the power converter 100B according to the second embodiment, the controller 50 may store in advance the value of the potential V15 at the fourth terminal 154 of the regenerative capacitor 15.

The controller 50 of the power converter 100B according to the second embodiment, as well as the controller 50 of the power converter 100 according to the first embodiment, performs the first control operation, the second control operation, and the third control operation. Thus, the power converter 100B according to the second embodiment, as well as the power converter 100 according to the first embodiment, may make zero-voltage soft switching of each of the plurality of first switching elements 1 and the plurality of second switching elements 2.

### Third Embodiment

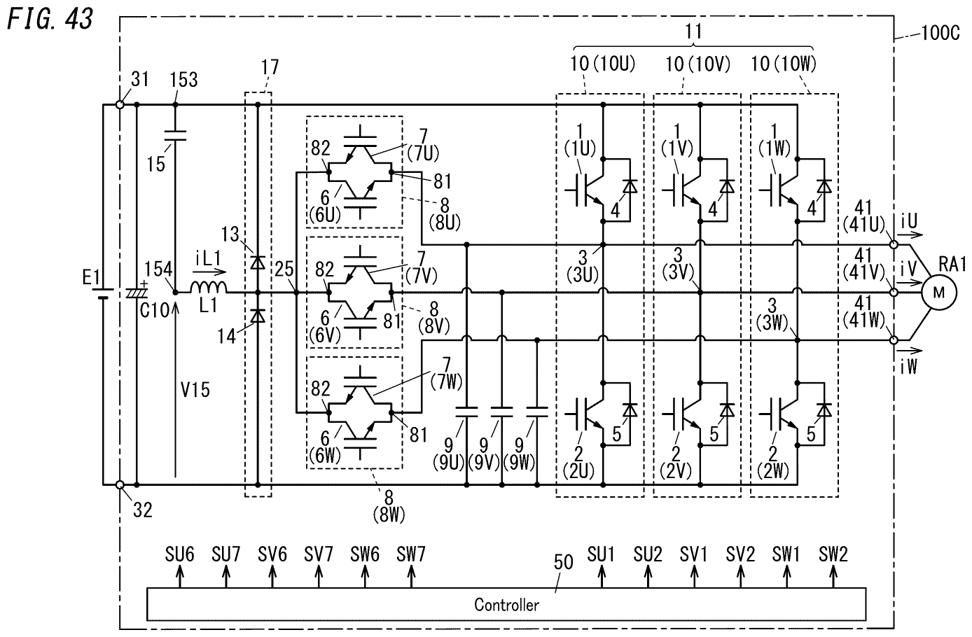

A power converter 100C according to a third embodiment will be described with reference to FIG. 43. In the power converter 100C according to the third embodiment, the regenerative capacitor 15 is connected between the second terminal of the resonant inductor L1 and the first DC terminal 31, which is a difference from the power converter 100 (refer to FIG. 1) according to the first embodiment. In the following description, any constituent element of the power converter 100C according to this third embodiment, having the same function as a counterpart of the power converter 100 according to the first embodiment described above, will be designated by the same reference numeral as that counterpart's, and description thereof will be omitted herein.

The controller 50 of the power converter 100C according to the third embodiment, as well as the controller 50 of the power converter 100 according to the first embodiment, performs the first control operation, the second control operation, and the third control operation. Thus, the power converter 100C according to the third embodiment, as well as the power converter 100 according to the first embodiment, may make soft switching with more reliability.

### Other Variations

Note that the first to third embodiments and their variations described above are only exemplary ones of various embodiments of the present disclosure and their variations and should not be construed as limiting. Rather, the first to third exemplary embodiments and their variations may be readily modified in various manners depending on a design choice or any other factor without departing from the scope of the present disclosure.

The operation performed by the controller 50 to “determine that a plurality of resonant currents flow simultaneously” is not limited to the operation of “determining that a plurality of resonant currents flow simultaneously” if the time lag is less than a threshold value and the operation of “determining that three-phase resonant currents flow simultaneously” if the rotational velocity of the motor is less than a rotational velocity threshold value.

For example, the controller 50 may determine that three-phase resonant currents flow simultaneously if the time lag between the beginning of a high-level period of a control signal corresponding to the U-phase and the beginning of a high-level period of a control signal corresponding to the V-phase, the time lag between the beginning of the high-level period of the control signal corresponding to the V-phase and the beginning of a high-level period of a control signal corresponding to the W-phase, and the time lag between the beginning of the high-level period of the control signal corresponding to the W-phase and the beginning of the high-level period of the control signal corresponding to the U-phase are all less than a threshold value.

Alternatively, the controller 50 may determine that two-phase resonant currents flow simultaneously if any one of the current difference between the U-phase load current iU and the V-phase load current iV, the current difference between the V-phase load current iV and the W-phase load current iW, or the current difference between the W-phase load current iW and the U-phase load current iU is less than a current difference threshold value.

Still alternatively, the controller 50 may determine that three-phase resonant currents flow simultaneously if the current difference between the U-phase load current iU and the V-phase load current i V, the current difference between the V-phase load current iV and the W-phase load current iW, and the current difference between the W-phase load current iW and the U-phase load current iU are all less than the current difference threshold value.

Yet alternatively, the controller 50 may determine “two-phase resonant currents flow simultaneously” if the electrical angle determined by calculation, or estimated, based on sensor information provided by a sensor device (such as an encoder or a resolver) for detecting the number of revolutions of a motor falls within a first rotational angle range (e.g., equal to or larger than 55 degrees and equal to or smaller than 65 degrees), or a second rotational angle range (e.g., equal to or larger than 115 degrees and equal to or smaller than 125 degrees), or a third rotational angle range (e.g., equal to or larger than 175 degrees and equal to or smaller than 185 degrees), or a fourth rotational angle range (e.g., equal to or larger than 235 degrees and equal to or smaller than 245 degrees), or a fifth rotational angle range (e.g., equal to or larger than 295 degrees and equal to or smaller than 305 degrees), or a sixth rotational angle range (e.g., equal to or larger than 355 degrees and equal to or smaller than 365 degrees).

For example, each of the plurality of first switching elements 1 and the plurality of second switching elements 2 does not have to be an IGBT but may also be a MOSFET. In that case, each of the plurality of first diodes 4 may also be replaced with, for example, a parasitic diode of a MOSFET serving as its corresponding first switching element 1. In addition, each of the plurality of second diodes 5 may also be replaced with, for example, a parasitic diode of a MOSFET serving as its corresponding second switching element 2. The MOSFET may be, for example, an Si-based MOSFET or an SiC-based MOSFET. Each of the plurality of first switching elements 1 and the plurality of second switching elements 2 may also be, for example, a bipolar transistor or a GaN-based GIT.

Optionally, in the power converters 100, 100A, 100B, 100C, if each of the plurality of resonant capacitors 9 has a relatively small capacitance, then the parasitic capacitors across the plurality of second switching elements 2 may also serve as the plurality of resonant capacitors 9 instead of providing the plurality of resonant capacitors 9 as separate elements.

For example, each of the plurality of switches 8 according to the second and third embodiments other than the first embodiment may have any of the exemplary alternative configurations shown in FIGS. 36-41.

Furthermore, the length of the dead time period Td does not have to be set to be as long as one resonant half cycle but may also be set to be different from one resonant half cycle. Nevertheless, in any case, the end of the dead time period Td preferably agrees with the end of the resonant half cycle.

The dead time period Td may also be set by a dead time generator circuit included in a gate driver integrated circuit (IC) provided separately from the controller 50. Alternatively, the controller 50 may include a gate driver IC and a dead time generator circuit included in the gate driver IC may set the dead time period Td.

Furthermore, the power converter 100, 100A, 100B, 100C does not have to be configured to output three-phase AC power but may also be configured to output multi-phase AC power in more than three phases.

### Aspects

The foregoing description provides specific implementations of the following aspects of the present disclosure.

A power converter (100; 100A; 100B; 100C) according to a first aspect includes a first DC terminal (31) and a second DC terminal (32), a power converter circuit (11), a plurality of AC terminals (41), a plurality of switches (8), a plurality of resonant capacitors (9), a resonant inductor (L1), a regenerative capacitor (15), and a controller (50). The power converter circuit (11) includes a plurality of first switching elements (1) and a plurality of second switching elements (2). In the power converter circuit (11), a plurality of switching circuits (10), in each of which one of the plurality of first switching elements (1) and a corresponding one of the plurality of second switching elements (2) are connected one to one in series, are connected to each other in parallel. In the power converter circuit (11), the plurality of first switching elements (1) are connected to the first DC terminal (31), and the plurality of second switching elements (2) are connected to the second DC terminal (32). The plurality of AC terminals (41) are provided one to one for the plurality of switching circuits (10). Each of the plurality of AC terminals (41) is connected to a connection node (3) between the first switching element (1) and the second switching element (2) of a corresponding one of the plurality of switching circuits (10). The plurality of switches (8) are provided one to one for the plurality of switching circuits (10). Each of the plurality of switches (8) has a first terminal (81) thereof connected to the connection node (3) between the first switching element (1) and the second switching element (2) of a corresponding one of the plurality of switching circuits (10). The plurality of switches (8) have their respective second terminals (82) connected in common to a common connection node (25). The plurality of resonant capacitors (9) are provided one to one for the plurality of switches (8). Each of the plurality of resonant capacitors (9) is connected between the first terminal (81) of a corresponding one of the plurality of switches (8) and the second DC terminal (32). The resonant inductor (L1) has a first terminal and a second terminal. In the resonant inductor (L1), the first terminal of the resonant inductor (L1) is connected to the common connection node (25). The regenerative capacitor (15) has a third terminal (153) and a fourth terminal (154). In the regenerative capacitor (15), the third terminal (153) of the regenerative capacitor (15) is connected to either the first DC terminal (31) or the second DC terminal (32). The controller (50) applies a control signal, having a potential alternating between a high level and a low level, to each of the plurality of first switching elements (1), the plurality of second switching elements (2), and the plurality of switches (8). The controller (50) may perform a first control operation and a second control operation when determining that resonant currents, each passing through a corresponding one of two or more switches (8) belonging to the plurality of switches (8), flow simultaneously through the resonant inductor (L1). The first control operation includes allowing a high-level period of a control signal for each of the two or more switches (8) to overlap, for a predetermined period, with a dead time period (Td) associated with each of two or more switching circuits (10) respectively connected to the two or more switches (8) which belong to the plurality of switching circuits (10). The second control operation includes determining a beginning of a high-level period of a control signal for at least one of the plurality of switches (8) by a load current of at least one phase flowing through an AC load (RA1) connected to the plurality of AC terminals (41).

This aspect enables making soft switching with more reliability.

In a power converter (100; 100A; 100B; 100C) according to a second aspect, which may be implemented in conjunction with the first aspect, the predetermined period forms at least part of a resonant half cycle (Tr2, Tr3) of a resonant circuit. The resonant circuit includes the resonant inductor (L1) and two or more of the resonant capacitors (9). Each of the two or more of the resonant capacitors (9) is connected to a corresponding one of the two or more switches (8).

In a power converter (100; 100A; 100B; 100C) according to a third aspect, which may be implemented in conjunction with the second aspect, the predetermined period is all of the resonant half cycle (Tr2, Tr3).

This aspect enables making zero-voltage soft switching with more reliability.

In a power converter (100; 100A; 100B; 100C) according to a fourth aspect, which may be implemented in conjunction with any one of the first to third aspects, the controller (50) performs the second control operation by shifting a beginning of a high-level period of a control signal for one of the plurality of switches (8) according to a total amount of load currents of two or more phases flowing respectively through two or more AC terminals (41) respectively connected to the two or more switches (8) which belong to the plurality of AC terminals (41).

This aspect allows resonance to start being produced at the beginning of the dead time period (Td1, Td2).

In a power converter (100; 100A; 100B; 100C) according to a fifth aspect, which may be implemented in conjunction with any one of the first to fourth aspects, the controller (50) may perform a third control operation including making the dead time period (Td1, Td2), associated with each of the two or more switching circuits (10) respectively connected to the two or more switches (8) which belong to the plurality of switching circuits (10), longer than a predefined dead time period (Td) by an additional time (Tad).

This aspect enables making zero-voltage soft switching even if the resonant half cycle (Tr2, Tr3) is longer than the dead time period (Td).

### Reference Signs List

1 First Switching Element
2 Second Switching Element
3 Connection Node
8 Switch
81 First Terminal
82 Second Terminal
9 Resonant Capacitor
10 Switching Circuit
11 Power Converter Circuit
15 Regenerative Capacitor
153 Third Terminal
154 Fourth Terminal
25 Common Connection Node
31 First DC Terminal
32 Second DC Terminal
41 AC Terminal
50 Controller
100, 100A, 100B, 100C Power Converter
iU, iV, iW Output Current (Load Current)
L1 Resonant Inductor
RA1 AC Load
Tad Additional Time
Td Dead Time Period
Td1 Dead Time Period
Td2 Dead Time Period
Tr2 Resonant Half Cycle
Tr3 Resonant Half Cycle

1. A power converter comprising:
a first DC terminal and a second DC terminal;
a power converter circuit including a plurality of first switching elements and a plurality of second switching elements, the power converter circuit being implemented as a parallel connection of a plurality of switching circuits in each of which one of the plurality of first switching elements and a corresponding one of the plurality of second switching elements are connected one to one in series, the plurality of first switching elements being connected to the first DC terminal, the plurality of second switching elements being connected to the second DC terminal;
a plurality of AC terminals provided one to one for the plurality of switching circuits, each of the plurality of AC terminals being connected to a connection node between the first switching element and the second switching element of a corresponding one of the plurality of switching circuits;
a plurality of switches provided one to one for the plurality of switching circuits, each of the plurality of switches having a first terminal thereof connected to the connection node between the first switching element and the second switching element of a corresponding one of the plurality of switching circuits, the plurality of switches having their respective second terminals connected in common to a common connection node;
a plurality of resonant capacitors provided one to one for the plurality of switches, each of the plurality of resonant capacitors being connected between the first terminal of a corresponding one of the plurality of switches and the second DC terminal;
a resonant inductor having a first terminal and a second terminal, the first terminal of the resonant inductor being connected to the common connection node;
a regenerative capacitor having a third terminal and a fourth terminal, the third terminal of the regenerative capacitor being connected to either the first DC terminal or the second DC terminal; and
a controller configured to apply a control signal, having a potential alternating between a high level and a low level, to each of the plurality of first switching elements, the plurality of second switching elements, and the plurality of switches,
the controller being able to perform a first control operation and a second control operation when determining that resonant currents, each passing through a corresponding one of two or more switches belonging to the plurality of switches, flow simultaneously through the resonant inductor,
the first control operation including allowing a high-level period of a control signal for each of the two or more switches to overlap, for a predetermined period, with a dead time period associated with each of two or more switching circuits respectively connected to the two or more switches which belong to the plurality of switching circuits, and
the second control operation including determining a beginning of a high-level period of a control signal for at least one of the plurality of switches by a load current of at least one phase flowing through an AC load connected to the plurality of AC terminals.

2. The power converter of claim 1, wherein
the predetermined period forms at least part of a resonant half cycle of a resonant circuit, the resonant circuit including the resonant inductor and two or more of the resonant capacitors, each of the two or more of the resonant capacitors being connected to a corresponding one of the two or more switches.

3. The power converter of claim 2, wherein
the predetermined period is all of the resonant half cycle.

4. The power converter of claim 1, wherein
the controller is configured to perform the second control operation by shifting a beginning of a high-level period of a control signal for one of the plurality of switches according to a total amount of load currents of two or more phases flowing respectively through two or more AC terminals respectively connected to the two or more switches which belong to the plurality of AC terminals.

5. The power converter of claim 1, wherein
the controller is able to perform a third control operation including making the dead time period, associated with each of the two or more switching circuits respectively connected to the two or more switches which belong to the plurality of switching circuits, longer than a predefined dead time period by an additional time.

6. The power converter of claim 2, wherein
the controller is configured to perform the second control operation by shifting a beginning of a high-level period of a control signal for one of the plurality of switches according to a total amount of load currents of two or more phases flowing respectively through two or more AC terminals respectively connected to the two or more switches which belong to the plurality of AC terminals.

7. The power converter of claim 3, wherein
the controller is configured to perform the second control operation by shifting a beginning of a high-level period of a control signal for one of the plurality of switches according to a total amount of load currents of two or more phases flowing respectively through two or more AC terminals respectively connected to the two or more switches which belong to the plurality of AC terminals.

8. The power converter of claim 2, wherein
the controller is able to perform a third control operation including making the dead time period, associated with each of the two or more switching circuits respectively connected to the two or more switches which belong to the plurality of switching circuits, longer than a predefined dead time period by an additional time.

9. The power converter of claim 3, wherein
the controller is able to perform a third control operation including making the dead time period, associated with each of the two or more switching circuits respectively connected to the two or more switches which belong to the plurality of switching circuits, longer than a predefined dead time period by an additional time.

10. The power converter of claim 4, wherein
the controller is able to perform a third control operation including making the dead time period, associated with each of the two or more switching circuits respectively connected to the two or more switches which belong to the plurality of switching circuits, longer than a predefined dead time period by an additional time.
